(19) United States
(12) Patent Application Publication
(10) Pub. No.: US 2025/0075014 A1
(43) Pub. Date: Mar. 6, 2025

(54) STEREOMODULATED POLYOLEFIN AND METHOD OF PREPARATION THEREOF

(71) Applicant: UNIVERSITY OF MARYLAND, COLLEGE PARK, College Park, MD (US)

(72) Inventors: Lawrence R. Sita, Silver Spring, MD (US); Danyon M. Fischbach, Carlisle, PA (US); Charlotte W. Wentz, Greenbelt, MD (US)

(21) Appl. No.: 18/826,070

(22) Filed: Sep. 5, 2024

Related U.S. Application Data
(60) Provisional application No. 63/580,711, filed on Sep. 5, 2023.
(60) Provisional application No. 63/624,584, filed on Jan. 24, 2024.

(51) Int. Cl. C08F 110/14

(52) U.S. Cl. CPC C08F 110/14; C08F 2420/04

(57) ABSTRACT

The present disclosure provides a method for preparing a polyolefin composition, which includes a blend of atactic polyolefin and isotactic polyolefin. Also provided is a polyolefin composition comprising a blend of atactic poly(4-methyl-1-pentene) (aPMP) and isotactic poly(4-methyl-1-pentene) (iPMP). Advantageously, the present PMP stereoblends can have desirable and tunable viscoelastic properties. Further provided is a method of preparing aPMP by reacting 4-methyl-1-pentene monomer with a pre-initiator and a co-initiator in a liquid medium.

### CROSS-REFERENCE TO RELATED APPLICATIONS

This application claims the benefit of U.S. Provisional Patent Application Ser. Nos. 63/580,711 filed on Sep. 5, 2023 and 63/624,584 filed on Jan. 24, 2024, the contents of all of which are incorporated by reference herein in their entireties.

### STATEMENT REGARDING FEDERALLY SPONSORED RESEARCH

This invention was made with government support under CHE2247554 and CHE1955730 awarded by the National Science Foundation, and 70NANB21H112 awarded by the National Institute of Standards and Technology. The government has certain rights in the invention.

### BACKGROUND

The world is facing a plastics waste crisis. In response, new strategies must be conceived, developed, and validated that not only reduce the barriers for the physical and chemical recycle of existing polymeric products, but also, that introduce the design of new polymers that can serve as commercially competitive replacements for less-environmentally-benign ‘legacy’ plastics, such as polystyrene and polyvinylchloride. Polyolefins, consisting largely of polyethene (PE) and polypropene (PP) based materials, currently comprise 50% of the nearly 300 million metric tons of plastic waste produced globally each year. The dependence of society on polyolefins for the foreseeable future is guaranteed by: (1) the range of physical properties that can be tailored for a large variety of end-use applications, (2) the supply security of abundant and low cost ethene and propene as monomer feedstocks, and (3) the deeply entrenched and paid-for global infrastructure that already exists for the manufacture and distribution of polyolefin materials and products world-wide.

In this regard, a holistic approach not only involves the design and implementation of new strategies for increasing levels of collection, recycle, and repurposing of plastic waste, but also an increase in the production and utilization of ‘green’ commercial polymers that have an overall negative carbon footprint and that do not degrade into chemical by-products that have an adverse environmental impact. Perhaps counterintuitively, polyolefins fit this profile as they can be produced from bio-sourced “green” olefin feedstocks that have very high CO₂ capture quotients, as exemplified by Braskem's new grades of green PE, and as pure hydrocarbons, they are biologically benign. Therefore, with respect to plastic waste, the dependence on polyolefins is also not a bad thing due to: (1) the already high recycle level for some polyolefin products, such as 30% in the case of high density polyethene (HDPE)—making it the most successful plastic to date for a circular economy, (2) the recent commercialization of ‘green’ PE that is produced from bio-sourced ethene with a neutral to negative environmental carbon footprint, and (3) as unfunctionalized hydrocarbon materials, the availability of options for the disposal of polyolefin waste through chemical processing that yields valuable products, such as fuel. Thus, collectively, these benefits provide clear incentives and justifications for developing new classes of polyolefins with an expanded range of physical properties. This goal, however, then raises the question of what the realistic options for are new polyolefin materials that can also be commercially viable? On the one hand, the biggest challenge that must be addressed is that there is simply only a very small pool of industrially relevant olefin monomers to build new polyolefins from, and this list largely consists of those a-olefins that can be obtained through the controlled dimerization or oligomerization of ethene and propene. On the other hand, the concept of polyolefin tacticity as originally conceived and introduced by Natta and coworkers provides the basis for a powerful strategy by which different “grades” of a common polyolefin structure can be explored and mined for physical properties that differ in either subtle or dramatic fashion from each other by virtue of differences in the linear sequence of relative configurations of adjacent stereocenters associated with pendant side groups.

In addition, new advances are being made with the development of chemical processes that can convert polyolefin waste into useful chemicals and lower molar mass materials with an increased net energy savings. Accordingly, there are significant long term advantages and rewards for identifying and developing new classes of green polyolefins, of which poly(4-methyl-1-pentene) (PMP) can be classified as one since the requisite 4-methyl-1-pentene (4M1P) monomer is currently produced on a large industrial scale through the alkali-metal catalyzed dimerization of C3—which is increasingly being bio-sourced. Highly stereoregular isotactic PMP (iPMP) is a commercial thermoplastic polyolefin with a high melting temperature, Tₘ, of 250° C., excellent optical transparency, and a low dielectric constant that is useful for a range of applications, including microwave cookware, optical lenses, and acoustic coverings, to name a few. However, a disadvantage of iPMP is that molded films are highly brittle with low impact and tensile strength.

Therefore, there remains a need for methods of preparing new viscoelastic grades of PMP.

### SUMMARY OF THE INVENTION

The present disclosure provides polyolefin compositions and methods of preparation thereof. In one aspect, the present disclosure provides a method for preparing a polyolefin composition. The method can comprise reacting an olefin monomer with a first metallocene pre-initiator, a second metallocene pre-initiator, a co-initiator, and a chain transfer agent in a liquid medium, thereby polymerizing the olefin monomer to produce the polyolefin composition. The polyolefin composition produced by the present method can comprise a blend of atactic polyolefin and isotactic polyolefin. In some embodiments, the olefin monomer is 4-methyl-1-pentene. In some embodiments, the first metallocene pre-initiator comprises (η⁵-C₅Me₅)Hf(Me)₂[N(Et)C(Me)N(Et)] and the second metallocene pre-initiator comprises (η⁵-C₅Me₅)ZrMe₂[N(Et)C(Me)N(^{t}Bu)]. In some embodiments, the co-initiator comprises [PhNHMe₂][B(C₆F₅)₄]. In some embodiments, the chain transfer agent comprises ZnR₂, wherein R is selected from the group consisting of methyl, ethyl, n-butyl, isoamyl, t-butyl, neopentyl, n-propyl, and iso-propyl.

In another aspect, the present disclosure provides a polyolefin composition produced by the method as described herein.

In another aspect, the present disclosure provides a polyolefin composition comprising a blend of atactic poly(4-methyl-1-pentene) (aPMP) and isotactic poly(4-methyl-1-pentene) (iPMP). For example, the polyolefin composition can have a mass ratio of aPMP to iPMP is about 1:99 to about 99:1, such as about 5:95, about 10:90, about 50:50, about 90:10, or about 99:1. In some embodiments, the composition has a melting temperature (Tₘ) of about 100° C. to about 240° C. In some embodiments, the composition has a glass transition temperature (T_{g}) of about 5° C. to about 30° C. and a mass ratio of aPMP to iPMP of 1:1.7 or higher. In some embodiments, the composition has an elongation to break of at least 200% and a mass ratio of aPMP to iPMP of 1.8:1 or higher. In some embodiments, the composition has a Young's modulus of about 0.1 to about 40 MPa and a mass ratio of aPMP to iPMP of 1.2:1 or higher.

In another aspect, the present disclosure provides a method of preparing atactic poly(4-methyl-1-pentene) (aPMP). The method can comprise reacting 4-methyl-1-pentene monomer with: a pre-initiator selected from the group consisting of (η⁵-C₅Me₅)Hf(Me)₂[N(Et)C(Me)N(Et)], (η⁵-C₅Me₅)ZrMe₂[N(Et)C(Me)N(^{t}Bu)], and a combination thereof; and a co-initiator in a liquid medium, thereby producing the atactic poly(4-methyl-1-pentene) (aPMP).

In yet, another aspect, the present disclosure provides an aPMP prepared by the method disclosed herein.

### BRIEF DESCRIPTION OF THE DRAWINGS

Further objects, features and advantages of the present disclosure will become apparent from the following detailed description taken in conjunction with the accompanying figures showing illustrative embodiments of the present disclosure. Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1 shows the limiting tactic forms for polyolefins and synthetic methods used in the present report to stereomodulate poly(4-methyl-1-pentene) (PMP) tacticity between atactic and isotactic.

FIG. 2 illustrates the toolbox of living polymerization methods that has been applied for the stereomodulation of poly(4-methyl-1-pentene) (PMP) to provide new fundamental forms in which thermal phase transitions.

FIG. 3 shows the ¹³C{¹H} NMR (200 MHz, TCE-d₂, 110° C.) spectra for (a) isotactic PMP (ref1) (Mₙ=51.0 kDa, Ð=1.39) and (b) atactic PMP (ref2) (Mₙ '₂ 48.7 kDa, Ð=1.19) The asterisks in (a) indicate ¹³C resonances for a polyolefin co-product arising from an a-olefin impurity in the original 4M1P.

FIG. 4 demonstrates the manufacture of optically transparent disks from linear atactic PMP (ref2) with T_{g}=39.5° C. through (a) solvent casting from hexane (thickness=0.5 cm) and (b) injection molding (non-optimized) at 150° C. (thickness=3 mm). Diameters of each disk are indicated.

FIG. 5A shows the partial DSC data for aPMP obtained via LCP using 2, with Mₙvalues (top to bottom) of 835 Da, 2.60 kDa, 3.30 kDa, 6.18 kDa, 31.4 kDa, and 48.7 kDa.

FIG. 5B shows the relationship between T_{g} and log ₁₀ (M_{w}) for aPMP obtained from both LCP and LCCTP (see Table 1). The line is an asymptopic fit of the data (y=a−bc^{x}) with a=317.5, b=5676, c=0.253, R²=0.983.

FIG. 6A shows the partial ¹³C{¹H}(200 MHz, TCE-d₂, 110° C.) NMR spectra for PMP obtained according to (from bottom to top) runs 12, 13, 15 and 17.

FIG. 6B shows the Partial DSC data for same PMP samples and in the same order (from bottom to top) as in FIG. 6A.

FIG. 6C shows the plots of Tₘ and percent crystallinity as a function of percent activation of 1 by B1 for runs 11-17 of Table 2.

FIG. 7A shows the ¹H NMR (600 MHz, *Chloroform-d1) of run 1 from Example 1.

FIG. 7B shows the partial ¹³C-NMR (150 MHz, *Chloroform-d1) of run 1 (835 Da Hf LCCTP) from Example 1.

FIG. 8A shows the ¹H NMR (600 MHz, *Chloroform-d1) of run 2 from Example 1.

FIG. 8B shows the partial ¹³C-NMR (150 MHz, *Chloroform-d1) of run 2 (2.60 kDa Hf LCCTP) from Example 1.

FIG. 9A shows the ¹H NMR (600 MHz, *Chloroform-d1) of run 3 from Example 1.

FIG. 9B shows the partial ¹³C-NMR (150 MHz, *Chloroform-d1) of run 3 (3.30 kDa Hf LCCTP) from Example 1.

FIG. 10A shows the ¹H NMR (600 MHz, *Chloroform-d1) of run 4 from Example 1.

FIG. 10B shows the partial ¹³C-NMR (150 MHz, *Chloroform-d1) of run 4 (6.18 kDa Hf LCCTP) from Example 1.

FIG. 11A shows the ¹H NMR (600 MHz. *Chloroform-d1) of run 5 from Example 1.

FIG. 11B shows the partial ¹³C-NMR (150 MHz, *Chloroform-d1) of run 5 (31.4 kDa Hf LCCTP) from Example 1.

FIG. 12A shows the ¹H NMR (600 MHz. *Chloroform-d1) of run 6 from Example 1.

FIG. 12B shows the partial ¹³C-NMR (150 MHz, *Chloroform-d1) of run 6 (48.7 kDa Hf LCCTP) from Example 1.

FIG. 13A shows the ¹H NMR (600 MHz. *Chloroform-d1) of run 7 from Example 1.

FIG. 13B shows the partial ¹³C-NMR (150 MHz, *Chloroform-d1) of run 7 (3.21 kDa Hf LCP) from Example 1.

FIG. 14A shows the ¹H NMR (600 MHz. *Chloroform-d1) of run 8 from Example 1.

FIG. 14B shows the partial ¹³C-NMR (150 MHz, *Chloroform-d1) of run 8 (10.4 kDa Hf LCP) from Example 1.

FIG. 15A shows the ¹H NMR (600 MHz. *Chloroform-d1) of run 9 from Example 1.

FIG. 15B shows the partial ¹³C-NMR (150 MHz, *Chloroform-d1) of run 9 from Example 1.

FIG. 16A shows the ¹H NMR (600 MHz. *Chloroform-d1) of run 10 from Example 1.

FIG. 16B shows the partial ¹³C-NMR (150 MHz, *Chloroform-d1) of run 10 from Example 1.

FIG. 17A shows the ¹H-NMR (600 MHz, *1,1,2,2-C₂Cl₄-d2, 110° C. after 1 h of temperature equilibration) of run 11 from Example 1.

FIG. 17B shows the partial ¹³C NMR (150 MHz, *1,1,2,2-C₂Cl₄-d2, 110° C. after 1 h of temperature equilibration) of run 11 from Example 1.

FIG. 18A shows the ¹H-NMR (800 MHz, *1,1,2,2-C₂Cl₄-d2, 110° C. 1 h of temperature equilibration) of run 12 from Example 1.

FIG. 18B shows the partial ¹³C NMR (200 MHz, *1,1,2,2-C₂Cl₄-d2, 110° C. after 1 h of temperature equilibration) of run 12 from Example 1.

FIG. 19A shows the ¹H-NMR (800 MHz, *1,1,2,2-C₂Cl₄-d2, 110° C. after 1 h of temperature equilibration) of run 13 from Example 1.

FIG. 19B shows the partial ¹³C NMR (200 MHz, *1,1,2,2-C₂Cl₄-d2, 110° C. after 1 h of temperature equilibration) of run 13 from Example 1.

FIG. 20A shows the ¹H-NMR (600 MHz, *1,1,2,2-C₂Cl₄-d2, 110° C. after 20 minutes of temperature equilibration) of run 14 from Example 1.

FIG. 20B shows the partial ¹³C NMR (150 MHz, *1,1,2,2-C₂Cl₄-d2, 110° C. after 20 minutes of temperature equilibration) of run 14 from Example 1.

FIG. 20C shows the ¹H-NMR (600 MHz, *1,1,2,2-C₂Cl₄-d2, 110° C. after 20 minutes of temperature equilibration) of I₂ quenched run 14 from Example 1 with a molecular weight calculated to be 8.1 kDa through integration of a 900 pulse program.

FIG. 21A shows the ¹H-NMR (600 MHz, *1,1,2,2-C₂Cl₄-d2, 110° C. after 1 h of temperature equilibration) of run 15 from Example 1.

FIG. 21B shows the partial ¹³C NMR (150 MHz, *1,1,2,2-C₂Cl₄-d2, 110° C. after 1 h of temperature equilibration) of run 15 from Example 1.

FIG. 22A shows the ¹H NMR (800 MHz, *1,1,2,2-C₂Cl₄-d2, 110° C. after 1 hr of temperature equilibration) of run 16 from Example 1.

FIG. 22B shows the partial ¹³C-NMR (200 MHz, *1,1,2,2-C₂Cl₄-d2) of run 16 from Example 1.

FIG. 23A shows the ¹H NMR (800 MHz, *1,1,2,2-C₂Cl₄-d2, 110° C. after 1 hr of temperature equilibration) of run 17 from Example 1.

FIG. 23B shows the partial ¹³C-NMR (200 MHz, *1,1,2,2-C₂Cl₄-d2) of run 17 from Example 1.

FIG. 24A shows the ¹H NMR (800 MHz, *1,1,2,2-C₂Cl₄-d2, 110° C. after 1 hr of temperature equilibration) of run 18 from Example 1.

FIG. 24B shows the partial ¹³C-NMR (200 MHz, *1,1,2,2-C₂Cl₄-d2) of run 18 from Example 1.

FIG. 25A shows the ¹H NMR (800 MHz, *1,1,2,2-C₂Cl₄-d2, 110° C. after 1 hr of temperature equilibration) of run 19 from Example 1.

FIG. 25B shows the partial ¹³C-NMR (200 MHz, *1,1,2,2-C₂Cl₄-d2) of run 19 from Example 1.

FIG. 25C shows the partial ¹³C-NMR (200 MHz, *1,1,2,2-C₂Cl₄-d2) of run 19 from Example 1.

FIG. 25D shows the 12 aliquot with integration for molecular weight (8.4 kDa by integration) of run 19 from Example 1.

FIG. 26A shows the ¹H NMR (800 MHz, *1,1,2,2-C₂Cl₄-d2, 110° C. after 1 hr of temperature equilibration) of run 20 from Example 1.

FIG. 26B shows the partial ¹³C-NMR (200 MHz, *1,1,2,2-C₂Cl₄-d2) of run 20 from Example 1.

FIG. 27A shows the ¹H NMR (800 MHz, *1,1,2,2-C₂Cl₄-d2, 110° C. after 1 hr of temperature equilibration) of run 21 from Example 1.

FIG. 27B shows the partial ¹³C-NMR (200 MHz, *1,1,2,2-C₂Cl₄-d2) of run 21 from Example 1.

FIG. 28A shows the ¹H NMR (800 MHz, *1,1,2,2-C₂Cl₄-d2, 110° C. after 1 hr of temperature equilibration) of run 22 from Example 1.

FIG. 28B shows the partial ¹³C-NMR (200 MHz, *1,1,2,2-C₂Cl₄-d2) of run 22 from Example 1.

FIG. 29A shows the ¹H NMR (800 MHz, *1,1,2,2-C₂Cl₄-d2, 110° C. after 1 hr of temperature equilibration) of run 23 from Example 1.

FIG. 29B shows the partial ¹³C-NMR (200 MHz, *1,1,2,2-C₂Cl₄-d2) of run 23 from Example 1.

FIG. 30 shows the Partial ¹³C-NMR (200 MHz, *1,1,2,2-C2C14-d2) of run 18, 20-23 LCCTP iPMP from Example 1.

FIG. 31 shows the DSC full trace of a heat/cool/heat cycle, cycle 1 removed, with a ramp rate of 20° C./min from −70-200° C. of run 1 from Example 1.

FIG. 32 shows the DSC full trace of a heat/cool/heat cycle, cycle 1 removed, with a ramp rate of 20° C./min from −70-200° C. of run 2 from Example 1.

FIG. 33 shows the DSC full trace of a heat/cool/heat cycle, cycle 1 removed, with a ramp rate of 20° C./min from −70-200° C. of run 3 from Example 1.

FIG. 34 shows the DSC full trace of a heat/cool/heat cycle, cycle 1 removed, with a ramp rate of 20° C./min from −70-200° C. of run 4 from Example 1.

FIG. 35 shows the DSC full trace of a heat/cool/heat cycle, cycle 1 removed, with a ramp rate of 20° C./min from −70-200° C. of run 5 from Example 1.

FIG. 36 shows the DSC full trace of a heat/cool/heat cycle, cycle 1 removed, with a ramp rate of 20° C./min from −70-200° C. of run 6 from Example 1.

FIG. 37 shows the DSC trace of a heat/cool/heat cycle, cycle 1 removed, with a ramp rate of 20° C./min from −70-300° C. of run 7 from Example 1.

FIG. 38 shows the DSC trace of a heat/cool/heat cycle, cycle 1 removed, with a ramp rate of 20° C./min from −70-300° C. of run 8 from Example 1.

FIG. 39 shows the DSC trace of a heat/cool/heat cycle, cycle 1 removed, with a ramp rate of 20° C./min from −70-300° C. of run 9 from Example 1.

FIG. 40 shows the DSC trace of a heat/cool/heat cycle, cycle 1 removed, with a ramp rate of 20° C./min from −70-300° C. of run 10 from Example 1.

FIG. 41 shows the DSC full trace of a heat/cool/heat cycle, cycle 1 removed, with a ramp rate of 10° C./min from 30-280° C. of run 11 from Example 1.

FIG. 42 shows the DSC full trace of a heat/cool/heat cycle, cycle 1 removed, with a ramp rate of 10° C./min from 30-280° C. of run 12 from Example 1.

FIG. 43 shows the DSC full trace of a heat/cool/heat cycle, cycle 1 removed, with a ramp rate of 10° C./min from 30-280° C. of run 13 from Example 1.

FIG. 44 shows the DSC full trace of heat/cool/heat cycle, cycle 1 removed, with a ramp of 10° C./min from −70-300° C. of run 14 from Example 1.

FIG. 45 shows the DSC full trace of heat/cool/heat cycle, cycle 1 removed, with a ramp of 10° C./min from −70-300° C. of run 15 from Example 1.

FIG. 46 shows the DSC full trace of a heat/cool/heat cycle, cycle 1 removed, with a ramp rate of 20° C./min from 30-280° C. of run 16 from Example 1.

FIG. 47 shows the DSC full trace of a heat/cool/heat cycle, cycle 1 removed, with a ramp rate of 20° C./min from 30-280° C. of run 17 from Example 1.

FIG. 48 shows the DSC full trace of a heat/cool/heat cycle, cycle 1 removed, with a ramp rate of 10° C./min from −70-300° C. of run 19 from Example 1.

FIG. 49 shows the DSC full trace of a heat/cool/heat cycle, cycle 1 removed, with a ramp rate of 10° C./min from 30-280° C. of run 20 from Example 1.

FIG. 50 shows the DSC trace of a heat/cool/heat cycle, cycle 1 removed, with a ramp rate of 10° C./min from −70-300° C. of run 18 from Example 1.

FIG. 51 shows the DSC trace of a heat/cool/heat cycle, cycle 1 removed, with a ramp rate of 10° C./min from −70-300° C. of run 19 from Example 1.

FIG. 52 shows the DSC trace of a heat/cool/heat cycle, cycle 1 removed, with a ramp rate of 10° C./min from −70-300° C. of run 20 from Example 1.

FIG. 53 shows the DSC trace of a heat/cool/heat cycle, cycle 1 removed, with a ramp rate of 10° C./min from −70-300° C. of run 21 from Example 1.

FIG. 54 shows the DSC trace of a heat/cool/heat cycle, cycle 1 removed, with a ramp rate of 10° C./min from −70-300° C. of run 22 from Example 1.

FIG. 55 shows the DSC trace of a heat/cool/heat cycle, cycle 1 removed, with a ramp rate of 10° C./min from −70-300° C. of run 23 from Example 1.

FIG. 56 shows the stacked DSC trace of a heat/cool/heat cycle, cycle 1 removed, with a ramp rate of 10° C./min from −70-300° C. of run 18, 20-23 from Example 1.

FIG. 57 shows the GPC trace of aPMP from run 1 from Example 1.

FIG. 58 shows the GPC trace of aPMP from run 2 from Example 1.

FIG. 59 shows the GPC trace of aPMP from run 3 from Example 1.

FIG. 60 shows the GPC trace of aPMP from run 4 from Example 1.

FIG. 61 shows the GPC trace of aPMP from run 5 from Example 1.

FIG. 62 shows the GPC trace of aPMP from run 6 from Example 1.

FIG. 63 shows the GPC trace of PMP from run 7 from Example 1.

FIG. 64 shows the GPC trace of PMP from run 8 from Example 1.

FIG. 65 shows the GPC trace of PMP from run 9 from Example 1.

FIG. 66 shows the GPC trace of PMP from run 10 from Example 1.

FIG. 67 shows the High temperature (HT-) GPC trace of PMP from run 11 from Example 1. HT-GPC was taken at NIST, in trichlorobenzene (TCB) at 135° C., calibrated with styrene standards.

FIG. 68 shows the HT-GPC trace of PMP from run 12 from Example 1. HT-GPC was taken at NIST, in trichlorobenzene (TCB) at 135° C., calibrated with styrene standards.

FIG. 69 shows the HT-GPC trace of PMP from run 13 from Example 1. HT-GPC was taken at NIST, in trichlorobenzene (TCB) at 135° C., calibrated with styrene standards.

FIG. 70 shows the HT-GPC trace of PMP from run 14 from Example 1. HT-GPC was taken at NIST, in TCB at 135° C., calibrated with styrene standards.

FIG. 71 shows the HT-GPC trace of PMP from run 15 from Example 1. HT-GPC was taken at NIST, in TCB at 135° C., calibrated with styrene standards.

FIG. 72 shows the HT-GPC trace of PMP from run 16 from Example 1. HT-GPC was taken at NIST, in TCB at 135° C., calibrated with styrene standards.

FIG. 73 shows the HT-GPC trace of PMP from run 17 from Example 1. HT-GPC was taken at NIST, in TCB at 135° C., calibrated with styrene standards.

FIG. 74 shows the HT-GPC trace of PMP from run 18 from Example 1. HT-GPC was taken at NIST, in TCB at 135° C., calibrated with styrene standards.

FIG. 75 shows the HT-GPC trace of PMP from run 19 from Example 1. HT-GPC was taken at NIST, in TCB at 135° C., calibrated with styrene standards.

FIG. 76 shows the HT-GPC trace of run 20 from Example 1.

FIG. 77 shows the HT-GPC trace of run 21 from Example 1.

FIG. 78 shows the HT-GPC trace of run 22 from Example 1.

FIG. 79 shows the HT-GPC trace of run 23 from Example 1.

FIG. 80 shows the X-ray powder diffraction profiles (vertically displaced) of run 11, 14, and 16 from Example 1.

FIG. 81 shows the X-ray powder diffraction profiles (vertically displaced) of run 7 (Hf LCP) from Example 1.

FIG. 82 shows the X-ray powder diffraction profile of completely amorphous PMP of run 2 (Hf LCCTP) from Example 1.

FIG. 83 shows the two-state competing LCCTP strategy for producing new viscoelastic grades of polyolefins, where hₐ and hᵢ are the number-average length of atactic and isotactic sequences, respectively.

FIG. 84 shows the origin of differences in viscoelastic properties of different grades of stereoblends and blocky stereoblock polyolefins arising from the relative number and size of crystalline domain crosslinks relative to the amorphous matrix.

FIG. 85 shows the Experimental methods employed to investigate the two-state competing LCCTP strategy of FIG. 83.

FIG. 86 shows the stress-strain curves from DMA of selected samples from Table 5 and actual blend of aPMP and iPMP (II). Numerals refer to run numbers and X signifies a breaking point.

FIG. 87 shows the photos of PMP from run 3 (top) and iPMP from run 10 (bottom) from Example 2 being subjected to a deformable strain.

FIG. 88 shows the (a) Partial ¹³C{¹H}(200 MHz, TCE-d₂, 110° C.) NMR spectra showing ¹³C resonances for C₁ and C₃ of PMP and (b) partial DSC traces of the second heating ramp (10° C./min), with bold numbers indicating measured T_{g} and Tₘ values, obtained for runs 0, 2, 4, 6, 8, and 10 of Table 5 (bottom to top).

FIG. 89 shows the (a) Partial ¹³C{¹H}(200 MHz, TCE-d₂, 110° C.) NMR spectra showing ¹³C resonances for C₁ and C₃ of PMP and (b) partial DSC traces the second heating ramp (10° C./min), with bold numbers indicating measured T_{g} and Tₘ values obtained according to (top) run 5 from Example 2, (middle) the insoluble fraction and (bottom) the soluble fraction obtained by Soxhlet extraction with hexanes.

FIG. 90 shows the (a) HT-SEC and (b) CEF obtained according to (top) run 5 from Example 2, (middle) the insoluble fraction and (bottom) the soluble fraction obtained by Soxhlet extraction with hexanes.

FIG. 91 shows the (a) HT-SEC and (b) CEF traces, obtained for runs 0, 2, 4, 6, and 8 of Table 5 (bottom to top).

FIG. 92A shows the ¹H NMR spectrum of atactic poly(4-methyl-1-pentene), Run 0 (800 MHz, *1,1,2,2-Tetrachloroethane-d2, 110° C.) from Example 2.

FIG. 92B shows the ¹³C{¹H}NMR spectrum of atactic poly(4-methyl-1-pentene), Run 0 (200 MHz, * 1,1,2,2-Tetrachloroethane-d2, 110° C.) from Example 2.

FIG. 93A shows the ¹H NMR spectrum of poly(4-methyl-1-pentene) blend, Run 1 (800 MHz, *1,1,2,2-Tetrachloroethane-d2, 110° C.) from Example 2.

FIG. 93B shows the ¹³C{¹H}NMR spectrum of poly(4-methyl-1-pentene) blend, Run 1 (200 MHz, *1,1,2,2-Tetrachloroethane-d2, 110° C.) from Example 2.

FIG. 94A shows the ¹H NMR spectrum of poly(4-methyl-1-pentene) blend, Run 2 (800 MHz, *1,1,2,2-Tetrachloroethane-d2, 110° C.) from Example 2.

FIG. 94B shows the ¹³C{¹H}NMR spectrum of poly(4-methyl-1-pentene) blend, Run 2 (200 MHz, *1,1,2,2-Tetrachloroethane-d2, 110° C.) from Example 2.

FIG. 95A shows the ¹H NMR spectrum of poly(4-methyl-1-pentene) blend, Run 3 (800 MHz, *1,1,2,2-Tetrachloroethane-d2, 110° C.) from Example 2.

FIG. 95B shows the ¹³C{¹H}NMR spectrum of poly(4-methyl-1-pentene) blend, Run 3 (200 MHz, *1,1,2,2-Tetrachloroethane-d2, 110° C.) from Example 2.

FIG. 96A shows the ¹H NMR spectrum of poly(4-methyl-1-pentene) blend, Run 4 (800 MHz, *1,1,2,2-Tetrachloroethane-d2, 110° C.) from Example 2.

FIG. 96B shows the ¹³C{¹H}NMR spectrum of poly(4-methyl-1-pentene) blend, Run 4 (200 MHz, *1,1,2,2-Tetrachloroethane-d2, 110° C.) from Example 2.

FIG. 97A shows the ¹H NMR spectrum of poly(4-methyl-1-pentene) blend, Run 5 (800 MHz, *1,1,2,2-Tetrachloroethane-d2, 110° C.) from Example 2.

FIG. 97B shows the ¹³C{¹H}NMR spectrum of poly(4-methyl-1-pentene) blend, Run 5 (200 MHz, *1,1,2,2-Tetrachloroethane-d2, 110° C.) from Example 2.

FIG. 98A shows the ¹H NMR spectrum of isotactic poly(4-methyl-1-pentene), from insoluble fraction Run 5 (800 MHz, *1,1,2,2-Tetrachloroethane-d2, 110° C.) from Example 2.

FIG. 98B shows the ¹³C{¹H}NMR spectrum of isotactic poly(4-methyl-1-pentene), from insoluble fraction Run 5 (200 MHz, *1,1,2,2-Tetrachloroethane-d2, 110° C.) from Example 2.

FIG. 99A shows the ¹H NMR spectrum of atactic poly(4-methyl-1-pentene), from soluble fraction Run 5 (800 MHz, *1,1,2,2-Tetrachloroethane-d2, 110° C.) from Example 2.

FIG. 99B shows the ¹³C{¹H}NMR spectrum of atactic poly(4-methyl-1-pentene), from soluble fraction Run 5 (200 MHz, *1,1,2,2-Tetrachloroethane-d2, 110° C.) from Example 2.

FIG. 100A shows the ¹H NMR spectrum of poly(4-methyl-1-pentene) blend, Run 6 (800 MHz, *1,1,2,2-Tetrachloroethane-d2, 110° C.) from Example 2.

FIG. 100B shows the ¹H NMR spectrum of poly(4-methyl-1-pentene) blend, Run 6 (800 MHz, *1,1,2,2-Tetrachloroethane-d2, 110° C.) from Example 2.

FIG. 101A shows the ¹H NMR spectrum of poly(4-methyl-1-pentene) blend, Run 7 (800 MHz, *1,1,2,2-Tetrachloroethane-d2, 110° C.) from Example 2.

FIG. 101B shows the ¹³C{¹H}NMR spectrum of poly(4-methyl-1-pentene) blend, Run 7 (200 MHz, *1,1,2,2-Tetrachloroethane-d2, 110° C.) from Example 2.

FIG. 102A shows the ¹H NMR spectrum of poly(4-methyl-1-pentene) blend, Run 8 (800 MHz, *1,1,2,2-Tetrachloroethane-d2, 110° C.) from Example 2.

FIG. 102B shows the ¹³C{¹H}NMR spectrum of poly(4-methyl-1-pentene) blend, Run 8 (200 MHz, *1,1,2,2-Tetrachloroethane-d2, 110° C.) from Example 2.

FIG. 103A shows the ¹H NMR spectrum of poly(4-methyl-1-pentene) blend, Run 9 (800 MHz, *1,1,2,2-Tetrachloroethane-d2, 110° C.) from Example 2.

FIG. 103B shows the ¹³C{¹H}NMR spectrum of poly(4-methyl-1-pentene) blend, Run 9 (200 MHz, *1,1,2,2-Tetrachloroethane-d2, 110° C.) from Example 2.

FIG. 104A shows the ¹H NMR spectrum of isotactic poly(4-methyl-1-pentene), Run 10 (800 MHz, *1,1,2,2-Tetrachloroethane-d2, 110° C.) from Example 2.

FIG. 104B shows the ¹³C{¹H}NMR spectrum of isotactic poly(4-methyl-1-pentene), Run 10 (200 MHz, *1,1,2,2-Tetrachloroethane-d2, 110° C.) from Example 2.

FIG. 105A shows the ¹H NMR spectrum of isotactic poly(4-methyl-1-pentene), Run 11 (800 MHz, *1,1,2,2-Tetrachloroethane-d2, 110° C.) from Example 2.

FIG. 105B shows the ¹³C{¹H}NMR spectrum of isotactic poly(4-methyl-1-pentene), Run 11 (200 MHz, *1,1,2,2-Tetrachloroethane-d2, 110° C.) from Example 2.

FIG. 106A shows the ¹H NMR spectrum of handmade blend II (800 MHz, *1,1,2,2-Tetrachloroethane-d2, 110° C.) from Example 2.

FIG. 106B shows the ¹³C{¹H}NMR spectrum of handmade blend II (200 MHz, *1,1,2,2-Tetrachloroethane-d2, 110° C.) from Example 2.

FIG. 107 shows the partial ¹³C{¹H}NMR spectra of a) Run 11, b) Run 10, and c) Run 0 (200 MHz, *1,1,2,2-Tetrachloroethane-d2, 110° C.) from Example 2.

FIG. 108A shows the SEC of atactic poly(4-methyl-1-pentene), Run 0 from Example 2.

FIG. 108B shows the CEF of atactic poly(4-methyl-1-pentene), Run 0 from Example 2.

FIG. 109A shows the SEC of poly(4-methyl-1-pentene) blend, Run 1 from Example 2.

FIG. 109B shows the CEF of poly(4-methyl-1-pentene) blend, Run 1 from Example 2.

FIG. 110A shows the SEC of poly(4-methyl-1-pentene) blend, Run 2 from Example 2.

FIG. 110B shows the CEF of poly(4-methyl-1-pentene) blend, Run 2 from Example 2.

FIG. 111A shows the SEC of poly(4-methyl-1-pentene) blend, Run 3 from Example 2.

FIG. 111B shows the CEF of poly(4-methyl-1-pentene) blend, Run 3 from Example 2.

FIG. 112A shows the SEC of poly(4-methyl-1-pentene) blend, Run 4 from Example 2.

FIG. 112B shows the CEF of poly(4-methyl-1-pentene) blend, Run 4 from Example 2.

FIG. 113A shows the SEC of poly(4-methyl-1-pentene) blend, Run 5 from Example 2.

FIG. 113B shows the CEF of poly(4-methyl-1-pentene) blend, Run 5 from Example 2.

FIG. 114A shows the SEC of isotactic poly(4-methyl-1-pentene), from insoluble fraction Run 5 from Example 2. Mn=21.5 kDa, Ð=2.50.

FIG. 114B shows the CEF of isotactic poly(4-methyl-1-pentene), from insoluble fraction Run 5 from Example 2.

FIG. 115A shows the SEC of atactic poly(4-methyl-1-pentene), from soluble fraction Run 5 from Example 2. Mn=1.63 kDa, Ð=1.23.

FIG. 115B shows the CEF of atactic poly(4-methyl-1-pentene), from soluble fraction Run 5 from Example 2.

FIG. 116A shows the SEC of poly(4-methyl-1-pentene) blend, Run 6 from Example 2.

FIG. 116B shows the CEF of poly(4-methyl-1-pentene) blend, Run 6 from Example 2.

FIG. 117A shows the SEC of poly(4-methyl-1-pentene) blend, Run 7 from Example 2.

FIG. 117B shows the CEF of poly(4-methyl-1-pentene) blend, Run 7 from Example 2.

FIG. 118A shows the SEC of poly(4-methyl-1-pentene) blend, Run 8 from Example 2.

FIG. 118B shows the CEF of poly(4-methyl-1-pentene) blend, Run 8 from Example 2.

FIG. 119A shows the SEC of poly(4-methyl-1-pentene) blend, Run 9 from Example 2.

FIG. 119B shows the CEF of poly(4-methyl-1-pentene) blend, Run 9 from Example 2.

FIG. 120A shows the SEC of poly(4-methyl-1-pentene) blend, Run 10 from Example 2.

FIG. 120B shows the CEF of poly(4-methyl-1-pentene) blend, Run 10 from Example 2.

FIG. 121A shows the SEC of poly(4-methyl-1-pentene) blend, Run 11 from Example 2.

FIG. 121B shows the CEF of poly(4-methyl-1-pentene) blend, Run 11 from Example 2.

FIG. 122 shows the DSC trace of poly(4-methyl-1-pentene) blend, run 0 (exo up) from Example 2. Heat/cool/heat cycle with a heating and cooling ramp of 20° C./min from −30-250° C.

FIG. 123 shows the DSC trace of poly(4-methyl-1-pentene) blend, run 1 (exo up) from Example 2. Heat/cool/heat cycle with a heating and cooling ramp of 10° C./min from −70-300° C.

FIG. 124 shows the DSC trace of poly(4-methyl-1-pentene) blend, run 2 (exo up) from Example 2. Heat/cool/heat cycle with a heating and cooling ramp of 10° C./min from −70-300° C.

FIG. 125 shows the DSC trace of poly(4-methyl-1-pentene) blend, run 3 (exo up) from Example 2. Heat/cool/heat cycle with a heating and cooling ramp of 10° C./min from −70-300° C.

FIG. 126 shows the DSC trace of poly(4-methyl-1-pentene) blend, run 4 (exo up) from Example 2. Heat/cool/heat cycle with a heating and cooling ramp of 10° C./min from −70-300° C.

FIG. 127 shows the DSC trace of poly(4-methyl-1-pentene) blend, run 5 (exo up) from Example 2. Heat/cool/heat cycle with a heating and cooling ramp of 10° C./min from −70-300° C.

FIG. 128 shows the DSC trace of isotactic poly(4-methyl-1-pentene), from insoluble fraction run 5 (exo up) from Example 2. Heat/cool/heat cycle with a heating and cooling ramp of 10° C./min from −30-250.

FIG. 129 shows the DSC trace of atactic poly(4-methyl-1-pentene), from soluble fraction run 5 (exo up) from Example 2. Heat/cool/heat cycle with a heating and cooling ramp of 10° C./min from −30-250° C.

FIG. 130 shows the DSC trace of poly(4-methyl-1-pentene) blend, run 6 (exo up) from Example 2. Heat/cool/heat cycle with a heating and cooling ramp of 10° C./min from −70-300° C.

FIG. 131 shows the DSC trace of poly(4-methyl-1-pentene) blend, run 7 (exo up) from Example 2. Heat/cool/heat cycle with a heating and cooling ramp of 10° C./min from −70-300° C.

FIG. 132 shows the DSC trace of poly(4-methyl-1-pentene) blend, run 8 (exo up) from Example 2. Heat/cool/heat cycle with a heating and cooling ramp of 10° C./min from −70-300° C.

FIG. 133 shows the DSC trace of poly(4-methyl-1-pentene) blend, run 9 (exo up) from Example 2. Heat/cool/heat cycle with a heating and cooling ramp of 10° C./min from −70-300° C.

FIG. 134 shows the DSC trace of poly(4-methyl-1-pentene) blend, run 10 (exo up) from Example 2. Heat/cool/heat cycle with a heating and cooling ramp of 10° C./min from −30-250° C.

FIG. 135 shows the DSC trace of poly(4-methyl-1-pentene) blend, run 11 (exo up) from Example 2. Heat/cool/heat cycle with a heating and cooling ramp of 10° C./min from −30-250° C.

FIG. 136 shows the DSC trace of poly(4-methyl-1-pentene) blend II (exo up) from Example 2. Heat/cool/heat cycle with a heating and cooling ramp of 10° C./min from −30-250° C.

### DETAILED DESCRIPTION

The present disclosure provides a method for producing a spectrum of new “grades” of poly(4-methyl-1-pentene) (PMP) in which technologically important viscoelastic properties and phase transition temperatures can be modified in systematic fashion through formation of physical blends consisting of amorphous atactic PMP and semicrystalline isotactic PMP in different ratios. In this way, the strong, but brittle nature of highly crystalline isotactic PMP with a high melting temperature of 250° C., which is commercialized under the TPX tradename by Mitsui (Japan), can be modified to produce PMP “stereoblends” with increased elasticity and melt temperature. Both atactic and isotactic PMP components are obtained from the same olefin monomer, but a new spectrum of grades of PMP can be generated through simple blends to produce new materials of technological importance for a range of end-use applications.

“Metallocene” is used herein to mean any organometallic coordination complex containing at least one or more σ-bonded or ηⁿ-bonded ligands coordinated with a metal atom from Groups IIIB to VIII or the Lanthanide series of the Periodic Table of the Elements. An example of a σ-bonded or ηⁿ-bonded ligand is the cyclopentadienyl ring. Examples of the metal atoms are the metals of Group IVB such as titanium, zirconium, or hafnium.

A stereoregular macromolecule is understood to be a macromolecule that comprises substantially one species of stereorepeating unit. Examples include, but are not limited to, an isotactic macromolecule, a syndiotactic macromolecule, and an atactic macromolecule. A stereoblock macromolecule is understood to be a block macromolecule composed of at least one or more stereoregular, and possibly, non-stereoregular blocks.

An atactic polymer is a regular polymer, the molecules of which have equal numbers of the possible configurational base units in a random sequence distribution. In an atactic polymer, the polymer microstructure will contain stereo centers along the polymer backbone that have random relative configurations.

An isotactic polymer is a polymer in which all the substituents are located on the same side of the macromolecular backbone.

An amorphous polymer is a polymer in which there is no long-range order amongst different polymer chains that would impart crystallinity to the material.

As used herein, the term “polyolefin” comprises olefin homopolymers, co-polymers, and block copolymers.

“Living polymerization” is used herein to mean a polymerization process with substantially no chain-growth stopping reactions, such as irreversible chain transfer and chain termination. Living polymerization allows for control over molecular weights and provide narrow molecular weight distributions, “Dormant species” is used to mean a species that cannot actively engage in propagation through chain enchainment of the monomer until it is converted into an active species through a reversible chemical process, such as a polymer chain coordinated to a neutral metal center. “Active species” is used in mean a species that can engage in propagation through chain enchainment of the monomer, such as a polymer chain coordinated to a cationic metal center. “Surrogate species” is used to define a main group metal alkyl that cannot engage in direct propagation through chain-enchainment of monomer but that can engage in reversible polymer chain transfer with an active or dormant species with a rate of chain-transfer that is at least equal in magnitude to that of the rate of propagation but preferably several times faster.

Coordinative chain-transfer polymerization (CCTP) employs added equivalents of a metal alkyl that can serve in the capacity of “surrogate” metal chain-growth sites. CCTP employs highly efficient and reversible chain (polymeryl group, P_{A} and P_{B}) transfer between active transition metal propagating centers (M_{A}) and chain-growth-inactive main group metal alkyl centers (M_{B}). If the rate constant for chain-transfer exchange between the active and inactive metal centers, k_{ct}, is several times greater than the rate constant for propagation, kₚ, then both the transition and main group metal centers will effectively appear to engage in chain-growth propagation at the same rate while also maintaining all the desired features of a living polymerization (Hustad, P. D., et al., Macromolecules 41:4081-4089 (2008); Müller, A. H. E., et al., Macromolecules 28:4326-4333 (1995)). Indeed, under these conditions, Xₙ, will be governed by both the quantity of monomer consumed and the total concentration of all polymeryl groups, P_{A} and P_{B}, that are formally engaged in active chain growth and more precisely by: Xₙ={[monomer]ₜ−[monomer]₀}/([(M−P_{A})⁺+(n)(M′−P_{B})]₀); where n is the number of equivalent polymeryl groups per main group metal (e.g. n=2 for ZnR₂). The molecular weight polydispersity index, D (=M_{w}Mₙ), will further be approximately determined by the relative magnitudes of the rate constants for these two processes according to: D≈1+(kₚ/k_{ct}) (Müller, A. H. E., et al., Macromolecules 28:4326-4333 (1995)). Finally, the quantity of polymer product is no longer capped by the amount of transition metal catalyst, but rather, on the total molar equivalents of the much less expensive and readily available main group metal alkyl (M_{B}) that is employed.

For successful realization of CCTP under living or non-living conditions, it has been demonstrated that substantial difficulties exist in identifying the right combinations of pre-initiator, co-initiator main group metal alkyl chain-transfer agent, and polymerization conditions under which rapid, reversible, and highly efficient chain-transfer (including chain-shuttling between two different active propagating centers) can occur (van Meurs, M., et al., J. Am. Chem. Soc. 127:9913-9923 (2005); Alfano, F., et al., Macromolecules 40:7736-7738 (2007)).

LCCTP is based on the rapid and reversible polymeryl group (chain) transfer between active transition-metal propagating centers and excess equivalents of inactive main-group-metal alkyl species serving as ‘surrogate’ chain growth sites. Living coordinative chain transfer polymerization (LCCTP) can be considered as degenerative chain-transfer coordination polymerization, which is mechanistically distinct from a living degenerative group transfer coordination polymerization process. See Zhang, Y., et al., J. Am. Chem. Soc. 125:9062-9069 (2003); Zhang, Y., et al., J. Am. Chem. Soc. 126:7776-7777 (2004); Harney, M. B., et al., Angew. Chem. Int. Ed. 45:2400-2404 (2006); and Harney, M. B., et al., Angew. Chem. Int. Ed. 45:6140-6144 (2006)), the contents of which are incorporated here by reference in entirety.

Monomodal in molecular weight distribution (MWD) is used herein to mean a composition of polymers that comprise one distinct molecular weight distribution. Typically, the MWD is a range of molecular weights that may range in a number average molecular weight (Mₙ) of about 500 Da to about 500,000 Da. The MWD of a polymer can be measured using any method known to one skilled in the relevant art, for example, size exclusion chromatography and gel permeation chromatography (GPC).

“Dispersity index” is used herein as a measure of the MWD for a given polymer composition. The polydispersity index is a ratio of weight average molecular weight (M_{w}) to number average molecular weight (Mₙ).

### Catalyst

Metallocene catalysts (e.g., initiators) for use in the present invention include any metallocene pre-initiator that initiates the polymerization of an olefin monomer. Specific examples include, but are not limited to single-site metallocene pre-initiator such as those disclosed in Hlalky, et al., J. Am. Chem. Soc. 111:2728-2729 (1989); K. C. Jayaratne, et al., J. Am. Chem. Soc. 122:958-959 (2000); K. C. Jayaratne, et al., J. Am. Chem. Soc. 122:10490-10491 (2000); R. J. Keaton, et al., J. Am. Chem. Soc. 122:12909-12910 (2000) and R. J. Keaton, et al., J. Am. Chem. Soc. 123:6197-6198 (2001), the contents of which are incorporated here by reference in entirety.

In one embodiment, the metallocene pre-initiator for use in the present invention has the formula:

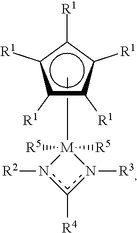

wherein the dotted lines indicate a delocalized bond;
M is Ti, Zr, Hf, V, Nb, or Ta;
each R¹ is independently hydrogen or alkyl or two adjacent R¹ form an aromatic ring;
each R², R³, and R⁴ is independently alkyl, cycloalkyl, Si(alkyl)₃, Si(aryl)₃, phenyl, optionally substituted phenyl, or alkylphenyl; and
each R⁵ is halo, alkyl, cycloalkyl, aryl, or arylalkyl.

As used herein, “alkyl” refers to straight- or branched-chain hydrocarbons having from 1 to 10 carbon atoms and more preferably 1 to 8 carbon atoms, including by way of example methyl, ethyl, propyl, iso-propyl, iso-butyl, and t-butyl.

“Aryl” by itself or as part of another group refers to monocyclic, bicyclic, or tricyclic aromatic groups containing 6 to 14 carbon atoms in the ring position. Useful aryl groups include C₆₋₁₄ aryl, preferably C₆₋₁₀ aryl. Typical C₆₋₁₄ aryl groups include phenyl, naphthyl, indenyl, phenanthrenyl, anthracenyl, fluorenyl, and biphenyl groups.

“Arylalkyl” refers to an alkyl group mentioned above substituted by a single aryl group including, by way of example, benzyl, phenethyl, and naphthylmethyl.

“Alkylarylalkyl” refers to an alkyl group mentioned above substituted by a single aryl group, wherein the aryl group is further substituted by one or more alkyl groups. Examples include, without limitation, 4-methylbenzyl and 4-ethylphenethyl.

“Cycloalkyl” refers to cyclic alkyl groups containing between 3 and 8 carbon atoms having a single cyclic ring including, by way of example, cyclopropyl, cyclobutyl, cyclopentyl, cyclooctyl, and the like.

“Optionally substituted phenyl” refers to a phenyl ring which may contain 1 to 5 electron donating or electron withdrawing groups. By way of example, electron-donating groups include, but are not limited to amino, hydroxy, alkoxy, amide, aryl, and alkyl. Examples of electron withdrawing groups include, but are not limited to, halo, ketone, ester, —SO₃H, aldehyde, carboxylic acid, cyano, nitro, and ammonium.

“Alkylphenyl” refers to an alkyl group mentioned above substituted by a single phenyl group including, by way of example, benzyl, 1-phenethyl, 1-phenylpropyl, 1-phenylbutyl, 2-phenethyl, 2-phenylpropyl, 2-phenylbutyl, 3-phenylpropyl, and 3-phenylbutyl.

“Halo” refers to fluoro, chloro, bromo, and iodo.

“Aromatic ring” refers to an unsaturated carbocyclic group of 6 to 14 carbon atoms having a single ring (e.g., phenyl) or multiple condensed rings (e.g., naphthyl or anthryl). The metallocene catalysts of the present invention can be prepared using any suitable method known to one skilled in the relevant art.

In some embodiments, the metallocene pre-initiator is (η⁵−C₅Me₅)Hf(Me)₂[N(Et)C(Me)N(Et)], (η⁵−C₅Me₅)ZrMe₂[N(Et)C(Me)N(^{t}Bu)], or a combination thereof.

The co-initiator is capable of activating the metallocene pre-initiator. Preferably, the co-initiator is one of the following: (a) ionic salts of the general formula [A⁺][⁻BR64], wherein A⁺ is Si(R⁷)₃, a cationic Lewis acid or a cationic Brönsted acid, B is the element boron, R⁶ is phenyl or an optionally substituted phenyl or (b) a boron alkyl of the general formula BR⁶₃ and each R⁷ is independently selected from alkyl and optionally substituted phenyl. Examples of Lewis or Brönsted acids that may be used in the practice of the invention include, but are not limited to, tetra-n-butylammonium, triphenylcarbonium, and dimethylanilinium cations.

The co-initiator can be strongly coordinating co-catalyst or a weakly coordinating co-catalyst.

Examples of co-initiators for use in the present invention include, but are not limited to, [PhNHMe₂][B(C₆F₅)₄], [Ph₃C][B(C₆F₅)₄], and B(C₆F₅)₃.

In some embodiments, the co-initiator is [PhNHMe₂][B(C₆F₅)₄].

### Chain Transfer Agent

In some embodiments, the chain transfer agent comprises a metal alkyl. The metal alkyl is capable of activating reversible chain transfer with active transition metal-based propagating centers. Examples of metal alkyls that may be used in the practice of this invention include main group metal alkyls such as Zn(R⁸)₂ and Al(R⁸)₃, wherein R⁸ is an alkyl. Mixtures comprised of two or more metal alkyls may also be used in the practice of this invention.

Non-limiting examples of metal alkyls for use in the present invention include ZnEt₂, ZnMe₂, Zn(n-butyl)₂, Zn(isoamyl)₂, Zn(t-butyl)₂, Zn(neopentyl)₂, Zn(n-propyl)₂, Zn(iso-propyl)₂, AlEt₃, AlMe₃, Al(iso-butyl)₃, Al(n-hexyl)₃, Al(n-propyl)₃, and Al(t-butyl)₃.

In some embodiments, the chain transfer agent is ZnEt₂.

### Olefin Monomer

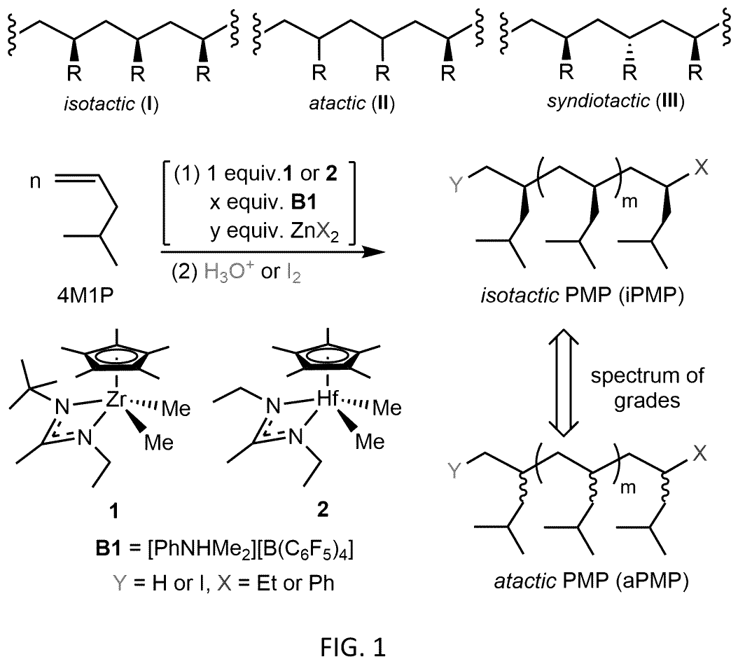

FIG. 1 depicts limiting tactic forms of polyolefins. The highly stereoregular isotactic form I (R=Me) that is depicted in FIG. 1 is a semicrystalline, thermoplastic with a high melting temperature, Tₘ, of 165° C. that renders it suitable for the manufacture of sterilizable cutlery, medical devices, and food packaging, to name a few, whereas the stereorandom atactic form II is an amorphous material with a low glass transition temperature, T_{g}, of −10° C. and it is of little commercial value. Other limiting forms of tacticity are also possible, such as syndiotactic III. However, the real power of Natta's tacticity concept comes with the understanding that, between any two limiting forms, a spectrum comprised of an infinite number of grades exist that differ with respect to the type and level of incorporation of ‘stereoerrors’ as one descends in stereoregularity (e.g., from isotactic to atactic). For PP, the properties of these different tacticity grades transition from being plastics to plastomers to elastomers as the level of stereoerror incorporation increases. Incredibly, though, despite the clear opportunities that exist for the discovery and development of new polyolefin materials through the programmed ‘stereoengineering’ of tacticity, to date, no other structural family of polyolefin has received the same level of interest, progress, or success, as that of PP.

Olefin monomers suitable for use in the invention include, but are not limited to, 4-methyl-1-pentene, ethene, propene, 1-butene, 1-pentene, 1-hexene, 1-heptene, 1-octene, styrene, butadiene, isoprene, α-methyl styrene, acrylonitrile, methyl acrylate, methyl methacrylate, vinyl acetate, vinyl chloride, vinyl fluoride, vinylidene chloride, N-vinyl pyrrolidone, 3-methylbutene, 3-methyl-1-pentene, vinylcyclohexane, vinylcyclobutane, vinylcyclopentane, vinylcyclooctane, 1-decene, enantiomerically pure β-citronellene, 3,5,5-trimethyl-1-hexene, cyclopentene, or vinylcyclohexene.

In some embodiments, the olefin monomer is 4-methyl-1-pentene.

Isotactic PMP (iPMP) was first reported by Natta and coworkers nearly 70 years ago as a semicrystalline thermoplastic with a high Tₘ value of 250° C. and other physical properties that are suitable for a range of applications, such as microwave oven cookware, food packaging, and optical lenses, to name a few. Importantly, the commercial viability of iPMP is secured by the availability of 4M1P as a monomer that is produced on an industrial scale through the alkali-metal-catalyzed dimerization of propene. However, iPMP still has some serious drawbacks as a structural material, such as being brittle with low tensile strength.¹²

Regarding tacticity/property relationships for PMP, the literature is very sparse, but also fraught with errors and confusion arising from incompletely or poorly characterized materials. More to the point, Griffith and Rånby (GR) reported using dilatometric measurements to establish T_{g} values for a series of PMP materials that were of unspecified molar mass and tacticity and simply noted as being ‘of varying degrees of crystallinity’. A T_{g} value of 29° C. was established for an ‘amorphous’ PMP sample, while a lower T_{g} of 18° C. was obtained for an iPMP material with 78% crystallinity. These investigators concluded that this surprising trend of T_{g} values decreasing with increasing crystallinity was most likely due to the crystalline phase being less dense than the amorphous phase of isotactic PMP. It is important to note here that the term amorphous is not synonymous with an atactic microstructure.

Very recently, Veige, Sumerlin and co-workers (VS) have cited the GR study in support of their claim of having synthesized cyclic atactic PMP (c-aPMP) through a novel ring-expanding metathesis polymerization of 4-methyl-1-pentyne, followed by hydrogenation of the intermediate unsaturated cyclic poly(4-methyl-1-pentyne) material. This c-aPMP material was further stated as having a number-average molar mass index, Mₙ, of 99 kDa, and a molar mass distribution dispersity, Ð(=M_{w}/Mₙ), of 1.30, where M_{w} is the weight-average molar mass index. By employing a different metathesis catalyst, these investigators also then produced, through the same two-step process, a high molar mass linear atactic PMP material (l-aPMP) with Mₙ=141 kDa and Ð=1.37. Importantly, differential scanning calorimetry (DSC) analysis of this l-aPMP reference provided a T_{g} value of 29° C., while their c-aPMP material displayed a much higher T_{g} value of 39±0.1° C. It is well-known that a cyclic polymer should display a higher T_{g} value relative to its linear counterpart due to the lack of end groups, and so it is reasonable that the observed 10° C. increase in T_{g} was concluded by these investigators as being key supporting evidence for the proposed unique cyclic structure of their c-aPMP material. Finally, a solvent-cast bulk sample of this c-aPMP displayed excellent optical transparency and it was inferred that this property is due to the cyclic nature of the material. However, our own investigations with the LCP of 4M1P raise questions regarding the validity of both the GR and VS results as these pertain to amorphous and atactic linear PMP.

The present disclosure clears up past misunderstandings or misinformation regarding this fundamental polyolefin material, and provides a foundation for the increased use of aPMP for science and technology. Further, the present disclosure provides methods of producing new viscoelastic grades of PMP in a controlled fashion.

### Methods

Methods for producing a spectrum of new “grades” of polyolefin composition in which viscoelastic properties can be modulated are disclosed herein. Further provided are methods of preparing atactic poly(4-methyl-1-pentene) (aPMP).

One aspect of the present disclosure provides a method for preparing a polyolefin composition. The method comprises reacting an olefin monomer with a first metallocene pre-initiator, a second metallocene pre-initiator, a co-initiator, and a chain transfer agent in a liquid medium, thereby polymerizing the olefin monomer to produce the polyolefin composition. The polyolefin composition may comprise a blend of atactic polyolefin and isotactic polyolefin.

In some embodiments, the olefin monomer is 4-methyl-1-pentene, ethene, propene, 1-butene, 1-pentene, 1-hexene, 1-heptene, 1-octene, styrene, butadiene, isoprene, 3-methylbutene, 3-methyl-1-pentene, vinylcyclohexane, vinylcyclobutane, vinylcyclopentane, vinylcyclooctane, 1-decene, enantiomerically pure β-citronellene, 3,5,5-trimethyl-1-hexene, cyclopentene, or vinylcyclohexene. In some embodiments, the olefin monomer is 4-methyl-1-pentene.

In some embodiments, the polyolefin composition comprises a blend of atactic poly(4-methyl-1-pentene) (aPMP) and isotactic poly(4-methyl-1-pentene) (iPMP).

In some embodiments, the liquid medium comprises one or more solvents. In some embodiments, the method disclosed herein comprises mixing the olefin monomer and the chain transfer agent in the first solvent to form a first mixture; mixing the first metallocene pre-initiator, the second metallocene pre-initiator, and the co-initiator in the second solvent to form a second mixture; contacting the first mixture and the second mixture, and polymerizing the olefin monomer by living coordinative chain transfer polymerization.

In some embodiments, the ratio of iPMP and aPMP may be tuned by adjusting the ratio of the first and second pre-initiators. For example, in some embodiments, the ratio of iPMP:aPMP increases as the ratio of the second pre-initiator to the first pre-initiator increases.

In some embodiments, the crystallinity of the polyolefin composition may be tuned by adjusting the ratio of the first and second pre-initiators. For example, in some embodiments, crystallinity of the polyolefin composition increases as the ratio of the second pre-initiator to the first pre-initiator increases.

In some embodiments, the first metallocene pre-initiator comprises (η⁵-C₅Me₅)Hf(Me)₂[N(Et)C(Me)N(Et)] and the second metallocene pre-initiator comprises (η⁵-C₅Me₅)ZrMe₂[N(Et)C(Me)N(^{t}Bu)].

In some embodiments, the co-initiator comprises [PhNHMe₂][B(C₆F₅)₄].

In some embodiments, the chain transfer agent comprises ZnR₂. R may be selected from the group consisting of methyl, ethyl, n-butyl, isoamyl, t-butyl, neopentyl, n-propyl, and iso-propyl. In some embodiments, the chain transfer agent comprises ZnEt₂.

The molar ratio of the co-initiator to the total amount of the first and second pre-initiators may vary. In some embodiments, the molar ratio of the co-initiator to the total amount of the first and second pre-initiators may be at least 0.8:1, at least 1:1, at least 1.1:1, at least 1.2:1, at least 1.3:1, at least 1.4:1, at least 1.5:1, at least 1.6:1, at least 1.7:1, at least 1.8:1, at least 1.9:1, at least 2:1, at least 2.2:1, or at least 2.5:1. In some embodiments, the molar ratio of the co-initiator to the total amount of the first and second pre-initiators may be from about 0.8:1 to about 3:1, from about 1:1 to about 2.5:1, from about 1:1 to about 2:1, from about 1:1 to about 1.8:1, from about 1:1 to about 1.6:1, from about 1:1 to about 1.4:1, or from about 1:1 to about 1.2:1. In some embodiments, the molar ratio of the co-initiator to the total amount of the first and second pre-initiators may be about 1.1:1.

The molar ratio of the chain transfer agent to the total amount of the first and second pre-initiators may vary. In some embodiments, The molar ratio of the chain transfer agent to the total amount of the first and second pre-initiators may be at least 0.8:1, at least 1:1, at least 1.5:1, at least 2:1, at least 2.5:1, at least 3:1, at least 3.5:1, at least 4:1, at least 4.5:1, at least 5:1, at least 5.5:1, at least 6:1, at least 10:1, at least 25:1, at least 50:1, at least 100:1, at least 150:1, at least 200:1, at least 250:1, at least 300:1, at least 350:1, or at least 400:1. In some embodiments, the molar ratio of the chain transfer agent to the total amount of the first and second pre-initiators may be from about 1:1 to about 400:1, from about 1:1 to about 350:1, from about 1:1 to about 300:1, from about 1:1 to about 250:1, from about 1:1 to about 200:1, from about 1:1 to about 150:1, from about 1:1 to about 100:1, from about 1:1 to about 50:1, from about 1:1 to about 25:1, from about 1:1 to about 15:1, from about 1:1 to about 10:1, from about 2:1 to about 12:1, from about 3:1 to about 10:1, from about 3:1 to about 8:1, or from about 4:1 to about 6:1. In some embodiments, The molar ratio of the chain transfer agent to the total amount of the first and second pre-initiators may be about 5:1.

Another aspect of the present disclosure provides a method of preparing atactic poly(4-methyl-1-pentene) (aPMP). The method comprises reacting 4-methyl-1-pentene monomer with: a pre-initiator selected from the group consisting of (η⁵-C₅Me₅)Hf(Me)₂[N(Et)C(Me)N(Et)], (η⁵-C₅Me₅)ZrMe₂[N(Et)C(Me)N(^{t}Bu)], and a combination thereof; and a co-initiator in a liquid medium, thereby producing the atactic poly(4-methyl-1-pentene) (aPMP).

In some embodiments, the co-initiator comprises [PhNHMe₂][B(C₆F₅)₄].

The molar ratio of the co-initiator to the pre-initiator may vary. In some embodiments, the molar ratio of the co-initiator to the pre-initiator may be from about 0.01:1 to about 2:1, from about 0.05:1 to about 1.5:1, or from about 0.1:1 to about 1.1:1. For example, the molar ratio of the co-initiator to the pre-initiator can be about 0.1:1, about 0.25:1, about 0.50:1, about 0.75:1, about 0.85:1, about 0.95:1, or about 1.1:1.

In some embodiments, the method comprises reacting 4-methyl-1-pentene monomer with a chain transfer agent in the liquid medium. In some embodiments, the chain transfer agent comprises ZnEt₂.

The molar ratio of the chain transfer agent to the pre-initiator may vary. In some embodiments, the molar ratio of the chain transfer agent to the pre-initiator may be from about 1:1 to about 400:1, from about 1:1 to about 350:1, from about 1:1 to about 300:1, from about 1:1 to about 250:1, from about 1:1 to about 200:1, from about 1:1 to about 150:1, from about 1:1 to about 100:1, from about 1:1 to about 50:1, from about 1:1 to about 40:1, from about 3:1 to about 400:1, from about 3:1 to about 300:1, from about 3:1 to about 200:1, from about 3:1 to about 100:1, from about 3:1 to about 50:1, from about 3:1 to about 35:1, or from about 5:1 to about 30:1. For example, in some embodiments, the molar ratio of the chain transfer agent to the pre-initiator may be about 5:1, or about 30:1.

### Composition

Another aspect of the present disclosure provides a polyolefin composition produced by the methods disclosed herein. Another aspect of the present disclosure provides a polyolefin composition comprising a blend of atactic poly(4-methyl-1-pentene) (aPMP) and isotactic poly(4-methyl-1-pentene) (iPMP).

The polyolefin composition as described herein may comprise a blend of aPMP and iPMP at various weight percentages. For example, the polyolefin composition described herein may comprise between 0.1 wt. % and 99.9 wt. % of aPMP and between 99.9 wt. % and 0.1 wt. % of iPMP. In some embodiments, the mass ratio of aPMP to iPMP is about 1:99 to about 99:1, including for example about 5:95, about 10:90, about 20:80; about 50:50, about 20:80; about 90:10, or about 99:1. In some embodiments, the mass ratio of aPMP to iPMP is about 10:90, about 1:1.5 (or about 40:60), about 1:3 (or about 25:75), about 2:1 (or about 67:33), about 4:1 (or 80:20), about 90:10, or about 20:1 (or 95.2:4.8).

In some embodiments, the aPMP in the polyolefin composition described herein may have a number-average molar mass index of from about 0.2 KDa to about 10.0 KDa, from about 0.2 KDa to about 5.0 KDa, or from about 0.2 KDa to about 3.0 KDa. For example, in some embodiments, the aPMP in the polyolefin composition described herein may have a number-average molar mass index of about 0.5 KDa, about 0.8 KDa, about 0.9 KDa, about 1.0 KDa, about 1.3 KDa, about 1.4 KDa, about 1.6 KDa, about 1.7 KDa, or about 2.8 KDa. In some embodiments, the iPMP in the polyolefin composition described herein may have a number-average molar mass index of from about 1.0 to about 200 KDa, from about 1.0 to about 150 KDa, from about 1.0 to about 100 KDa, or from about 1.0 to about 45 KDa. For example, in some embodiments, the iPMP in the polyolefin composition described herein may have a number-average molar mass index of about 1.8 KDa, about 20.2 KDa, about 24.9 KDa, about 27.0 KDa, about 28.0 KDa, about 33.0 KDa, about 36.7 KDa, about 37.3 KDa, about 39.0 KDa, about 39.4 KDa, or about 40.6 KDa.

In some embodiments, the aPMP in the polyolefin composition described herein has a molar mass distribution dispersity of about 1.0 to about 2.5. For example, in some embodiments, the aPMP in the polyolefin composition described herein has a molar mass distribution dispersity of about 1.12, about 1.15, about 1.16, about 1.18, about 1.19, about 1.20, about 1.27, about 1.36, or about 2.00. In some embodiments, the iPMP in the polyolefin composition described herein has a molar mass distribution dispersity of about 1.0 to about 4.0. For example, in some embodiments, the iPMP in the polyolefin composition described herein has a molar mass distribution dispersity of about 1.40, about 1.47, about 1.50, about 1.65, about 1.70, about 1.90, about 2.12, about 2.14, about 3.00, or about 3.65.

In some embodiments, the polyolefin composition as described herein may have a melting temperature (Tₘ) of about 100° C. to about 240° C., about 150° C. to about 240° C., about 180° C. to about 240° C., or about 190° C. to about 230° C.

In some embodiments, the polyolefin composition as described herein may have a glass transition temperature (T_{g}) of about 5° C. to about 30° C. and the mass ratio of aPMP to iPMP is 1:1.7 or higher. For example, in some embodiments, the polyolefin composition as described herein may have a glass transition temperature (T_{g}) of about 7° C., about 13° C., about 18° C., about 19° C., about 20° C., or about 23° C., when the mass ratio of aPMP to iPMP equals to or is higher than 1:1.7.

In some embodiments, the polyolefin composition as described herein may have a crystallinity degree of from about 0.1% to about 80%, from about 0.1% to about 60%, from about 0.1% to about 40%, from about 0.5% to about 35%, or from about 0.9% to about 30%. For example, in some embodiments, the polyolefin composition as described herein may have a crystallinity degree of about 0.92%, about 1.92%, about 4.70%, about 5.12%, about 10.9%, about 13.0%, about 17.2%, about 18.1%, about 23.3%, about 25.7%, or about 29.9%.

In some embodiments, the polyolefin composition as described herein may have an elongation to break of at least 200%, at least 210%, or at least 220% and the mass ratio of aPMP to iPMP is 1.8:1 or higher. For example, in some embodiments, the polyolefin composition as described herein may have an elongation to break of 225%, about 336%, about 346%, or about 350%, when the mass ratio of aPMP to iPMP equals to or is higher than 1.8:1.

In some embodiments, the polyolefin composition as described herein may have a Young's modulus of about 0.1 to about 50 MPa, about 0.1 MPa to about 45 MPa, or about 0.1 to about 40 MPa, and the mass ratio of aPMP to iPMP is 1.2:1 or higher. For example, in some embodiments, the polyolefin composition as described herein may have a Young's modulus of about 0.77 MPa, 1.04 MPa, about 1.25 MPa, about 3.01 MPa, about 3.97 MPa, or about 38.8 MPa, when the mass ratio of aPMP to iPMP equals to or is higher than 1.2:1.

Another aspect of the present disclosure provides an atactic poly(4-methyl-1-pentene) (aPMP) produced by the methods disclosed herein.

In some embodiments, the aPMP as described herein may have a molar mass distribution dispersity of about 1.0 to about 2.5. For example, the aPMP as described herein can have a molar mass distribution dispersity of about 1.0, about 1.5, about 2.0, or about 2.5.

In some embodiments, the aPMP as described herein may have a glass transition temperature (T_{g}) of between about −50° C. and about 40° C., between about −25° C. and about 40° C., or between about 0° C. and about 40° C.

In some embodiments, the aPMP as described herein may have a crystallinity degree of about 0%.

In some embodiments, the aPMP as described herein may be amorphous.

### EXAMPLES

### Example 1

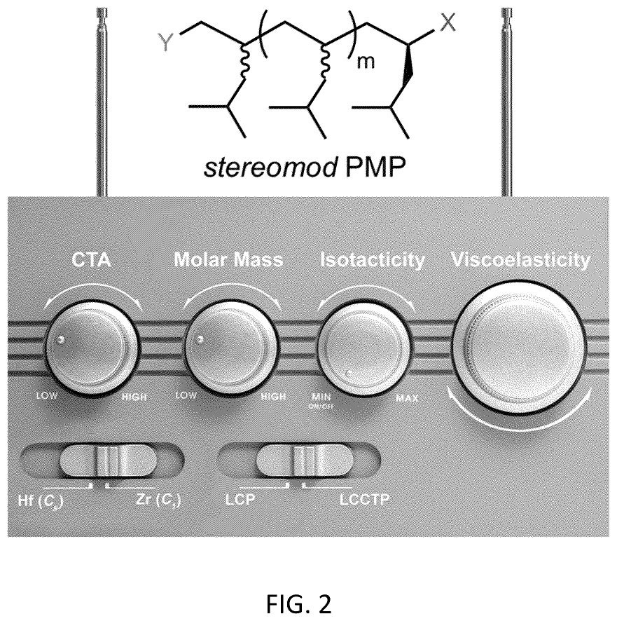

Disclosed herein is application of a toolbox of living coordination polymerization methods based on CPAM group 4 metal initiators to the stereomodulation of poly(4-methyl-1-pentene) (PMP) tacticity to provide new fundamental forms in which thermal phase transitions. T_{g} and Tₘ, can be adjusted over a wide range. (FIG. 2) Also reported herein are the synthesis and properties of authenticated 1,2-regioregular atactic PMP, which serves to correct past errors and misinformation regarding this fundamental polyolefin.

FIG. 1 presents a summary of the reagents and methods that were employed in the present study. The family of cyclopentadienyl, amidinate (CPAM) group 4 metal pre-initiators of general formula, (h⁵-C₅R₅)[(N,N′)-k²-N(R¹)C(R²)N(R³)]MMe₂ (M=Zr or Hf (I), which upon ‘activation’ with a stoichiometric equivalent of the anilinium borate co-initiator, [PhNHMe₂][B(C₆F₅)₄](B1), provides the corresponding ion pair initiators, {(h⁵-C₅R₅)[(N,N′)-k²-N(R¹)C(R²)N(R³)]-M(Me){B(C₆F₅)₄}(II). In the presence of excess equivalents of ethene or an a-olefin, propagation of active species derived from II then proceeds through 1,2-migratory insertion (1,2-MI) of the monomer into the growing polymer chain, which occurs in the absence of irreversible chain termination. As with other living polymerizations, this LCP process can be used to target a desired molar mass with a specific number-average degree of polymerization (DPₙ), and with a molar mass distribution (MMD) of the final polyolefin product typically being monomodal with a very small dispersity index, i.e. Ð≤1.1. The symmetry characteristics of I correlate with the tacticity of the polyolefin microstructure that is produced. More specifically, in the case of fully activated C₁-symmetric, chiral (but racemic) CPAM Zr pre-initiator 1 (FIG. 1), propagation proceeds in a highly stereoselective fashion to provide an isotactic microstructure through enantiomorphic site control that is enforced by nonbonded steric interactions of the supporting CPAM ligand sphere. Significantly, as the steric size of the a-olefin ‘tail’ increases, propagation can become isospecific (i.e. 100% stereoselective) in the extreme limit with no stereoerrors being incorporated. For example, with propene as monomer, enantioface selectivity, a, for olefin coordination to the transition-metal center, followed by 1,2-MI is high at 0.94, and this value translates to a mmmm pentad percent of 0.74 for the isotactic PP product as assessed by ¹³C{¹H}NMR spectroscopy, where m represents a meso dyad in which adjacent chain stereocenters have the same relative configuration. Regioselectivity, b, for 1,2- over 2,1-MI propagation with this monomer is also very high at a value >0.98, and the occurrence of a 2,1-regioerror does not lead to chain termination. In the case of 1-hexene, the larger steric size of the a-olefin tail now results in LCP with fully activated 1 being both stereo- and regiospecific (i.e. a=b=1.0) for the isotactic poly(1-hexene) (iPH) that is obtained. In contrast, with the Cₛ-symmetric CPAM Hf pre-initiator 2, full activation with B1 (x=1.1) (see FIG. 1) now provides a strictly atactic polyolefin microstructure and in the absence of any degree of stereodefining chain-end control being contributed by the growing polymer chain.

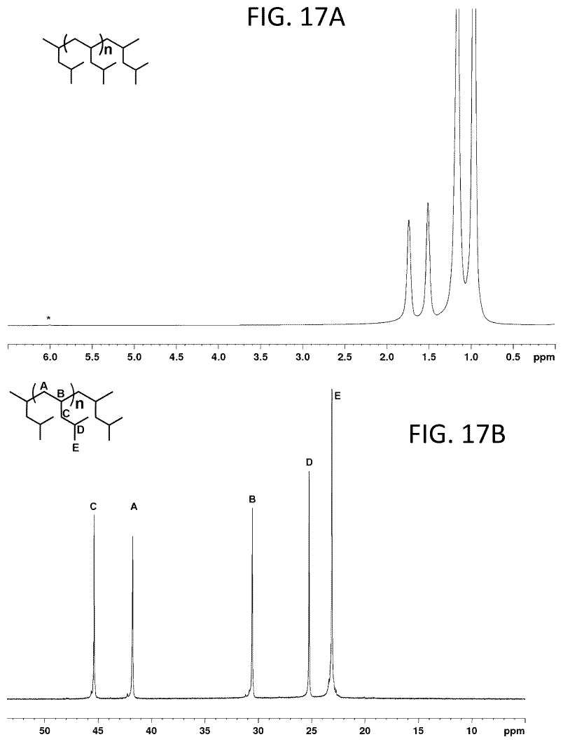

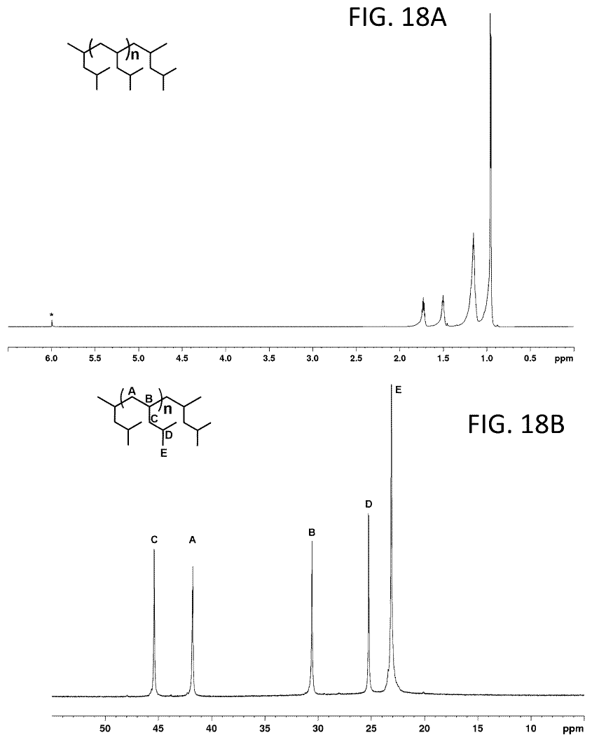

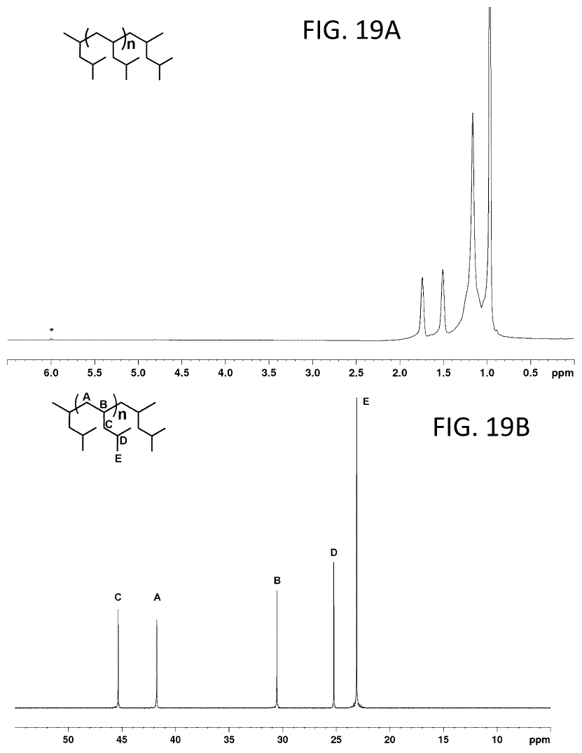

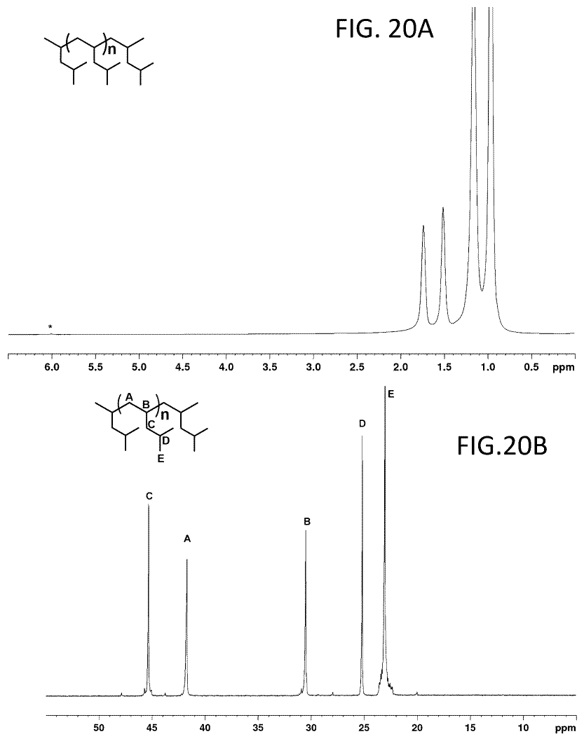

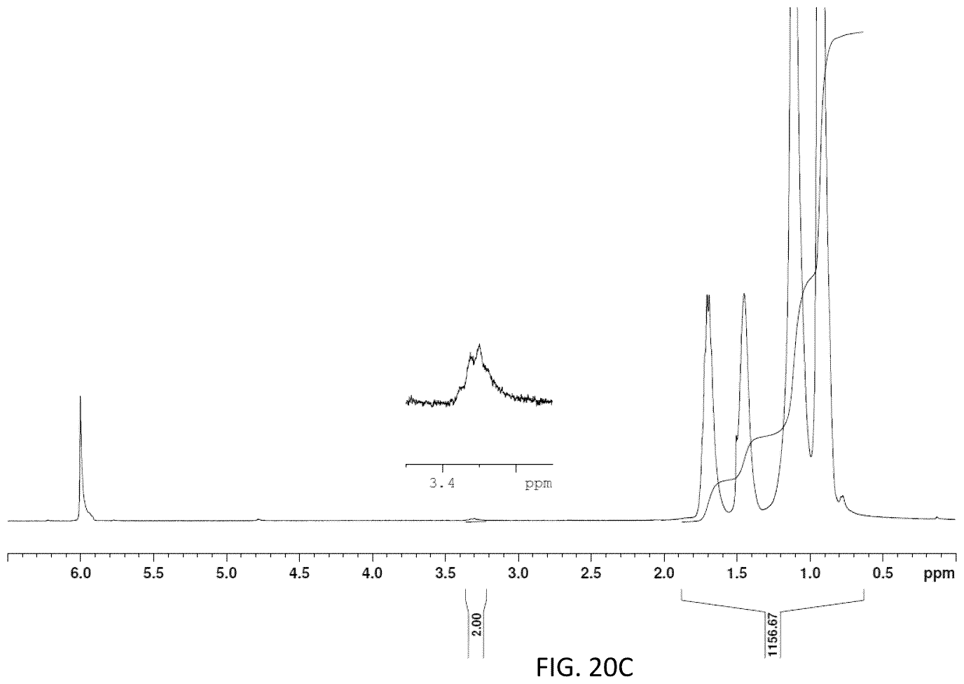

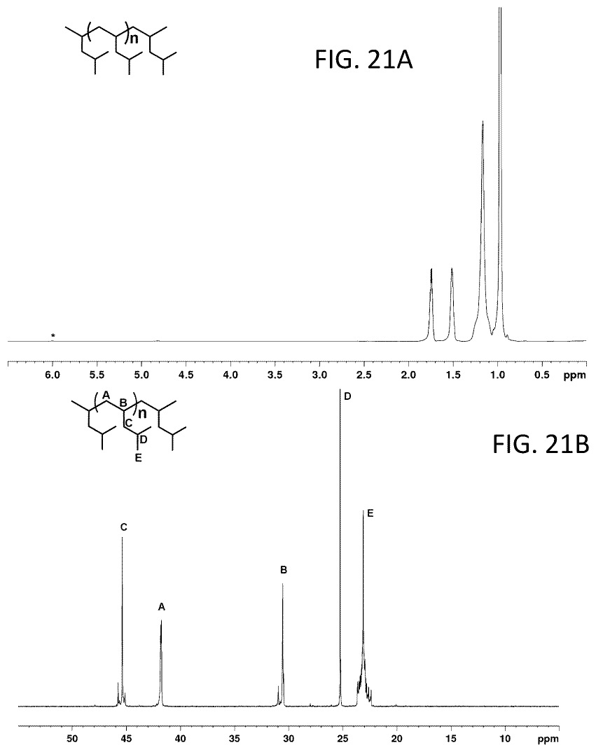

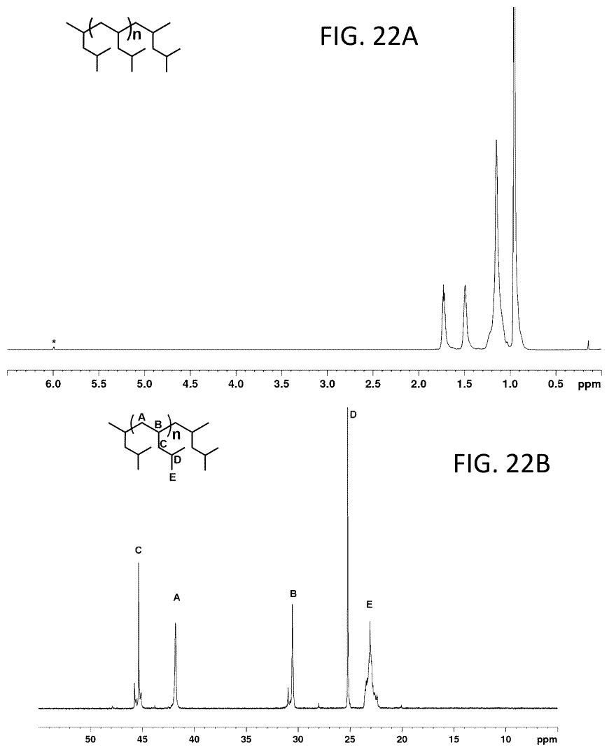

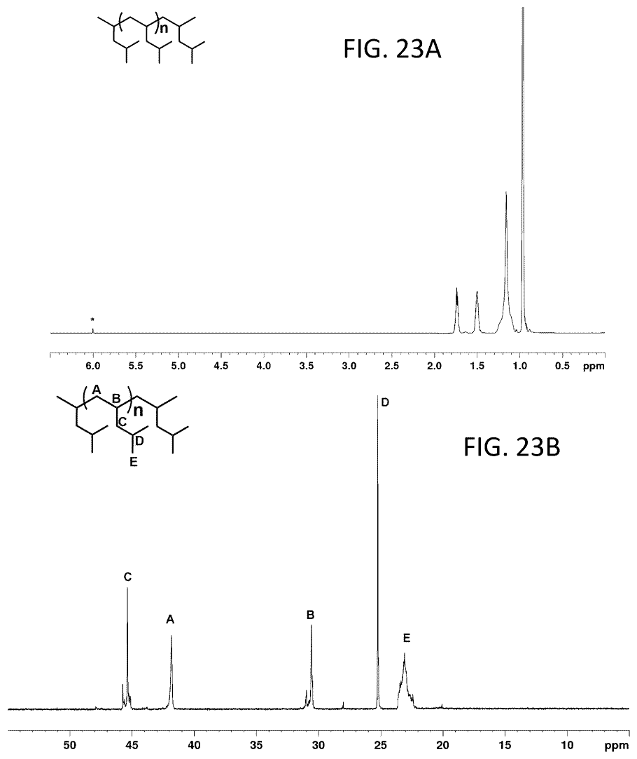

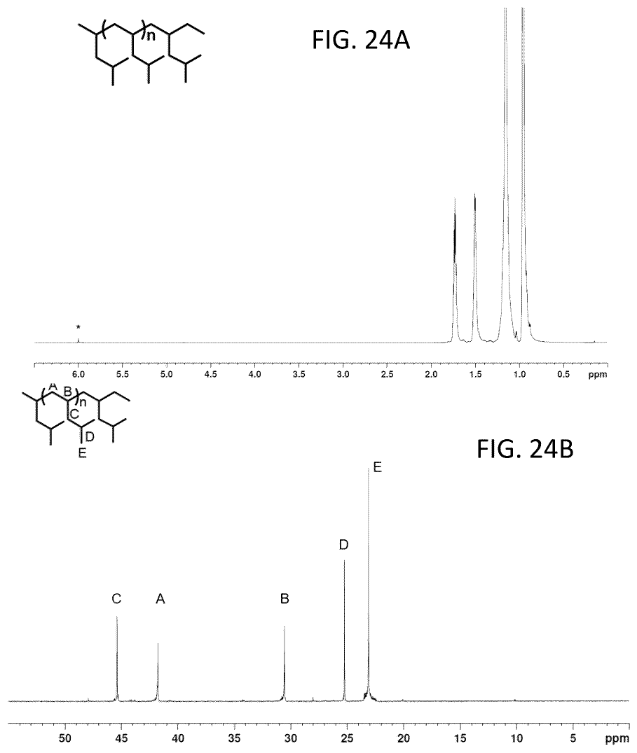

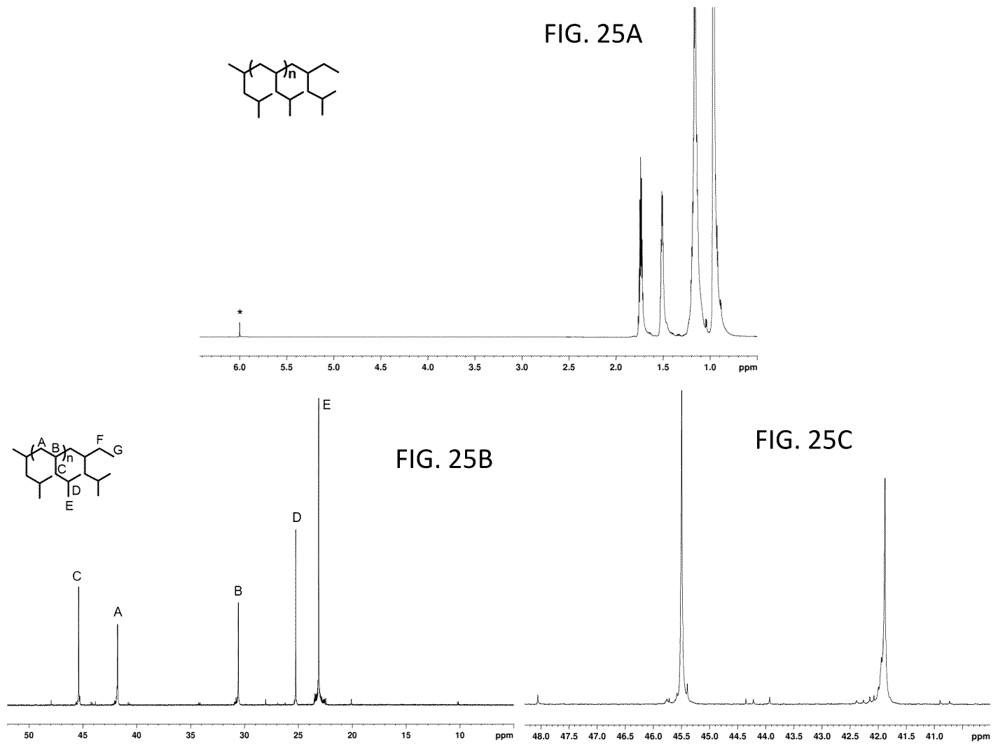

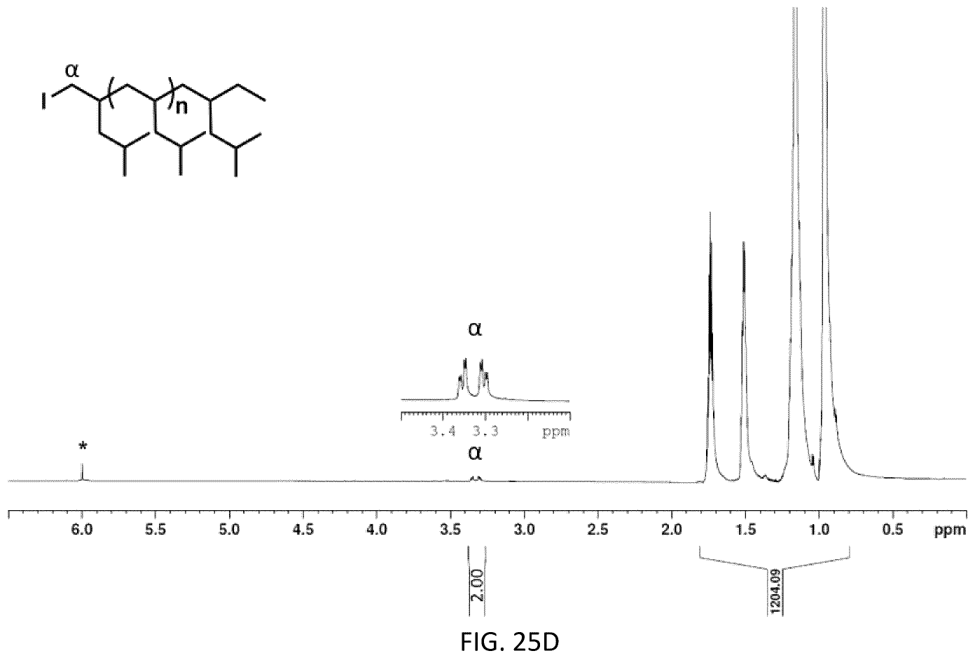

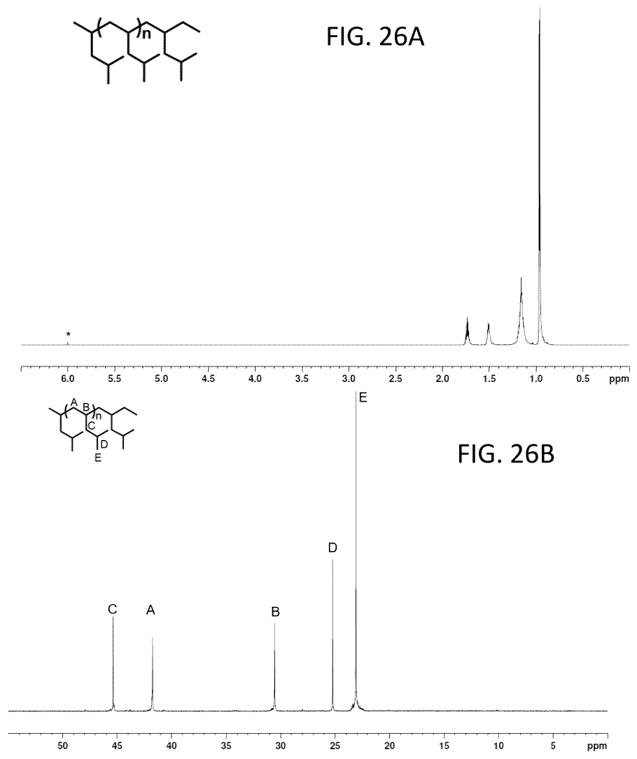

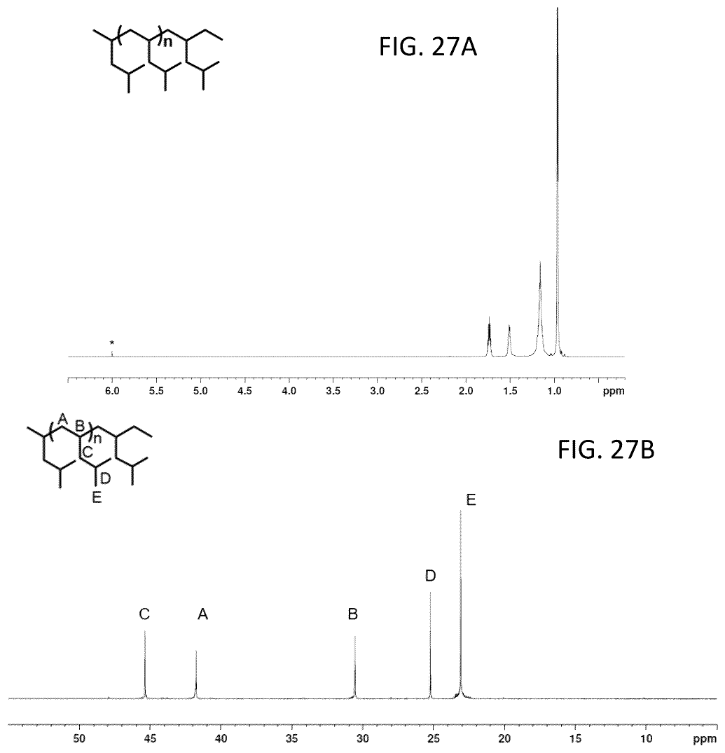

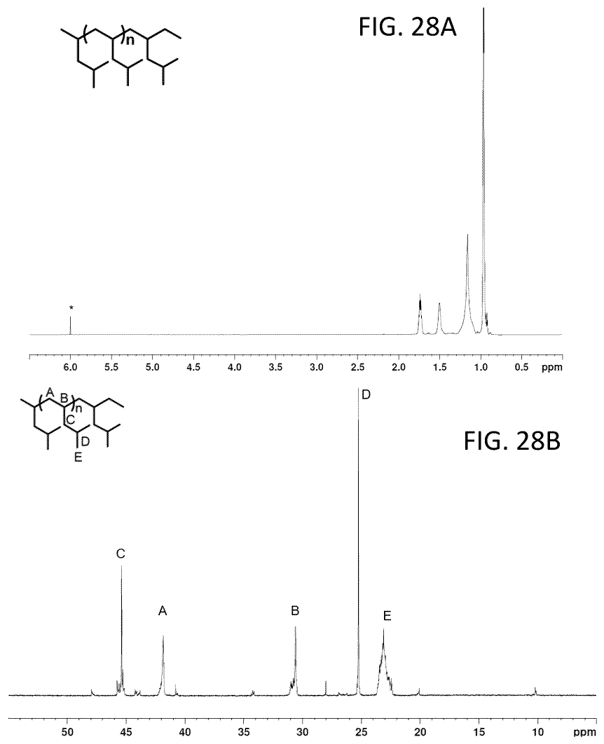

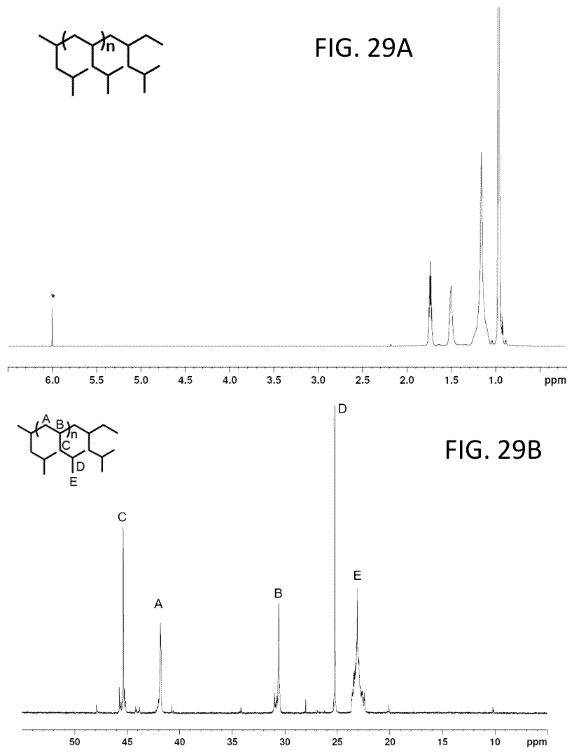

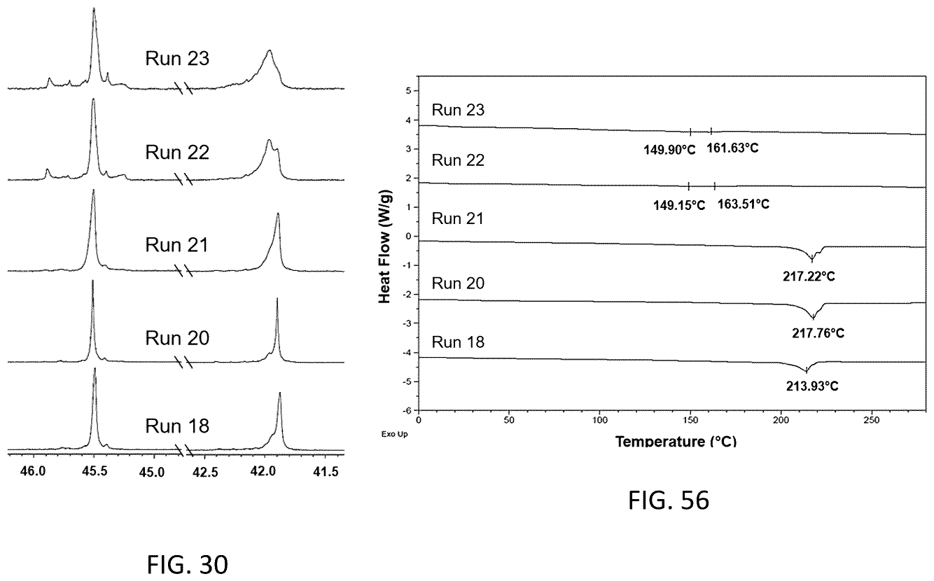

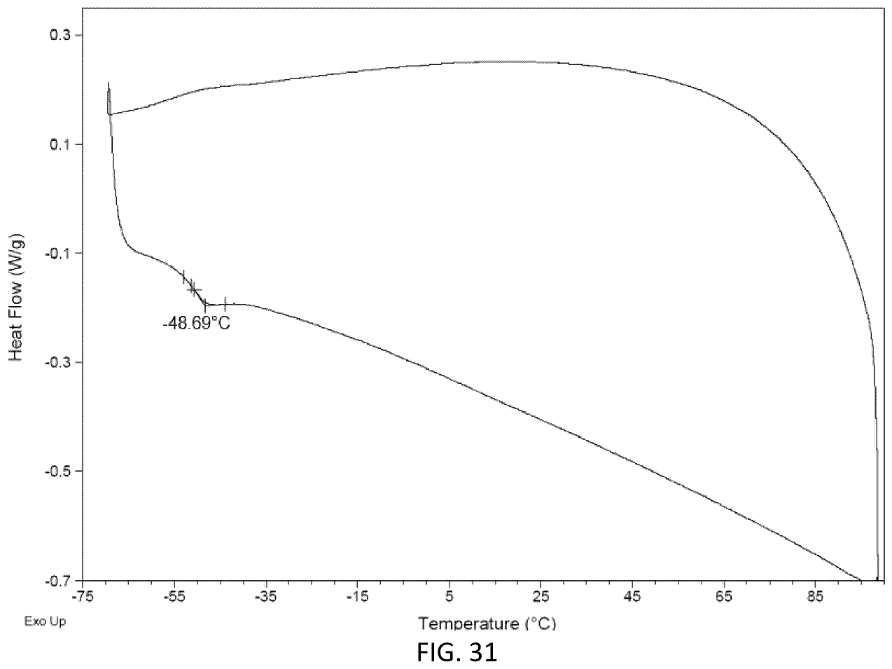

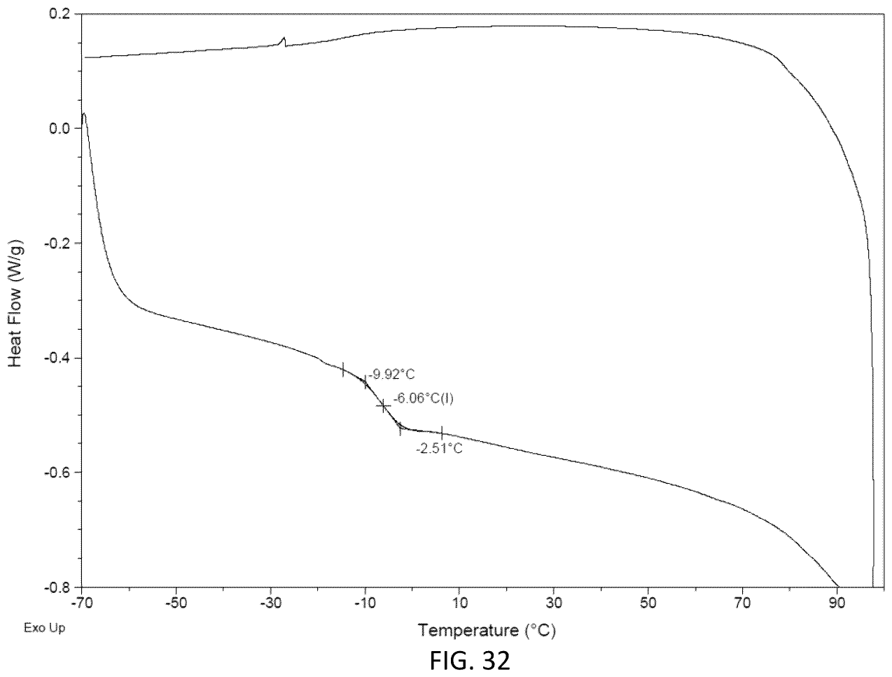

Armed with this background, the first goal of the present study was to determine the ability of fully activated 1 and 2 to provide reference samples for 1,2-regioregular iPMP (ref1) and aPMP (ref2), respectively. For these materials, the Mₙ values were targeted to be high enough at about 50 kDa in order to ensure that end groups do not contribute to the manifestation of bulk physical properties, nor appear as additional ¹³C NMR resonances. Thus, using our standard methods, ref1 (Mₙ=51.0 kDa, Ð=1.39) and ref2 (Mₙ '₂ 48.7 kDa, Ð=1.19) were produced through LCP using 1 and 2, respectively, and FIG. 1 presents the corresponding ¹³C{¹H}NMR (200 MHz) spectra for these materials in 1,1,2,2-tetrachloroethane-d₂ (TCE-d₂) at 110° C. Starting with isotactic ref1 (FIG. 3, panel a), the appearance of five sharp ¹³C resonances is consistent with ¹³C{¹H]NMR spectra reported for other highly regio- and stereoregular iPMP materials in which C5 and C6 of the geminal methyl groups of the isobutyl side chains appear as being magnetically equivalent due to the intrinsic Cₛ symmetry of a sufficiently long isotactic chain. In contrast, in the ¹³C{¹H}spectrum of atactic ref2 (FIG. 3, panel b), each of the corresponding ¹³C resonances are now broad, and this feature is undoubtedly due to the partial overlap of multiple resonances associated with different n′ad tacticity sequences. Unfortunately, due to the lack of sufficient chemical shift dispersion even at a magnetic field strength with a ¹³C resonance frequency of 200 MHz (800 MHz for ¹H), it is not possible to resolve and unequivocally assign individual chemical shifts for the ten possible pentad sequences. Accordingly, in the present study, we cannot perform the type of extensive quantitative ¹³C NMR investigations of stereochemical microstructure that have been reported for PP, and instead, only qualitative assessments and comparisons of the relative degree of stereoregularity for each member of a collection of PMP samples can be made. It must also be noted that, to the best that we can determine, FIG. 3, panel b now represents the first ¹³C NMR spectrum for authenticated 1,2-regioregular aPMP to have ever been published. We make this statement in light of the fact that the ¹³C NMR spectrum reported by VS for their 1-aPMP material and by Zambelli and co-workers for a PMP material that lacked any other characterization data, are not consistent with these being 1,2-regioregular. Finally, the ¹H NMR spectra for both ref1 and ref2 are consistent with the structure of PMP and that polymerizations have occurred in living fashion with the absence of termination by any b-hydrogen transfer process (see FIGS. 12A-12B and 17A-17B).

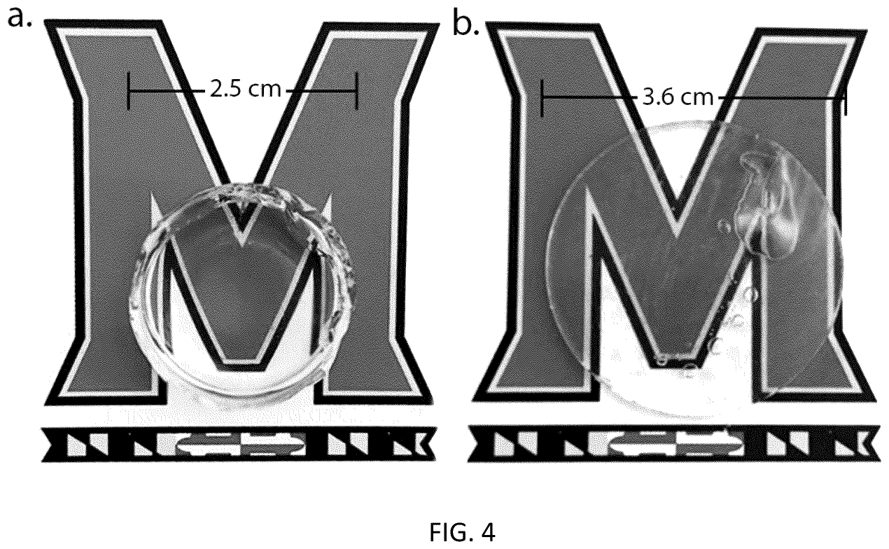

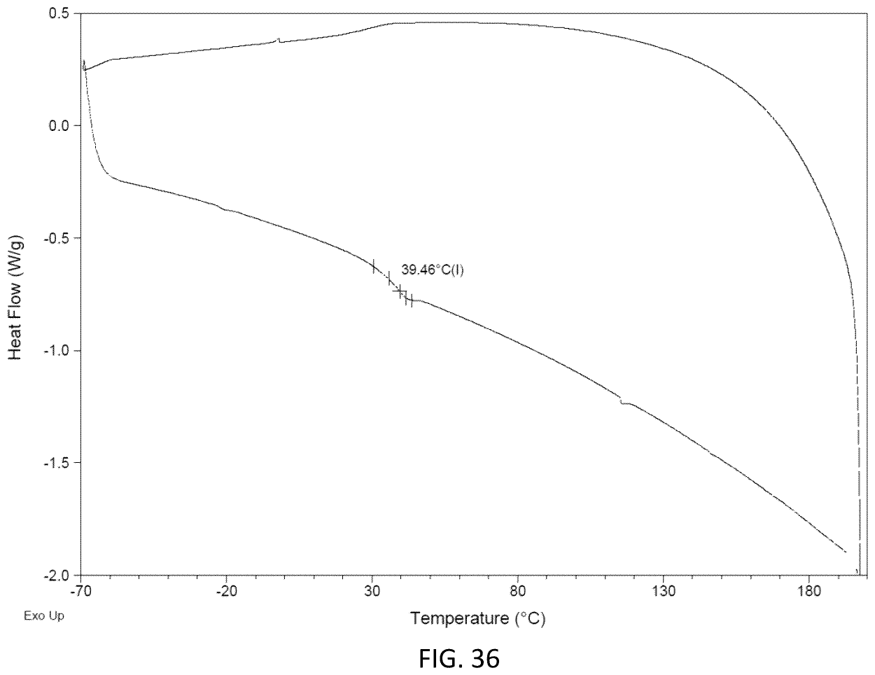

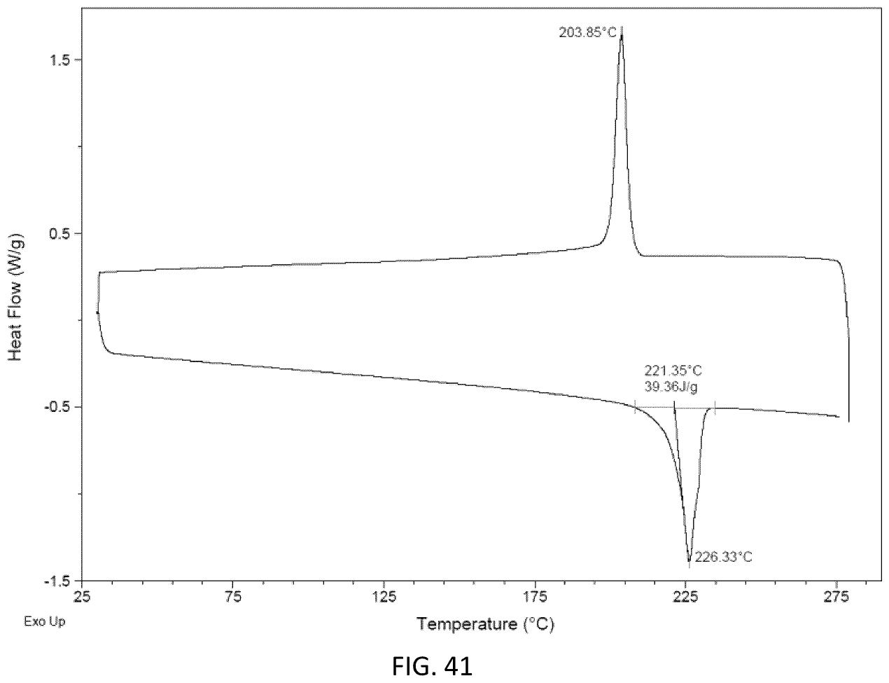

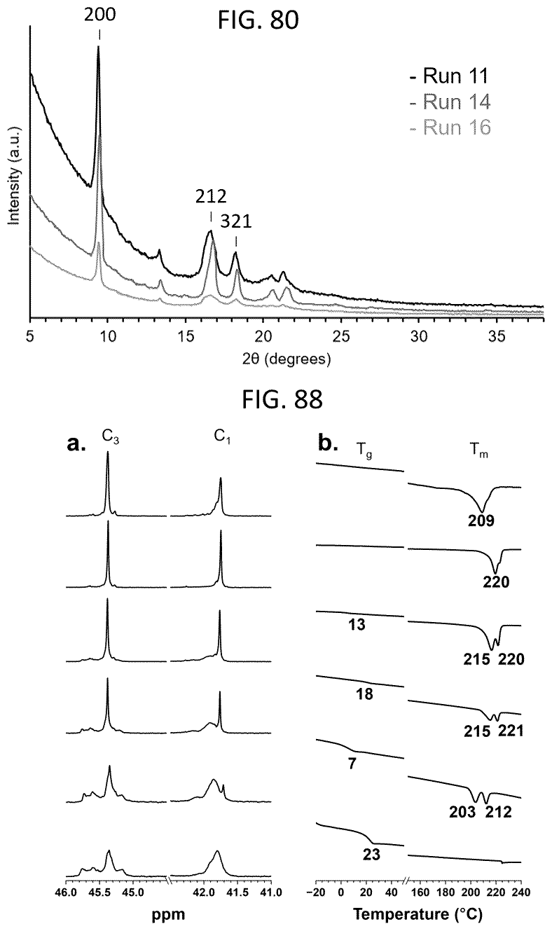

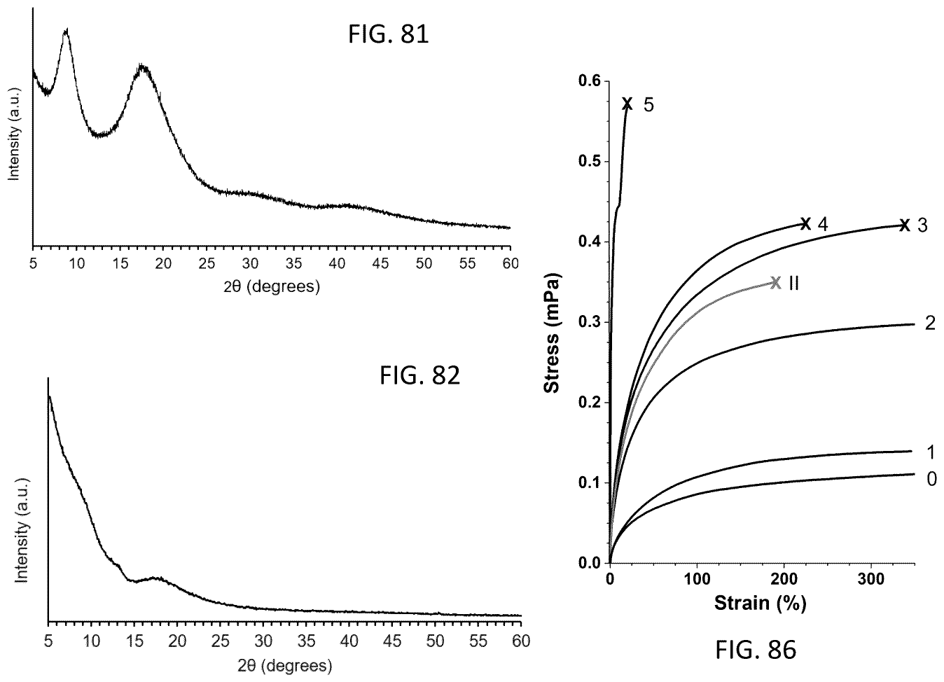

Powder x-ray diffraction analyses of ref1 and ref2 confirmed the semicrystalline and amorphous nature of these respective isotactic (Form I) and atactic PMP materials (see FIGS. 80 and 82). As a corollary, ref1 is only sparingly soluble in most organic solvents over a broad temperature range, and for this reason, we postulate that chain aggregation that is likely occurring in solutions of this material are contributing to the broader-than-expected MMD and higher D value as obtained through high temperature size-exclusion chromatography (HT-SEC, 1,3,5-trichlorobenzene, 150° C.). In contrast, atactic ref2 is exceedingly soluble in organic solvents even at room temperature, and normal SEC (THF, 40° C.) provided a MMD and D value that are now fully consistent with expectations of LCP. Upon removal of solvent, ref1 appears as a white flowable powder, whereas ref2 forms a very hard glass. Thermal analysis of these two materials by DSC (second cycle, 10° C. min⁻¹) revealed only a first-order Tₘ transition for ref1 at 226° C. for which a percent crystallinity (c) value of 34% was determined. In contrast, the DSC of ref2 now displayed only a second-order T_{g} transition, as expected, but quite surprisingly, with a high value of 39.5° C. (see FIGS. 36 and 41). Indeed, both the glass-like nature and high T_{g} value of ref2 prompted us to determine the ability to manufacture transparent optical disks of this material through both solvent casting (from hexane) at 25° C. and by injection molding (non-optimized) at 150° C. FIG. 4 presents the results of these efforts, and it is clear that in both cases, high optical transparency can be easily achieved and even for relatively thick objects (e.g. 0.5 cm thickness). Clearly, such transparency for aPMP is not limited to a cyclic form.

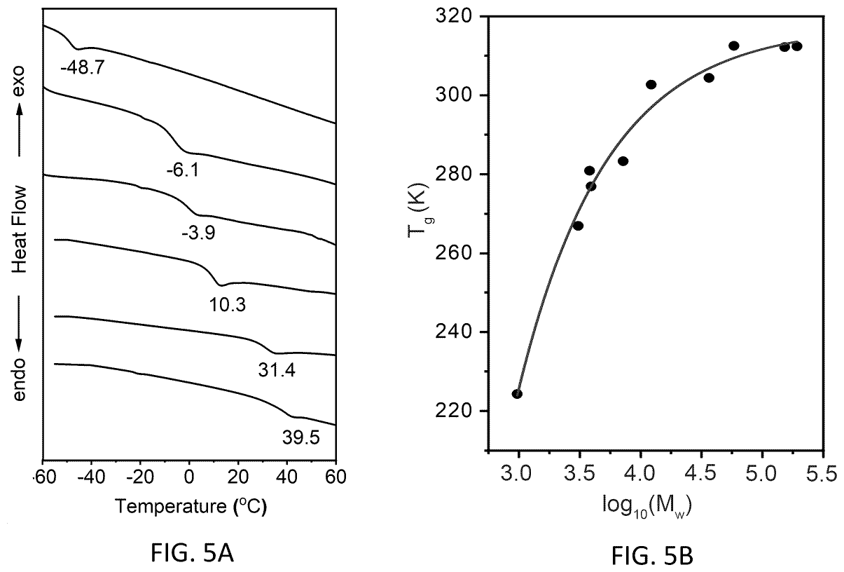

Since the surprisingly high T_{g} value for ref1 is at odds with both the GR and VS reports, a more thorough investigation of our linear aPMP materials was warranted. In this regard, it is well known that T_{g} increases with Mₙ up to a limiting value as Mₙ→∞ for a wide range of polymers. As previously reported by us, living coordinative chain transfer polymerization (LCCTP) of ethene and a-olefins using either 1 or 2 as pre- initiators is ideally suited for the scalable production of a broad range of polyolefins via living polymerization. More to the point, LCCTP now employs excess equivalents of a relatively inexpensive and abundant main group metal alkyl, such as diethylzinc (ZnEt₂), as a chain transfer agent (CTA) to provide a much larger population of ‘surrogate’ chain growth centers that are engaged in rapid and reversible polymeryl group (chain) transfer with the smaller population of active transition-metal propagators. Under the condition where the relative rate and rate constant for reversible chain transfer, n_{CT} (k_{CT}), are substantially larger than those for propagation, np (kₚ), all the surrogate and active species appear to undergo chain growth at the same rate, and accordingly, all the desired features of a living process, including targeted DPₙ values and small Ð values, can be obtained. However, the penalties associated with scale-up are now removed, and accordingly, even the production of kilogram quantities of low to ultra-low molar mass ‘precision’ polyolefins are practical using LCCTP. As presented in Table 1, both LCP (y=0) and LCCTP using fully activated 2 (i.e., Ib) (x=1.1) with varying equivalents (y>0) of ZnEt₂ as CTA (see FIG. 1) were employed to produce an extended family of well-characterized aPMP samples with Mₙ values within the 835 Da to 126 kDa range. FIG. 3 presents two different presentations of the correlation between T_{g} and Mₙ that is observed for this new database of aPMP materials. As can be seen, there is an increase in the glass transition temperature as a function of DPₙ(see FIG. 5A) and a plot of the entire series of T_{g} values vs. log ₁₀ (M_{w}) is in qualitative agreement with the Flory-Fox equation that describes the dependence of T_{g} on molar mass. The asymptotic curve fit of this data that is shown in FIG. 5B provides a limiting T_{g}(∞) value of 40° C. for linear 1,2-regioregular aPMP of infinite chain length. This value is virtually identical to that observed for our ref2, as well as the claimed c-aPMP material of VS—but it is 10° C. higher than that reported for their l-aPMP in spite of this material having a much higher molar mass than ref2. As a possible resolution to these conflicting results, as previously noted, the reported ¹³C NMR spectra for both l-aPMP and c-aPMP indicate a high degree of regioirregularity for both materials. Accordingly, it could be that the observed increase in T_{g} value between the two is still internally consistent with a linear vs. cyclic structure, and that of the latter is just coincidentally identical to that of our ref2. Finally, given the ease with which scalable and practical quantities of authentic amorphous, high-T_{g}, regioregular aPMP can now be obtained via either LCP or LCCTP according to FIG. 1, a foundation for exploring new applications of this polyolefin has been established. Indeed, as FIG. 1 further reveals, reactive quenching and the use of diphenylzinc (ZnPh₂) as CTA for LCCTP provides access to either mono-end-group-functionalized or a,w-difunctionalized hetero- and homotelechelic polyolefins in high yields that are now serving as building blocks for the design and production of several classes of advanced materials.

TABLE 1
LCCTP and LCP of 4M1P using Ib.

| | ZnEt₂ | 4M1P | | Mₙ^{b} | M_{w}^{b} | | T_{g}^{c} |
|---|---|---|---|---|---|---|---|
| Run | (eq.) | (eq.) | Yield (g) | (kDa) | (kDa) | Ð^{b} | (° C.) |
| 1 | 30 | 713 | 1.45 | 0.835 | 0.967 | 1.15 | −48.7 |
| 2 | 10 | 595 | 1.24 | 2.60 | 3.07 | 1.18 | −6.1 |
| 3 | 5 | 595 | 1.19 | 3.30 | 3.91 | 1.18 | 3.9 |
| 4 | 5 | 891 | 1.92 | 6.18 | 7.18 | 1.16 | 10.3 |
| 5 | 2 | 1190 | 1.09 | 31.4 | 36.4 | 1.16 | 31.4 |
| 6 | 2 | 1220 | 3.56 | 48.7 | 58.2 | 1.19 | 39.5 |
| 7 | — | 12.0 | 0.100 | 3.21 | 3.80 | 1.18 | 7.9 |
| 8 | — | 60.0 | 0.500 | 10.4 | 12.2 | 1.17 | 29.7 |
| 9 | — | 595 | 0.990 | 98.7 | 152 | 1.53 | 39.2 |
| 10 | — | 1190 | 1.98 | 126 | 192 | 1.52 | 39.4 |

^{a}For complete details of polymerization conditions for each run, see Experimental Details.
^{b}Determined by GPC.
^{c}Determined by DSC. Runs 1-5 are LCP.

As noted in the above, there has been a remarkable lack of interest and progress made with the development of new stereochemical grades of PMP. Miller and co-workers reported a Tₘ value of 215° C. for highly regio- and stereoregular syndiotactic PMP that was also characterized by ¹³C NMR (rrrr=95%, where r denotes a racemic dyad with adjacent stereocenters of opposite relative configuration). But Duchateau and co-workers have provided the most detailed investigation to date of the impact that stereoregularity of iPMP has on the value of Tₘ through the synthesis and characterization of a small library of samples obtained from the coordinative polymerization of 4M1P using a series of C₂—, Cₛ— and C₁-symmetric ansa-bridged zirconocene complexes as pre-catalyst and excess equivalents of methylaluminoxane (MAO) as co-catalyst. Remarkably, though, irrespective of the catalyst and polymerization conditions employed, all the PMP materials obtained in this study displayed Tₘ values above 200° C., which is strongly suggestive of a high degree of regio- and stereoregularity for a predominantly isotactic microstructure. Indeed, the reported ¹³C NMR spectra confirmed this conclusion with the authors using very small differences in the observed patterns of n′ad ¹³C resonances to qualitatively assess the degree of stereoregularity, which all remained within a very high value.

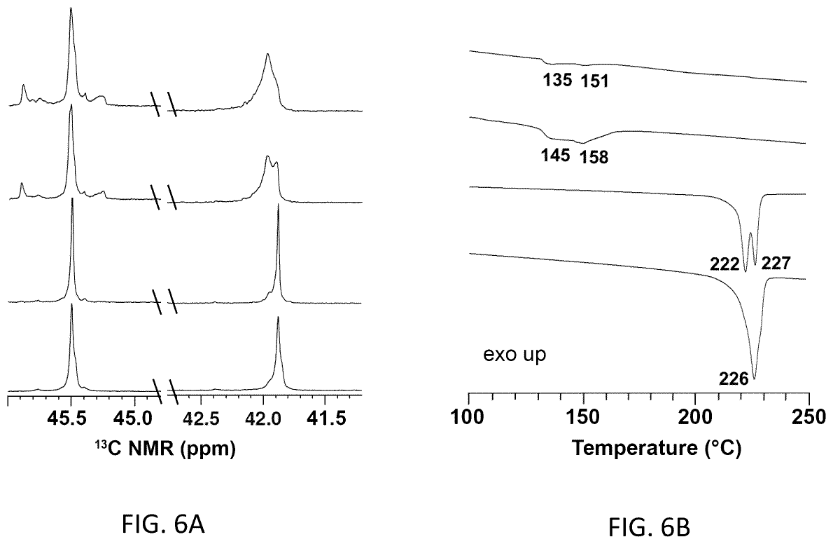

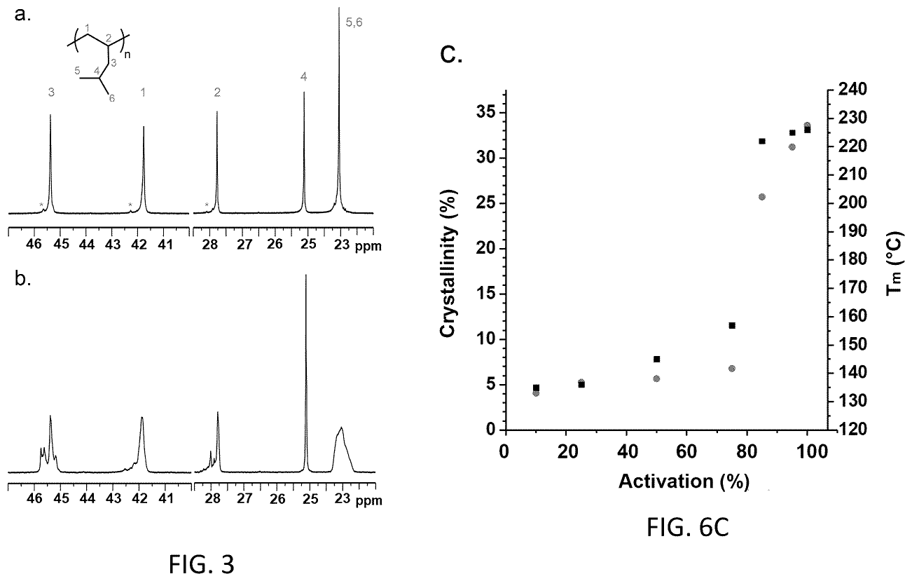

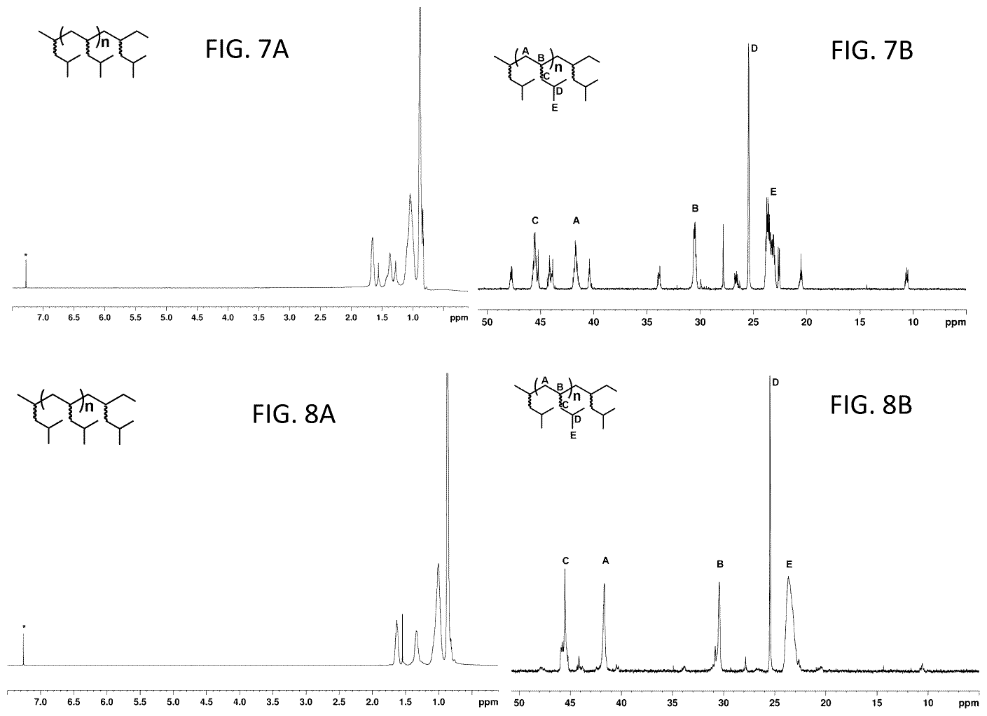

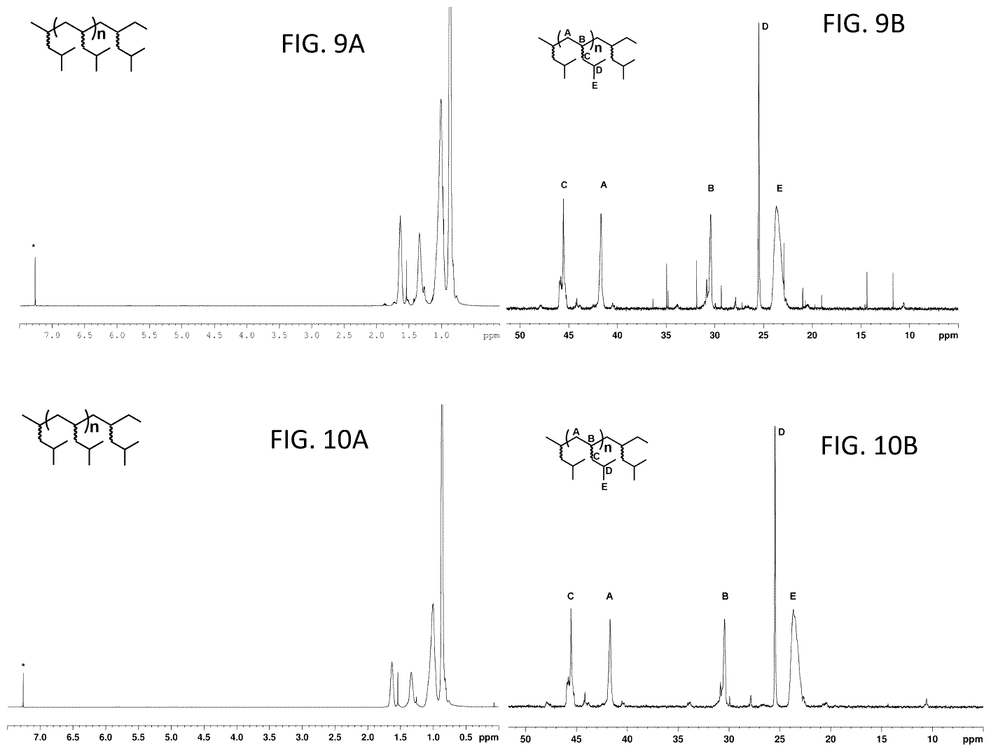

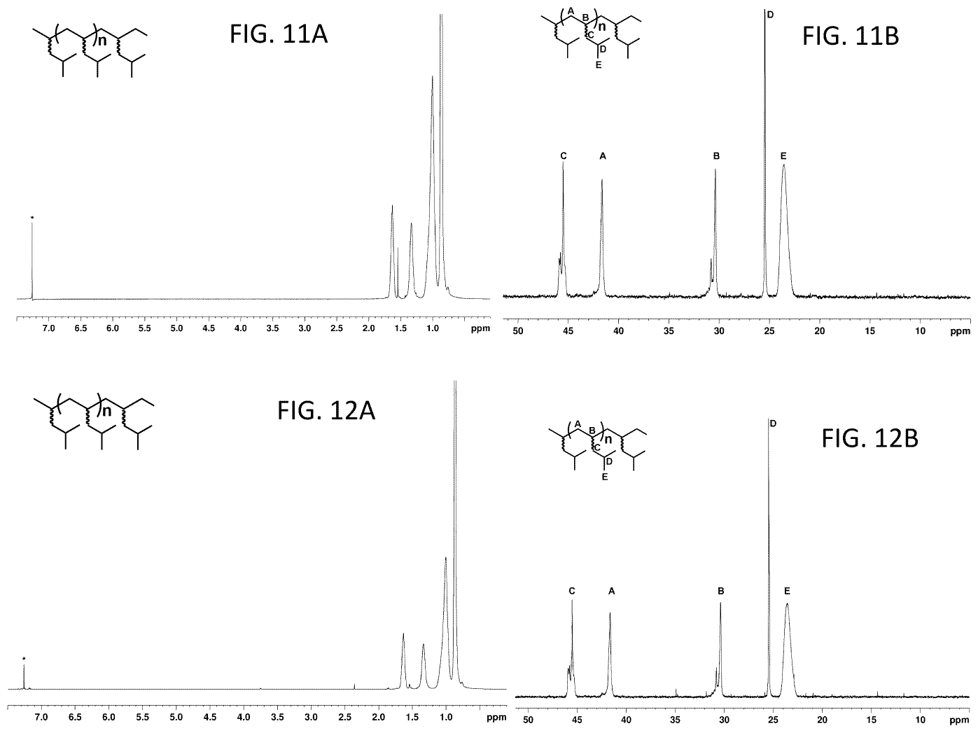

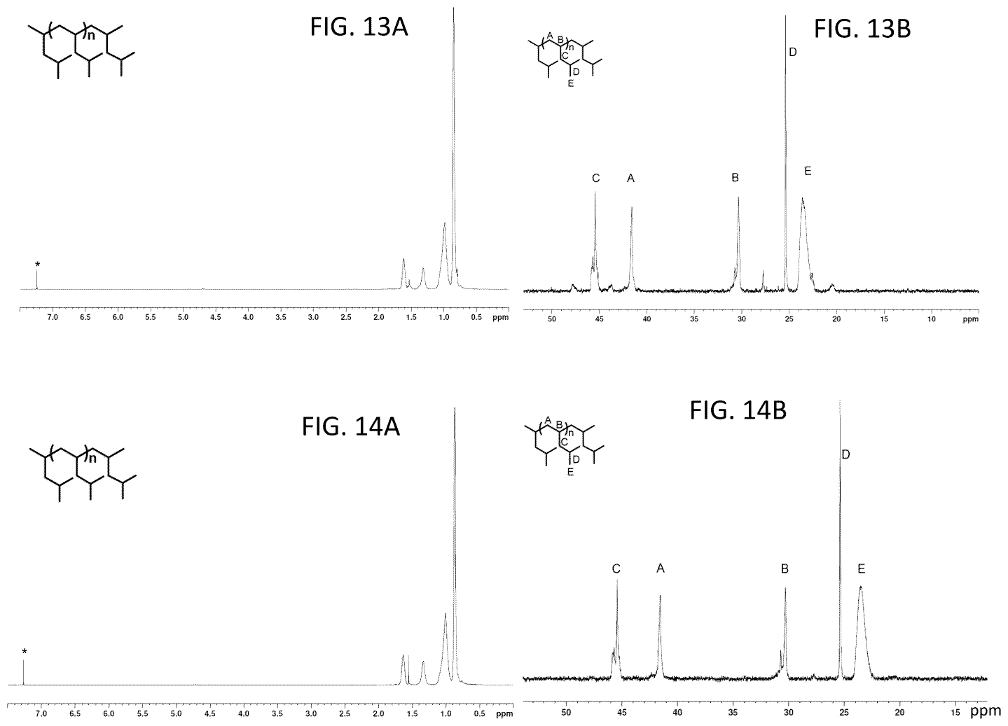

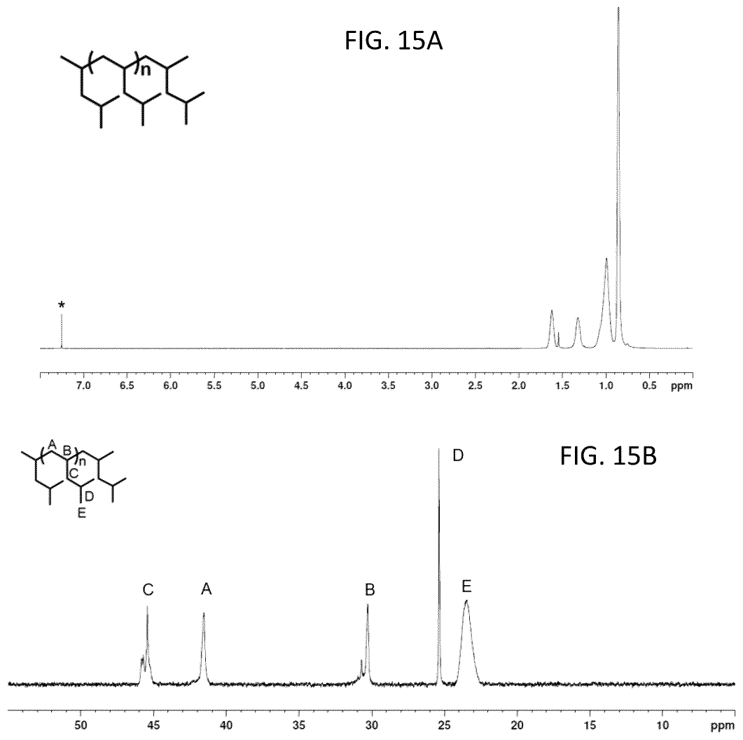

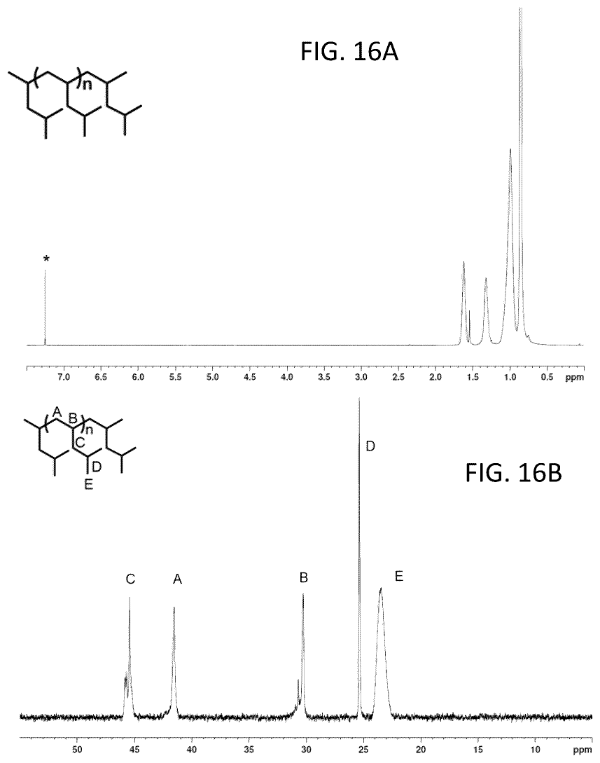

The results of the Duchateau investigation demonstrate the very strong degree of stereocontrol that the growing polymer chain (also known as chain-end control) can exert on monomer insertion during propagation, which in the case of PMP, appears to have a very dominant preference for producing an isotactic microstructure. We have similarly observed the exclusive formation of isotactic poly(vinylcyclohexane) (PVCH) in the LCP of vinylcyclohexane using Cₛ-symmetric derivatives of I. Accordingly, from the outset of the present work, we recognized the potential difficulties with overriding intrinsic chain-end control in any strategy for achieving the programmed stereomodulation of PMP tacticity. Within the ‘toolbox’ of strategies and methods that we have previously reported, we first investigated achieving this goal using ‘two-state degenerative’ LCP that is based on the substoichiometric activation of 1 (x<1.0 in FIG. 1). The mechanistic basis for two-state degenerative LCP stereomodulation of tacticity rests with the configurational stability of the population of active ion pair propagators that are in equilibrium with a second population of configurationally unstable neutral ‘dormant’ species via rapid and reversible methyl group exchange. As with LCCTP, if the rate and rate constant for methyl group exchange are far greater in magnitude than those of chain-growth propagation by monomer insertion, then all the desired features of a living polymerization can be preserved. However, by virtue of the kinetic parameters for dormant state epimerization being the largest of all, stereoregularity of microstructure becomes dependent on the relative concentration of dormant states to active propagators, or more simply, to the percent level of activation of 1. Finally, as validated for the stereoengineering of PP, this two-state degenerative LCP process can provide access to the entire atactic—isotactic spectrum of different tacticity grades, as well as, unique stereochemical microstructures, such as isotactic-atactic stereogradient and stereoblock PP. Table 2 and FIGS. 6A-6C provide a summary of results obtained for a family of PMP materials that were generated through two-state degenerative LCP of 4M1P as a function of % activation of 1 (x<1.0) and in the absence of any CTA (y=0). To begin, run 11 is the same experimental used to obtain the highly stereoregular iPMP reference sample, ref1 (vide supra). Runs 12 to 17 track the impact that an increasing population of configurationally unstable dormant states have on the stereoregularity of tacticity of the PMP product. Most notably, a high Tₘ value above 200° C. and a high degree of crystallinity for the thermally unannealed materials are maintained down to 85% activation of 1 (runs 11-13). However, at and below 75% activation, several noticeable changes appear in the physical properties of the PMP samples obtained from runs 13-17. First, Tₘ now falls below 200° C. for the first time and this parameter decreases further along with % crystallinity as a function of a decreasing value of x. And second, a concomitant appearance of a T_{g} transition now occurs, indicating the presence of a significant rubbery component. The occurrence of double or multiple melting transition temperatures that are indicated for runs 13-17, and which are shown in FIG. 6B, are not unprecedented for semicrystalline polymers and this feature suggests that crystallites of varying size are now present. While ¹³C NMR data cannot be used to quantify stereochemical microstructure at the n′ad sequence level, a trend to less stereoregularity as % activation decreases can clearly be seen in FIG. 4a. It is also important to note that the decrease in molar mass that is observed as a function of decreasing % activation for the same amount of 4M1P monomer and the same time of polymerization (runs 14-17) is easily explained by the decreasing number of active sites that are propagating over the same period of time.

TABLE 2
Two-state Degenerative LCP of 4M1P using 1 with Varying Equivalents of B1.^{a}

| | | ZnEt₂ | 4M1P | Yield | Mₙ | M_{w} | | Tg | Tₘ | |
|---|---|---|---|---|---|---|---|---|---|---|
| Run | [B1/2] | (eq.) | (eq.) | (g) | (kDa)^{b} | (kDa)^{b} | Ð^{b} | (° C.)^{c} | (° C.)^{c} | % Crystallinity^{c} |
| 11 | 1.1 | — | 280 | 0.41 | 51.0 | 70.9 | 1.38 | — | 226 | 33.6 |
| 12 | 0.95 | — | 280 | 0.51 | 48.1 | 66.9 | 1.34 | — | 225 | 31.2 |
| 13 | 0.85 | — | 280 | 0.55 | 61.4 | 81.7 | 1.32 | — | 222, 227 | 25.7 |
| 14 | 0.75 | — | 100 | 0.34 | 17.8 | 21.8 | 1.22 | 29.1 | 190, 203 | 8.49 |
| 15 | 0.50 | — | 100 | 0.34 | 16.8 | 19.8 | 1.18 | 27.4 | 145, 158 | 5.65 |
| 16 | 0.25 | — | 100 | 0.29 | 13.0 | 14.9 | 1.15 | 28.8 | 135, 151 | 5.26 |
| 17 | 0.10 | — | 100 | 0.22 | 8.80 | 9.94 | 1.13 | 24.9 | 135, 151 | 4.06 |

^{a}For details of polymerization conditions for each run, see Experimental Details.
^{b}Determined by SEC.
^{c}Determined by DSC.

Finally, we have recently reported that multi-state degenerative LCCTP is also possible by employing the pre-initiator 2 and varying both x<1.0 andy>1.0 in FIG. 1. In the present work, we now demonstrate, for the first time, the concept and validation of stereomodulated multi-state LCCTP with 1 by varying substoichiometric equivalents of B1 in the presence of varying equivalents of ZnEt₂ as CTA for the scalable stereoengineering of PMP tacticity. Experimental Details section has a more complete documentation of results, but here it can be noted that at full activation (x=1.1) and 30 equivalents of CTA, LCCTP of 4M1P produced iPMP (Mₙ=7.34 kDa) with a Tₘ value of 223° C. (33% crystallinity), but interestingly, with a measurable T_{g} of 28.8° C. now appearing. As we have documented for iPP, and now for iPMP, an erosion of stereoregularity is to be expected for LCCTP using racemic 1 due to reversible chain transfer that occurs between ‘matched’ and ‘mismatched’ pairings of relative configurations of the chiral, configurationally stable transition-metal centers and the ‘handedness’ of the growing isotactic polyolefin chain. Finally, at 50% activation and using 5 equivalents of CTA, the PMP product of LCCTP now possesses both lower multi Tₘ transitions at 145° C. and 162° C., and with a T_{g} of 13.6° C. for a Mₙ value of 6.18 kDa.

In summary, the results of the present study demonstrate the ability to ‘stereoengineer’ both the tacticity, and importantly, the physical properties of a well-established polyolefin that has only ever been commercialized in its highly isotactic form by Mitsui under the tradename TPX. The significant challenge of overriding a strong degree of chain-end control that is exerted by the growing PMP chain has been met by employing a new toolbox for stereomodulated LCP and LCCTP in programmed fashion that relies on only two fundamental CPAM group 4 metal pre-initiators (e.g., 1 and 2). This ‘one-catalyst, many materials’ paradigm stands in sharp contrast to the traditional empirically-driven ‘one-catalyst, one material’ strategy that has traditionally relied on the synthesis of large families of substitutionally-diversified metallocenes for stereomodulating PP tacticity. Unequivocal documentation of the synthesis and properties of 1,2-regioregular atactic PMP not only clears up past misunderstandings or misinformation regarding this fundamental polyolefin material, but it also now provides a foundation for the increased use of aPMP for science and technology. Additional efforts are now in progress to further explore and expand the range of PMP-based materials using our toolbox of polymerization methods and the results of these studies will be reported in due course.

### Experimental Details

General Considerations. All manipulations of air and moisture sensitive compounds were carried out under N2 atmospheres with standard Schlenk line or glovebox techniques. Toluene (ReagentPlus, 99%) was dried and deoxygenated by passage over activated alumina and GetterMaxr 135 catalyst (purchased from Research Catalysts, Inc.) and collected prior to use. Chlorobenzene (Acros Organic, 99%) was dried over calcium hydride by refluxing at 130° C. for three days and distilled under N2 prior to use. 1, 1, 2, 2-Tetrachloroethane(C2Cl4)-d2 was purchased from Cambridge Isotopes and used as received. Chloroform-d1 was purchased from Cambridge Isotopes and used as received. 4-methyl-1-pentene (>97%) were purchased from TCI Chemicals, dried over Na/K alloy and isolated by vacuum-transfer prior to use. Diethylzinc (>52 wt. % Zn) was purchased from Sigma-Aldrich and used as received. All other solvents and reagents were used as received unless otherwise.

### Characterization

Nuclear Magnetic Resonance (NMR) Spectroscopy of ¹H and ¹³C{1H} nuclei was carried out with a Bruker DRX 600 with BBFO probe or Bruker AVIII-HD 800 spectrometer fitted with a cryo-QCI probe. Chloroform-d1 was used as the solvent for polymer samples using LCCTP synthesis. 1,1,2,2-C₂Cl₄-d2 was used as the solvent for polymer samples using LCP synthesis and heated to 110° C. All spectra were referenced to tetramethyl silane using residual ¹H and ¹³C{¹H}chemical shifts of the deuterated solvents.

Gel Permeation Chromatography (GPC) was used to obtain molecular weight (Mn and Mw) and polydispersity index (PDI) of polymers using Viscotek GPCMax equipped with three columns (Styragel HR 4, HR 3, and HR 1) in a column oven and differential refractometer (Viscotek TDA 302) maintained at 40° C. Tetrahydrofuran (HPLC Grade) was used as the eluent with a flow rate of 1 mL/min. Polystyrene standards (from Agilent Technologies, 370 Da−128.7 kDa) were used for calibration. For GPC sample preparation, 2 mg of dry polymer sample was dissolved in 1 mL of THF (HPLC Grade).

Size Exclusion Chromatography (SEC). High temperature size exclusion chromatography was performed using a Tosoh HT-Eco SEC instrument with differential refractive index detection. Narrow dispersity polystyrene standards were used for calibration. Measurements were performed at 135° C. using 1,2,4-trichlorobenzene as the mobile phase (300 mg/kg Irganox 1010 was added as antioxidant to the solvent). The stationary phase was a set of 3 Tosoh HTs columns (2 Tosoh TSKgel GMHhrH (S) HT2, 13 μm mixed bed, 7.8 mm ID×30 cm columns and 1 Tosoh TSKgel GMHHR-H (20) HT2, 20 μm, 7.8 mm ID×30 cm column with an exclusion limit ˜4×108 g/mol).

Differential scanning calorimetry (DSC) was used to obtain thermal transition (Tg and Tm) values using TA instruments DSC Q1000 system. Samples were run in sealed hermetical aluminum pans with an empty pan as reference. A heat/cool/heat temperature program was used at a ramp rate of 10 or 20° C./min with varied temperature ranges. The initial mass of the sample was between 4.5-10 mg.

### GENERAL PROCEDURE

### General Procedure for Living Coordinative Chain Transfer Polymerization (LCCTP) of atactic poly(4-methyl-1-pentene) (aPMP) via Hafnium Diethyl Catalyst

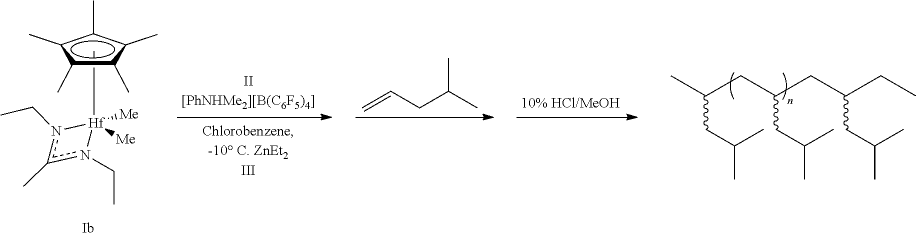

In a round bottom flask, 40 mL of toluene was cooled to −5° C. The 4M1P monomer of targeted equivalents was added to the flask. Then chain transfer agent III, was added to the flask. Then a solution of Ib (0.04 mmol, 18.3 mg), in −5° C. 1.0 mL PhCl was added to II (0.044 mmol, 35.3 mg) which was vigorously agitated until dissolved and activated, whereupon it was added to the flask. The flask was stirred for typically 18 hours at −5° C. and quenched with 10% HCl/methanol. The material was then run through a silica column using hexane, collected into a pre-weighed vial, and dried under vacuum. Details on the amount of the reagents and polymer's characterization are provided in Table 3, runs 1-6.

### General Procedure for Living Coordinate Polymerization (LCP) of Poly(4-methyl-1-pentene) (PMP) via Hafnium Diethyl Catalyst

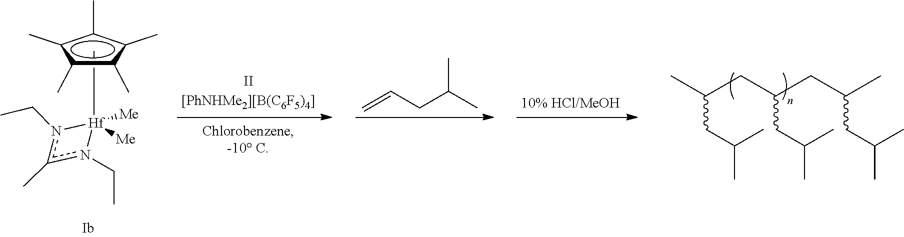

In around bottom flask, 50 mL of toluene was cooled to −5° C. The 4M1P monomer of targeted equivalents was added to the flask. Then a solution of Ib (0.05 mmol, 22.9 mg), in −5° C. 1.0 mL PhCl was added to II (0.055 mmol, 44.1 mg) which was vigorously agitated until dissolved and activated, whereupon it was added to the flask. The flask was stirred for typically 4 hours at −5° C. and quenched with 10% HCl/methanol. The material was then run through a silica column using hexane, collected into a pre-weighed vial, and dried under vacuum. Details on the amount of the reagents and polymer's characterization are provided in Table 3, runs 7-10.

TABLE 3
LCCTP (top) and LCP (bottom) of 4M1P using Ib.

| | ZnEt₂ | 4M1P | Yield | Mₙ | M_{w} | | Tg |
|---|---|---|---|---|---|---|---|
| Run | (eq.) | (eq.) | (g) | (kDa)^{b} | (kDa)^{b} | Ð^{c} | (° C.)^{c} |
| 1 | 30 | 713 | 1.45 | 0.835 | 0.967 | 1.15 | −48.7 |
| 2 | 10 | 595 | 1.24 | 2.60 | 3.07 | 1.18 | −6.06 |
| 3 | 5 | 595 | 1.19 | 3.30 | 3.91 | 1.18 | 3.92 |
| 4 | 5 | 891 | 1.92 | 6.18 | 7.18 | 1.16 | 10.32 |
| 5 | 2 | 1190 | 1.09 | 31.4 | 36.4 | 1.16 | 31.4 |
| 6 | 2 | 1220 | 3.56 | 48.7 | 58.2 | 1.19 | 39.5 |
| 7 | — | 12.0 | 0.100 | 3.21 | 3.80 | 1.18 | 7.91 |
| 8 | — | 60.0 | 0.500 | 10.4 | 12.2 | 1.17 | 29.7 |
| 9 | — | 595 | 0.990 | 98.7 | 152 | 1.53 | 39.2 |
| 10 | — | 1190 | 1.98 | 126 | 192 | 1.52 | 39.4 |

^{b}Determined by gel permeation chromatography (GPC).
^{c}Determined by differential scanning chromatography (DSC).

### General Procedure for Living Coordinate Polymerization (LCP) of Poly(4-methyl-1-pentene) (PMP) with varied activation via Zirconium Catalyst

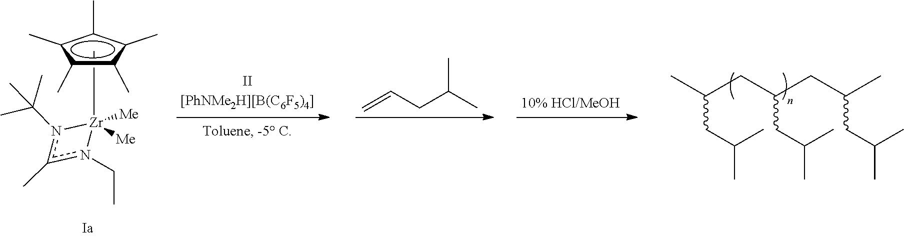

In a round bottom flask, 50 ml of chlorobenzene (PhCl) was cooled to −10° C. 4-methly-1-pentene (4M1P) monomer of targeted equivalents was added to the flask. Pre-weighed Ia (0.05 mmol, 19.9 mg) is mixed with II, with 1.0 ml of cold PhCl and added to the reaction mixture resulting in a bright yellow color. The reaction mixture stirred typically for 4 hr. The reaction was removed from the glovebox and quenched/precipitated in 500 mL of acidic methanol (10% HCl) overnight. The polymer was vacuum filtered and washed with methanol (×3) then collected in a pre-weighed vial and dried under vacuum. Samples polymerized via LCP conditions using substoichiometric amounts of II (i.e. [II]/[I]<1.0), activation of precatalyst still resulted in the bright yellow color and followed the same procedure as before. Details on the amount of the reagents and polymer's characterization are provided in Table 4 runs 12-20.

### General Procedure for Living Coordinative Chain Transfer Polymerization (LCCTP) of Atactic Poly(4-Methyl-1-Pentene) (aPMP) Via Zirconium Catalyst. P_{GP}-2

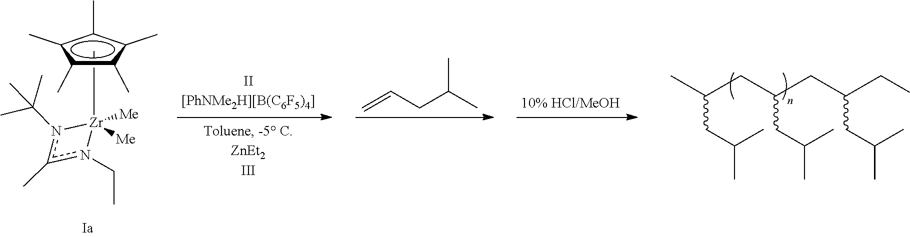

In a round bottom flask, 20 mL of toluene was cooled to 0° C. The 4M1P monomer (11.9 mmol, 1.0 g) was added to the flask. Then chain transfer agent III(0.1 mmol, 12.4 mg), was added to the flask. Then a solution of Ia (0.02 mmol, 7.95 mg), with 0° C. 1.0 mL PhCl was added to II which was vigorously agitated until dissolved and activated, whereupon it was added to the flask. The reaction was removed from the glovebox, after typically 18 hr, and quenched/precipitated in 500 mL of acidic methanol (10% HCl) for at least 1 hr. The polymer was vacuum filtered and washed with methanol (×3) then collected in a pre-weighed vial and dried under vacuum. Samples polymerized via LCCTP conditions using substoichiometric amounts of II (i.e. [II]/[I]<1.0), activation of precatalyst still resulted in the bright yellow color and followed the same procedure as before. Details on the amount of the reagents and polymer's characterization are provided in Table 4, runs 21-26.

TABLE 4
LCP (top) and LCCTP (bottom) of 4M1P using Ia and varying equivalents(eq) of II.

| | | ZnEt₂ | 4M1P | Yield | Mₙ | M_{w} | | Tg | Tm | |
|---|---|---|---|---|---|---|---|---|---|---|
| Run | [II/I] | (eq) | (eq) | (g) | (kDa) ^{a} | (kDa) ^{a} | Ð ^{a} | (° C.) ^{b} | (° C.) ^{b} | % Crystallinity |
| 11 | 1.1 | — | 280 | 0.409 | 51.0 | 70.9 | 1.38 | — | 226 | 33.6 |
| 12 | 0.95 | — | 280 | 0.512 | 48.1 | 66.9 | 1.34 | — | 225 | 31.2 |
| 13 | 0.85 | — | 280 | 0.548 | 61.4 | 81.7 | 1.32 | — | 222; 227 | 25.7 |
| 14 | 0.75 | — | 100 | 0.336 | 17.8 | 21.8 | 1.22 | 29.1 | 190; 202 | 8.49 |
| 15 | 0.50 | — | 100 | 0.335 | 16.8 | 19.8 | 1.18 | 27.4 | 145; 158 | 5.65 |
| 16 | 0.25 | — | 100 | 0.289 | 13.0 | 14.9 | 1.15 | 28.8 | 136; 151 | 5.26 |
| 17 | 0.10 | — | 100 | 0.220 | 8.80 | 9.94 | 1.13 | 24.9 | 135; 151 | 4.06 |
| 18^{c} | 1.1 | 5 | 595 | 0.745 | 6.18 | 22.6 | 3.29 | — | 214 | 23.1 |
| 19^{c} | 1.1 | 30 | 4280 | 3.67 | 7.34 | 14.95 | 2.02 | 28.8 | 223 | 33.3 |
| 20 | 0.95 | 5 | 595 | 0.955 | 5.01 | 10.2 | 2.04 | 25.3 | 218 | 26.1 |
| 21 | 0.85 | 5 | 595 | 0.999 | 3.11 | 5.04 | 1.82 | 22.3 | 217 | 19.1 |
| 22 | 0.75 | 5 | 595 | 0.748 | 3.95 | 7.65 | 1.94 | 4.56 | 149; 164 | 2.25 |
| 23 | 0.50 | 5 | 595 | 0.240 | 6.18 | 10.7 | 1.73 | 13.6 | 145; 162 | 3.77 |

^{a} Determined by GPC.
^{b} Determined by DSC.
^{c}Samples have the same percent activation but differing molecular weights.

### Example 2

Methods for orchestrating competing living coordination chain transfer polymerizations for the one-pot production of new viscoelastic grades of poly(4-methyl-1-pentene) are disclosed herein. By exerting control over two populations of co-existing cyclopentadienyl, amidinate (CPAM) group 4 metal active species that possess different stereoselectivities for chain growth propagation during the living coordinative chain transfer polymerization (LCCTP) of 4-methyl-1-pentene, controlled production of grades for poly(4-methyl-1-pentene) (PMP) materials that display a tuneable range of viscoelastic properties can be achieved in ‘one-pot’ fashion. Analytical and spectroscopic investigations reveal that these differences in viscoelastic properties are associated with formation of atactic/isotactic PMP stereoblends, rather than a stereoblock chain architecture. These results serve to establish the ability of low molar mass atactic PMP to function as an effective property modifier for commercially important isotactic PMP, which in pure form is highly brittle with low tensile strength. The further outcome of these studies is extension of multi-state LCCTP as a tool for expanding the range of accessible grades and properties of polyolefins that can be produced from the limited small set of industrially significant olefins.

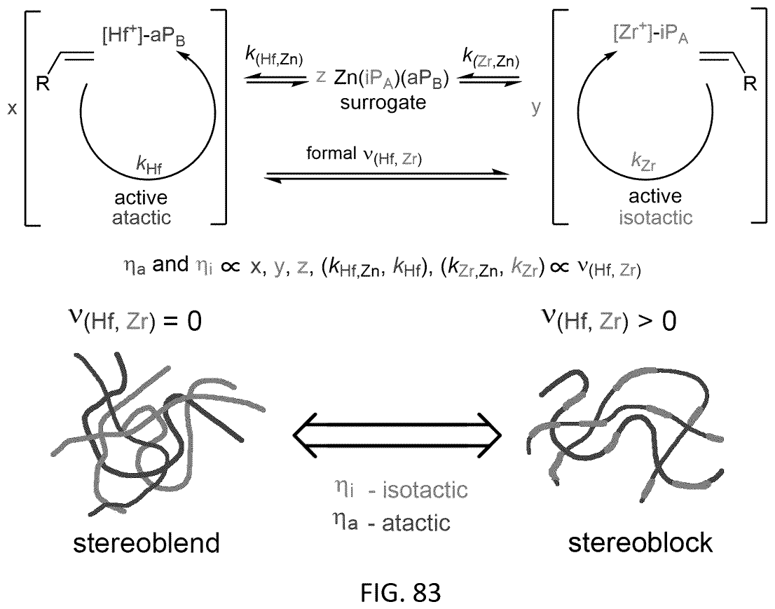

FIG. 83 presents the new multi-state strategy that is the subject of the present report in which isospecific and aspecific LCCTP processes for 4M1P are pitted against each other within a single reactor using varying equivalents of diethylzinc, ZnEt₂ (DEZ), as a chain transfer agent (CTA). As with other multi-state LCP and LCCTP processes that we have proposed and experimentally validated, in the absence of chain termination, all the desired features of a living polymerization can be retained if the rate and rate constants for reversible group and polymeryl chain transfer between active transition-metal propagators and either dormant species, in the case of LCP, or an excess population of main-group-metal ‘surrogate’ chain growth centers, in the case of LCCTP, are far greater in magnitude than the corresponding kinetic parameters for chain growth occurring at the transition-metal centers. This includes the ability to have control over the number-average degree of polymerization, DPₙ, and a very narrow molar mass distribution (MMD), as defined by a dispersity index, Ð(=M_{w}/Mₙ)≤1.1, where Mₙ and M_{w} are the number-average and weight-average molar mass indices. However, the key advantage of multi-state LCP and LCCTP processes lies with introduction of new mechanistic control points that can be manipulated and brought under external control to direct product formation as an infinite variety of different grades with differing properties that formally exist within a spectrum defined by two limiting ends.

Returning back to the multi-state mechanism of FIG. 83, the rate of chain transfer, n_{(Hf,Zr)}, that can formally occur between the aspecific Hf propagator, which is known to produce an atactic polyolefin microstructure, and the stereospecific Zr active species, which propagates in isotactic fashion, is dependent upon a number of kinetic variables, including the relative population size of all the active and surrogate chain growth centers, as established by the initial stoichiometric equivalents for x, y, and z (see FIG. 83), as well as the rate constants for propagation at each of the two transition-metal active centers (cf. k_{Hf} and k_{Zr}) relative to those for reversible chain transfer occurring between each of the transition-metal propagators and the excess number of CTA-derived surrogates (cf. k_{(Hf,Zn)} and k_{(Zr, Zn)}). More simplistically, as presented in FIG. 83, it can be seen that the possible range of values of hₐ and hᵢ, which are a function of n_{(Hf,Zr)}, comprise a spectrum of different stereochemical grades that is represented by a limiting isotactic—atactic stereoblend composition at one end, in the case of n_{(Hf,Zr)}=0, and uniform stereoblock microstructures for all other cases in which n_{(Hf,Zr)}>0. It is also reasonable to conclude that the molar mass indices and MMD profile for each grade produced will further depend upon the relative rates and rate constants of all the inter- and intramolecular dynamic processes that are involved. With respect to the goal of producing new viscoelastic grades of PMP, this can likely be achieved by producing either isotactic—atactic stereoblends or ‘blocky’ chain architectures so long as crystalline, isotactic-rich domains can serve as physical crosslinks within an amorphous matrix comprised of either atactic chains, or the non-crystallized portions of isotactic chains according to FIG. 84. As a first-order approximation, the number and size of these crystalline crosslinks relative to the amorphous matrix will determine bulk viscoelastic properties, irrespective of the materials being stereoblend or stereoblock in nature. Finally, the advantage of producing the former in a one-pot process is that it avoids any potential post-polymerization degradation of molar mass and MMD that might occur with mechanical blending or the increase in chemical waste that is incurred with solvent blending of the different components.

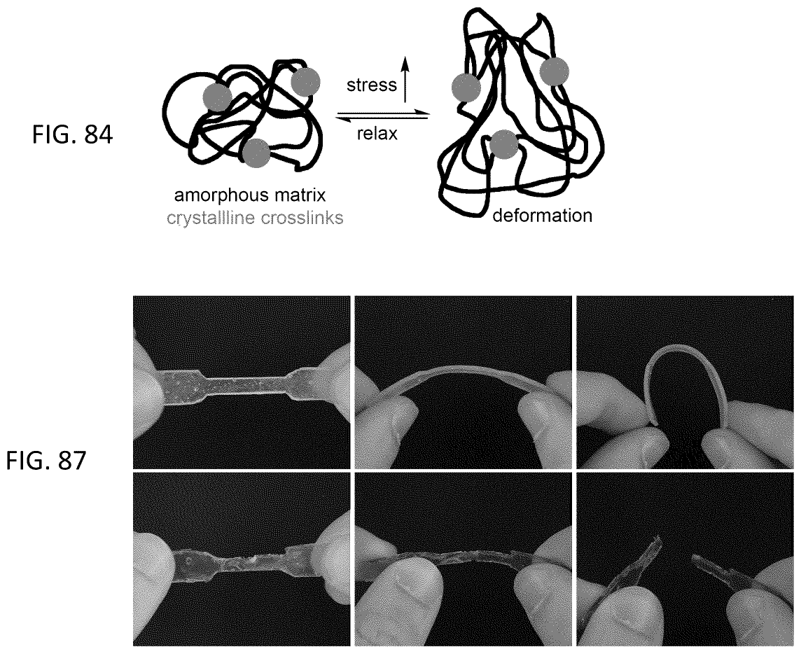

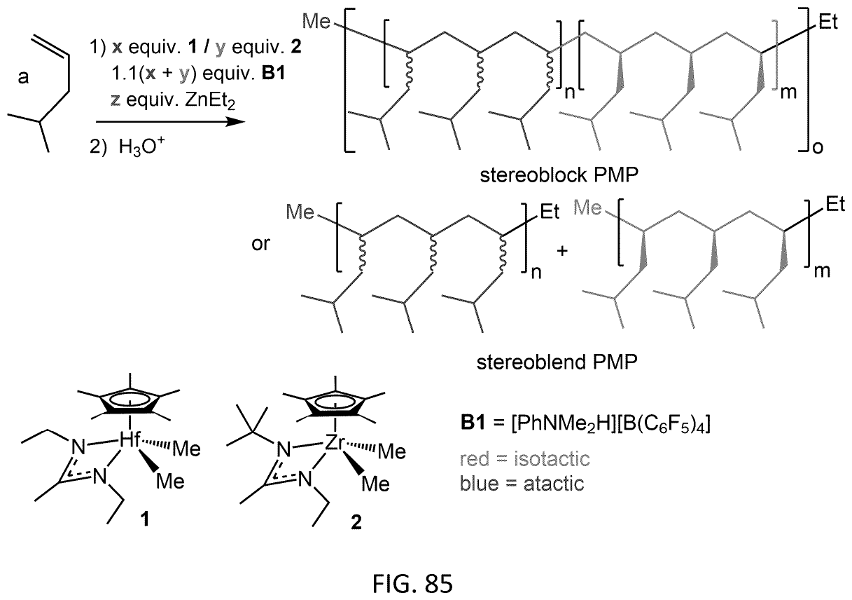

FIG. 85 presents the experimental methods that were employed to investigate the viability of FIG. 83 for delivering new viscoelastic grades of PMP and Table 5 provides results obtained from these efforts. To begin, as reported in Example 1, run 0 serves as a benchmark for production of amorphous aPMP (Ia) using only the Cₛ-symmetric cyclopentadienyl, amidinate (CPAM) hafnium dimethyl pre-initiator 1 in combination with 1.1 equivalent of the anilinium borate, [PhNHMe₂][B(C₆F₅)₄](B1), as co-initiator and 5 equivalents of DEZ as CTA. Runs 1-9 document results obtained with an increasing amount of the chiral (but racemic) C₁-symmetric CPAM zirconium dimethyl pre-initiator 2 being introduced while keeping the total number of transition-metal active propagators (Hf+Zr) and the number of equivalents of CTA constant. Finally, run 10 serves to provide the other benchmark in which use of only 2 as the pre-initiator, and with all other factors remaining the same, produced highly crystalline iPMP (Ib).

TABLE 5
Poly(4-methyl-1-pentene) (I) obtained by two-state competing LCCTP according to FIG. 85.^{a}

| | | | | | | | | | | | Elongation |
|---|---|---|---|---|---|---|---|---|---|---|---|
| | | | | | | | | | | Young's | at |
| | | Yield | Ia Mₙ | | Ib Mₙ | | T_{g} | Tₘ | Crystallinity | Modulus | Break |
| Run | 1:2 | (g) | (kDa)^{c} | Ia Ð^{c} | (kDa)^{c} | Ib Ð^{c} | (° C.)^{d} | (° C.)^{d} | (%)^{d} | (MPa)^{e} | (%)^{e} |
| 0 | 100:0 | 1.98 | 1.6 | 1.15 | — | — | 23 | — | — | 0.77 | 350 |
| 1 | 90:10 | 1.97 | 1.3 | 1.19 | 20.2 | 1.47 | 13 | 196, 208 | 0.92 | 1.04 | 346 |
| 2 | 80:20 | 1.78 | 1.4 | 1.20 | 39.0 | 1.40 | 7 | 203, 212 | 1.92 | 1.25 | 346 |
| 3 | 70:30 | 1.88 | 1.7 | 1.20 | 39.4 | 1.70 | 20 | 209, 217 | 4.70 | 3.01 | 336 |
| 4 | 60:40 | 1.67 | 1.6 | 1.16 | 40.6 | 1.65 | 18 | 215, 221 | 5.12 | 3.97 | 225 |
| 5 | 50:50 | 1.89 | 1.0 | 1.36 | 28.0 | 2.12 | 19 | 216, 222 | 10.9 | 38.8 | 19.4 |
| 6 | 40:60 | 1.86 | 0.9 | 1.18 | 37.3 | 2.14 | 13 | 215, 220 | 13.0 | nd | nd |
| 7 | 30:70 | 1.99 | 0.8 | 1.12 | 33.0 | 1.50 | — | 217 | 18.1 | nd | nd |
| 8 | 20:80 | 1.89 | 0.5 | 1.27 | 24.9 | 3.00 | — | 220 | 23.3 | nd | nd |
| 9 | 10:90 | 1.73 | 2.8 | 2.00 | 27.0 | 1.40 | — | 221 | 25.7 | nd | nd |
| 10 | 0:100 | 1.46 | — | — | 1.8 | 3.65 | — | 209 | 17.2 | nd | nd |
| 11 | 0:100 | 1.91 | — | — | 36.7 | 1.90 | — | 227 | 29.9 | nd | nd |

^{a}For details of polymerization conditions for each run, see Experimental Details.
^{b}No chain transfer agent in run 11.
^{c}Determined by SEC.
^{d}Determined by DSC.
^{e}Determined by DMA.

Intriguingly, the PMP materials from runs 0-10 physically display striking differences in bulk viscoelastic properties that are also captured in the stress-strain curves obtained from dynamic mechanical analysis (DMA) using molded rectangular test samples, some of which are reproduced in FIG. 86. Most notably, whereas the Ia sample (run 0) is amorphous with low tensile strength, there is a clear increase in the Young's modulus of the PMP samples with an increase in the amount of pre-initiator 2 that was employed for their production (cf., runs 1-5 in FIG. 86), and then the sample becomes very brittle at the limit for the Ib sample (run 10) as expected. The photographic evidence of FIG. 87 further shows the striking difference in the elastic properties of PMP from run 3 that allows molded objects to be easily and reversibly deformed vs. the very brittle nature of Ia from run 10.

Data obtained from ¹³C{¹H}NMR and differential scanning calorimetry (DSC) characterization of the complete set of new PMP grades of Table 5 as presented in FIG. 88 and the Experimental Details appeared to support the preliminary conclusion that the observed differences in viscoelastic properties can be attributed to formation of an isotactic-atactic stereoblock architecture. More to the point, the collection of partial ¹³C{¹H}(200 MHz, 1,1,2,2-tetrachloroethane-d₂ (TCE-d₂), 100° C.) spectra presented in FIG. 88, panel a for a subset of these materials (runs 0, 2, 4, 6, 8 and 10) show the expected broad ¹³C resonances for C1 and C3 of Ia (run 0), whereas those for Ib (run 10) are much narrower (sharper). As previously reported, Ib produced under LCCTP conditions with pre-initiator 2 contains a certain level of mmrm stereoerrors, where m and r designate meso and rac dyad configurations, as the result of zinc-mediated chain exchange occurring between the two configurationally-stable enantioforms of the zirconium-based active propagators. In between these two limiting reference samples, the ¹³C{¹H}NMR spectra show a superposition of ¹³C resonances for aPMP and iPMP, with the former diminishing in intensity relative to the latter as run number increases (cf, runs 2, 4, 6, and 8). The trends observed in the NMR spectra are mirrored in the DSC data for these PMP materials as presented in FIG. 88, panel b. For example, amorphous Ia reveals only a glass transition temperature, while semi-crystalline Ib displays a Tₘ of 209° C, which is lower than that of commercial iPMP due to molar mass differences in Mₙ and Ð and the aforementioned level of mmrm stereoerrors. As the proportion of iPMP increases relative to aPMP, there is an onset of crystallinity and an increase in Tₘ and crystallinity values through the progression of runs according to Table 5 and FIG. 88, panel b. Oddly though, the Tₘ value of 220° C. observed for PMP produced with a pre-initiator ratio of 1:2 set at 20:80 (run 8) is significantly higher than the iPMP reference Ib (run 10). This suggests that the iPMP content of the former material might be more stereoregular than the latter, even though both were presumably produced under reversible CT conditions. In support of this hypothesis, run 11 of Table 5 presents results for production of highly stereoregular iPMP that is devoid of any r dyads by using pre-initiator 2 in the absence of any CTA to yield a Tₘ value of 227° C.

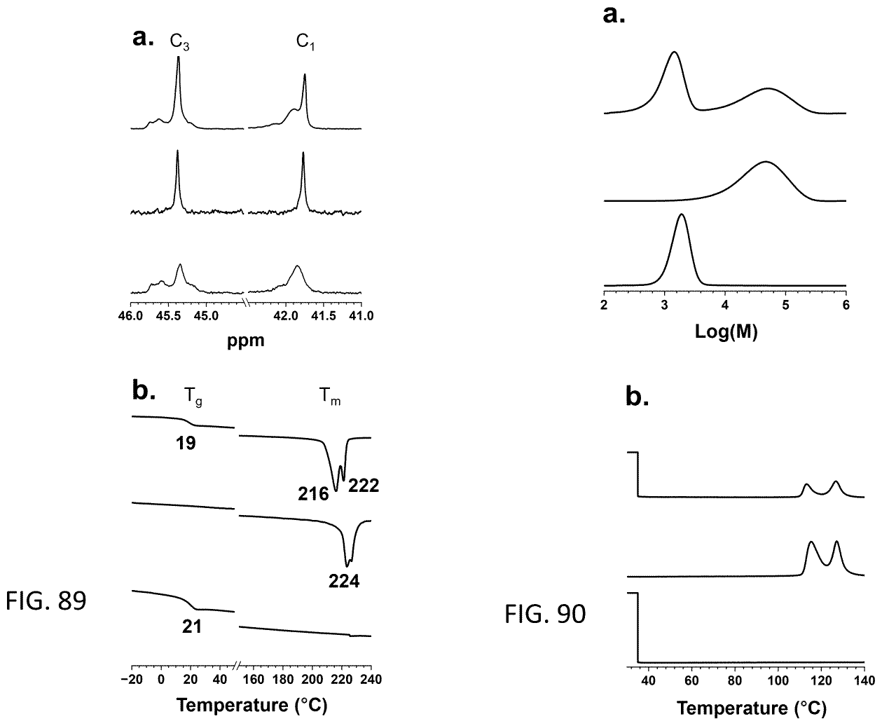

Ever since Natta and co-workers first proposed an isotactic-atactic stereoblock architecture to rationalize the elastic properties of an isolated fraction of PP from a complex mixture of different tacticities, there has been considerable interest in developing new polymerization processes that could be used to produce stereoblock polyolefins on demand and with control over the viscoelastic properties of different grades of these materials through programmed variations in hₐ and hᵢ. While we have previously been successful in achieving this goal for production of well-defined isotactic-atactic stereoblock PP thermoplastic elastomers through development of stereomodulated living coordinative polymerization based on temporal control over degenerate exchange between populations of configurationally-stable (active) and configurationally-unstable (dormant) states, this strategy suffers from the inability to scale the process to provide substantial amounts of product. Hence the strong desire to develop an LCCTP process based on enantiomerically pure and configurationally stable propagators. But the historical record covering the quest for stereoblock polyolefins produced under chain transfer conditions is wrought with questions regarding the true nature of the materials actually produced. Accordingly, even though all signs revealed so far pointed to the successful production of stereoblock PMP, we sought to avoid making a mistake. Thus, to begin, Soxhlet extraction of the PMP sample from run 5 was performed using refluxing hexanes for 18 h to provide 59% by weight of a soluble fraction with the remainder being insoluble. As presented in FIG. 89, characterization by ¹³C{¹H}NMR and DSC unequivocally revealed these soluble and insoluble fractions to be aPMP and iPMP, respectively. Further, as suspected, the latter ¹³C NMR spectrum revealed this iPMP fraction to be more stereoregular than that of the benchmark sample Ia of run 10 (cf FIGS. 88 and 89A), a result that we were initially at odds to explain. However, this simple fractionation could not be used to exclude the possible existence of a third stereoblock PMP fraction that could potentially be functioning as a blend compatibilizer between aPMP and iPMP. Accordingly, to better interrogate the tacticity composition of the PMP samples from runs 1-9, we next turned to crystallization elution fractionation (CEF) and high-temperature size exclusion chromatography (HT-SEC).

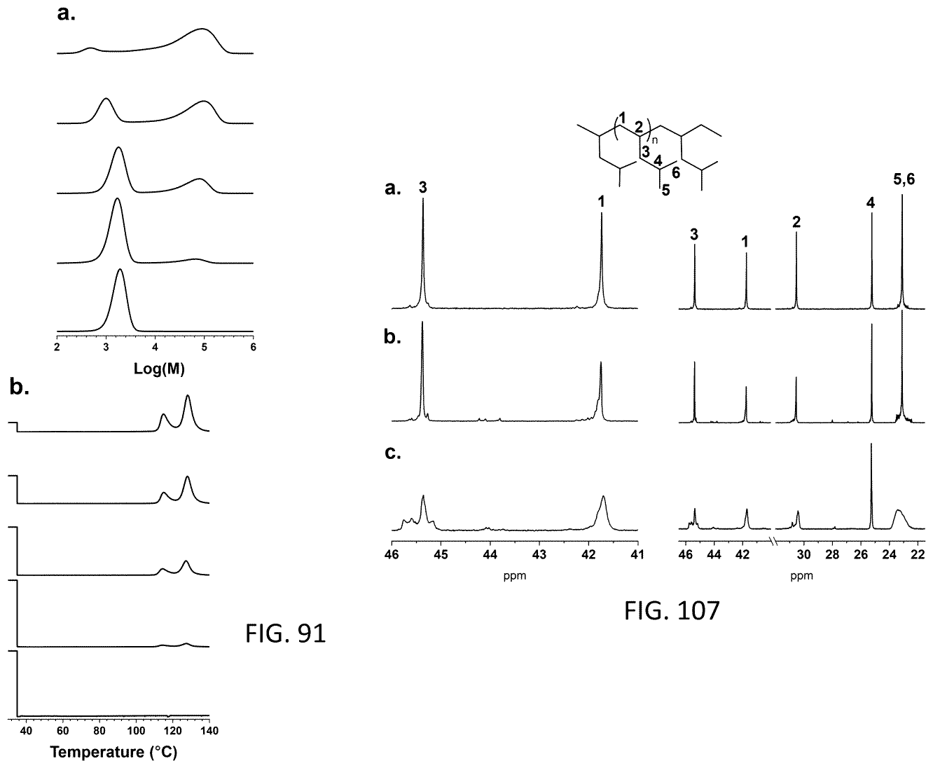

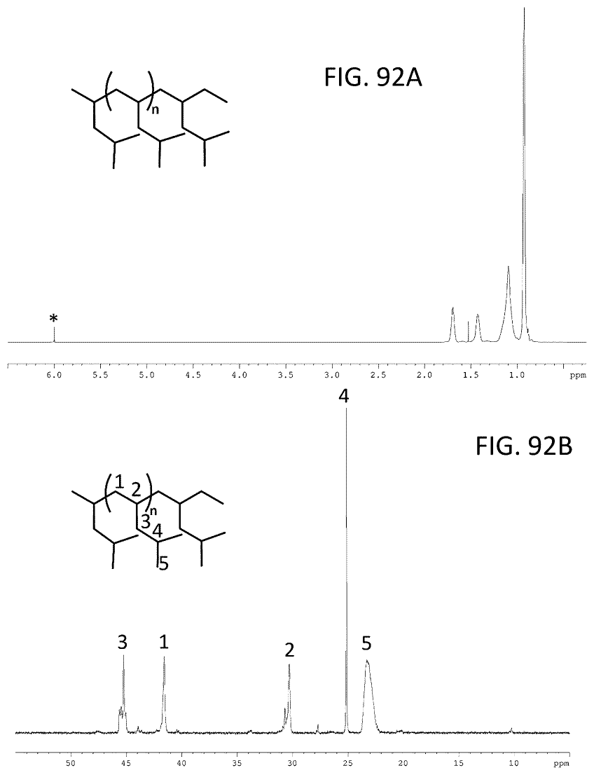

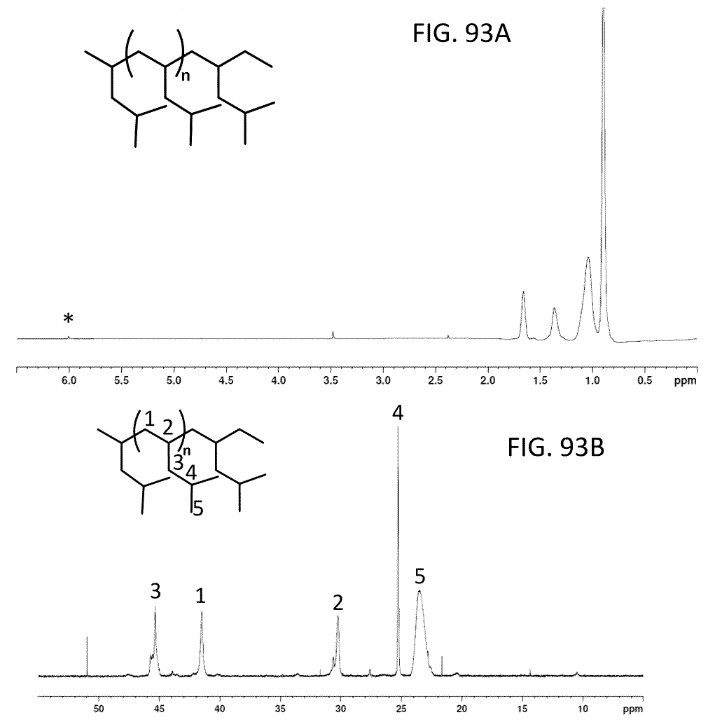

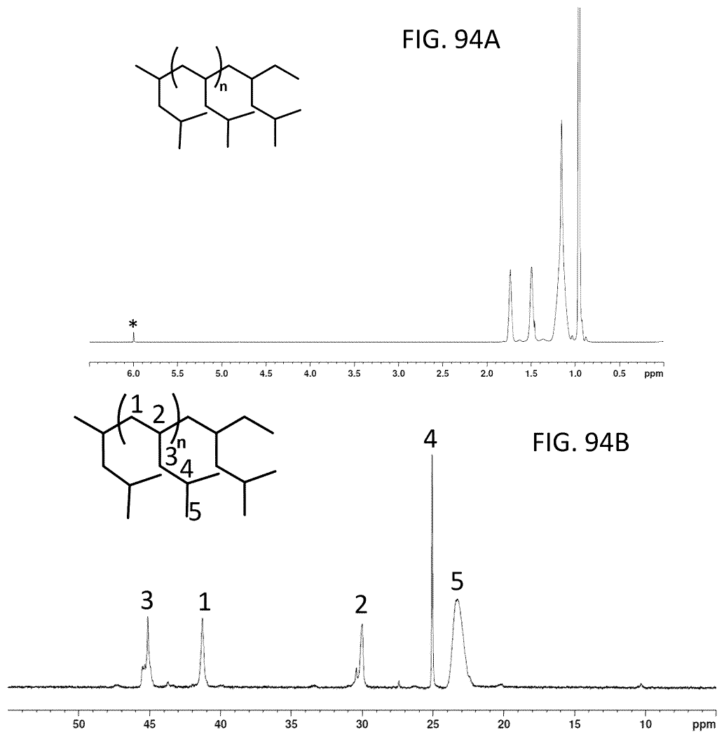

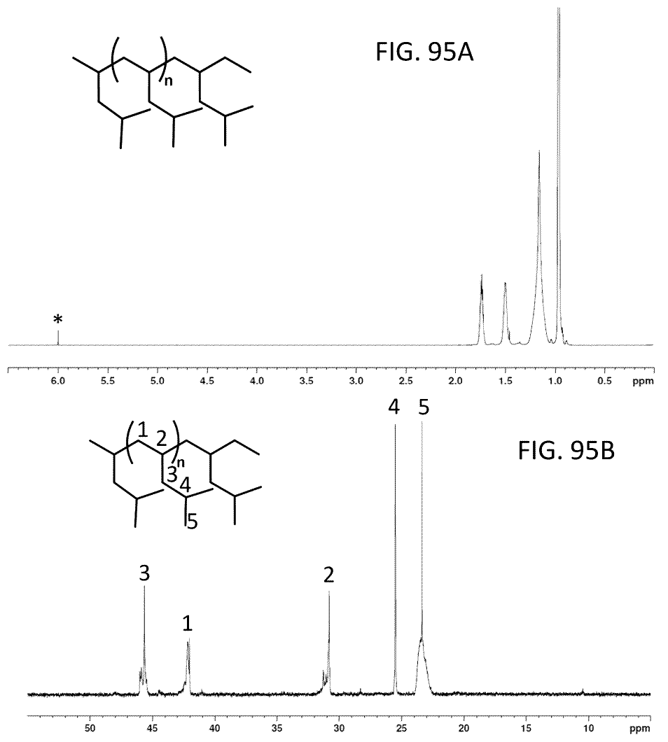

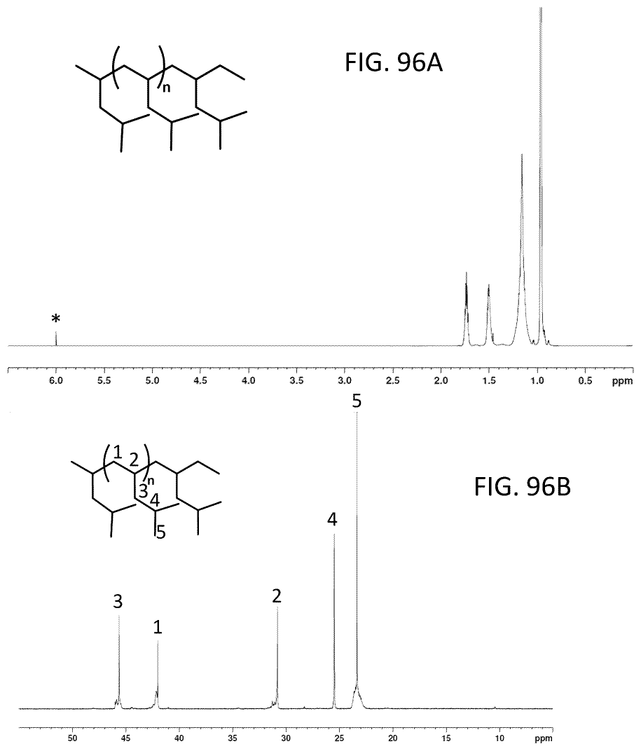

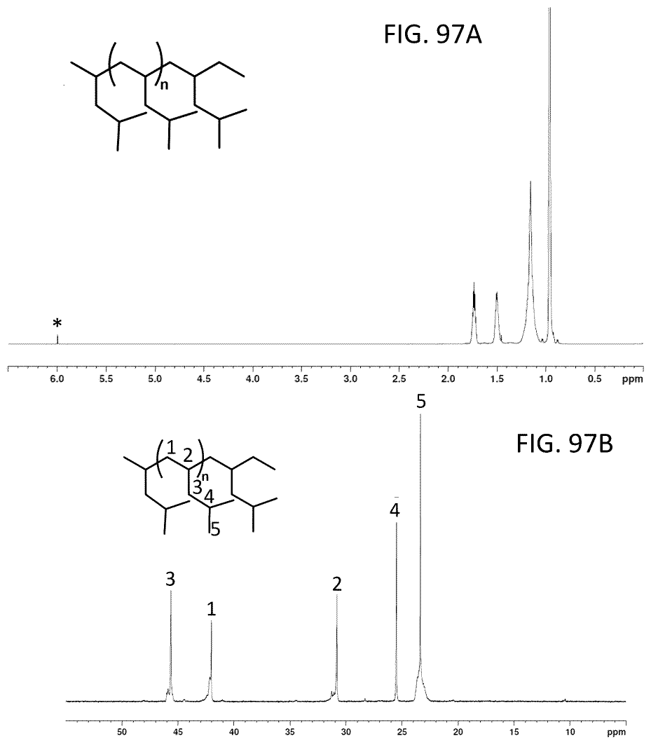

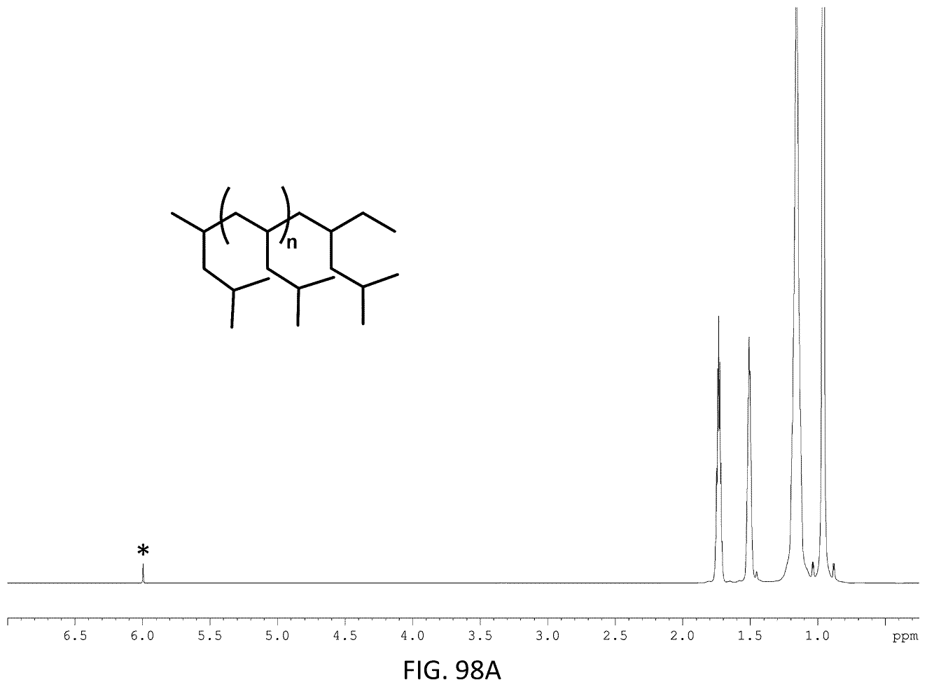

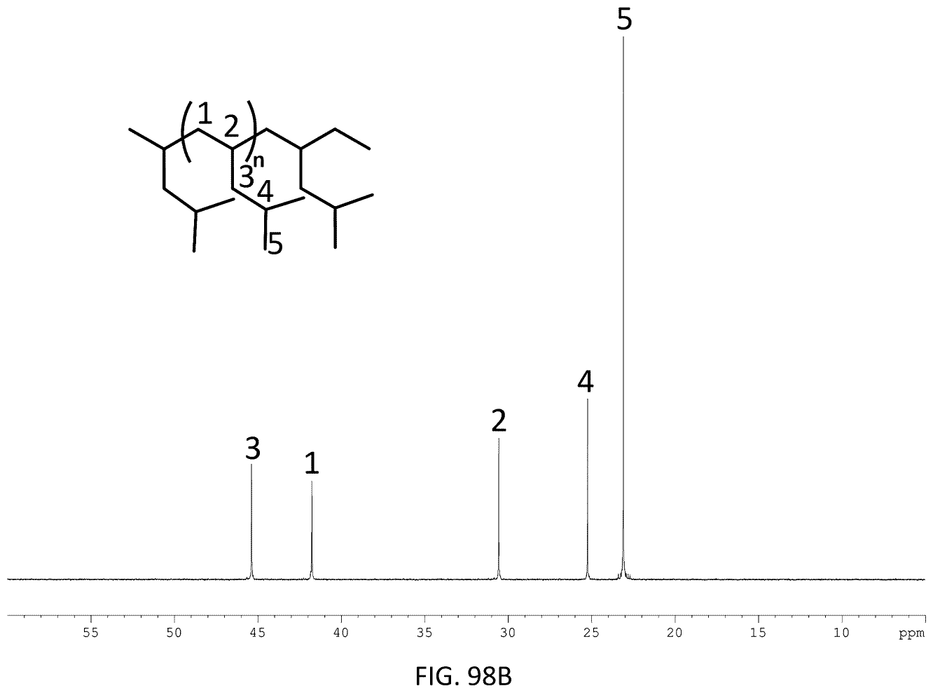

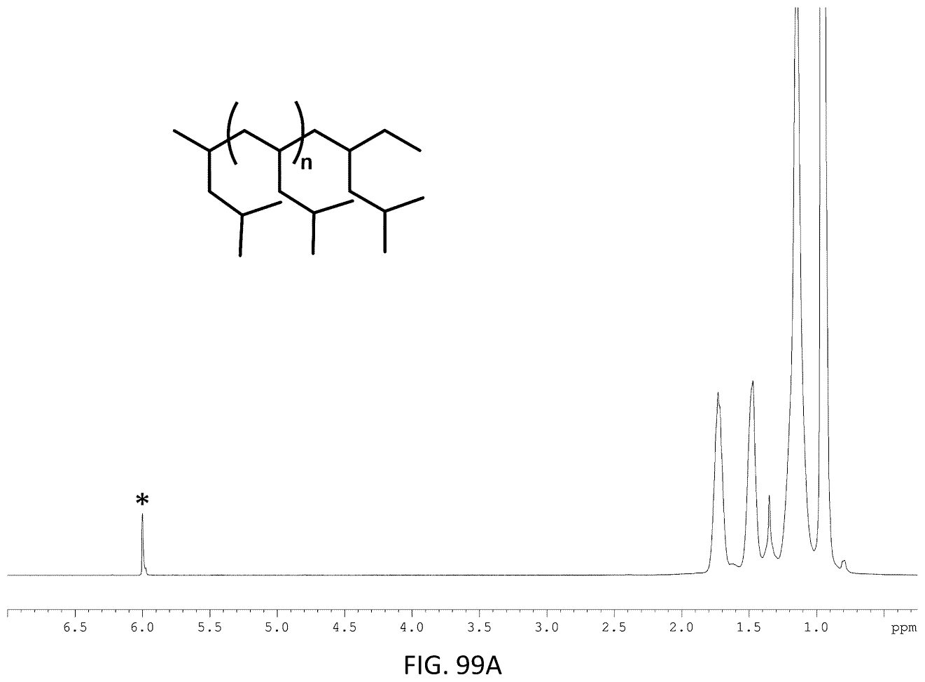

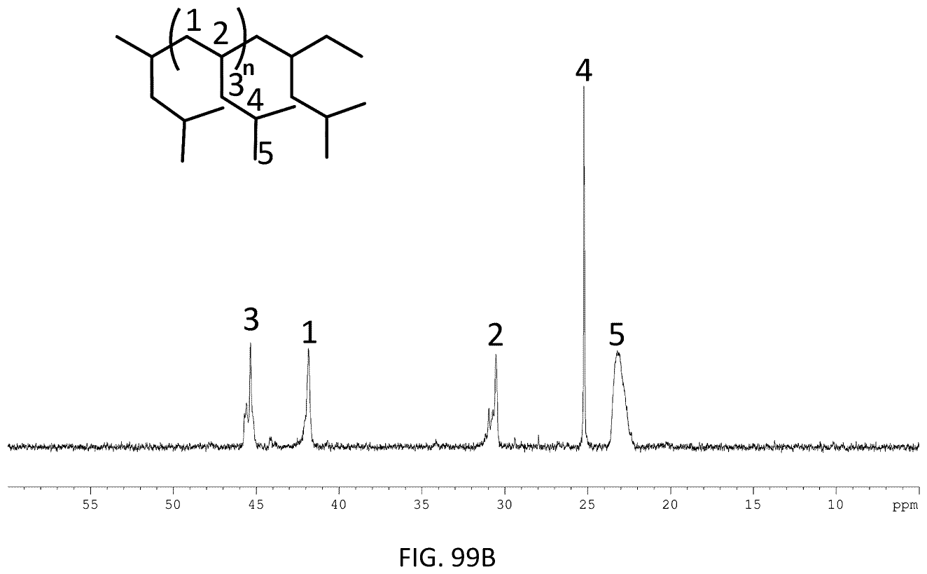

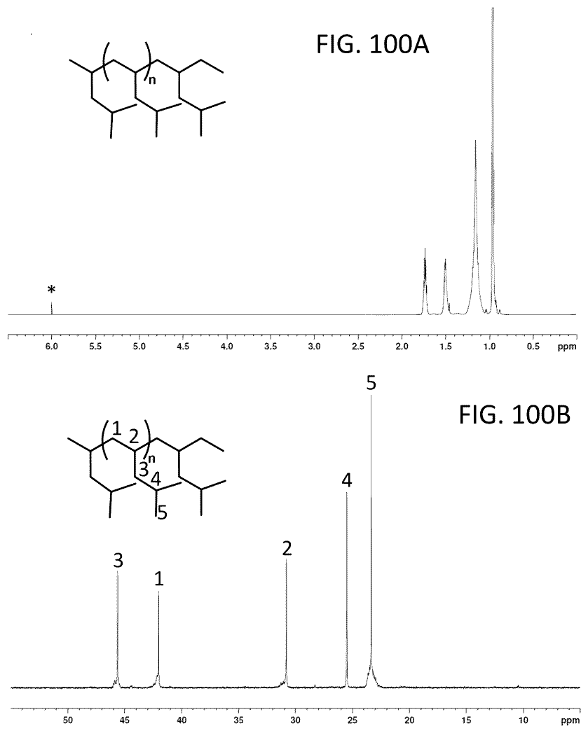

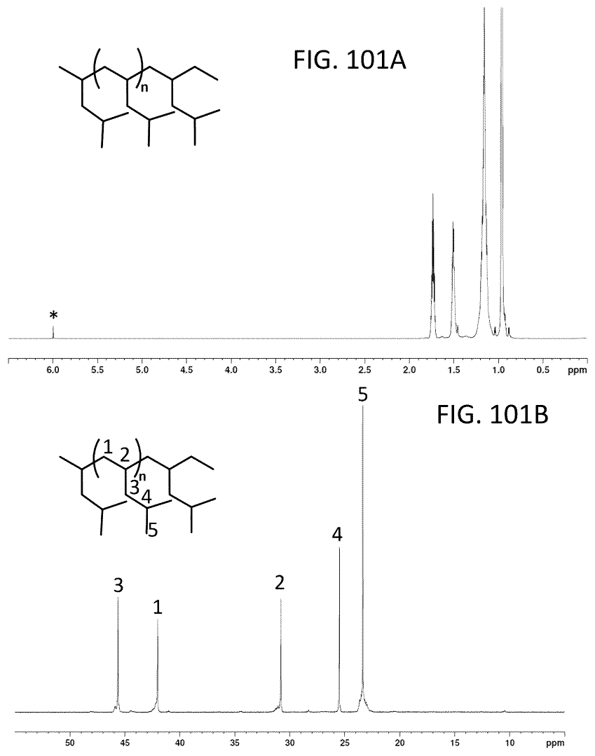

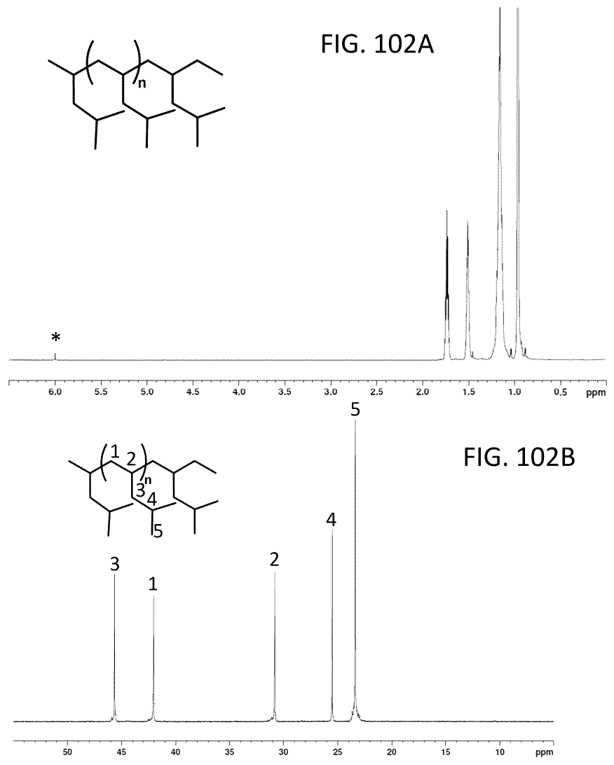

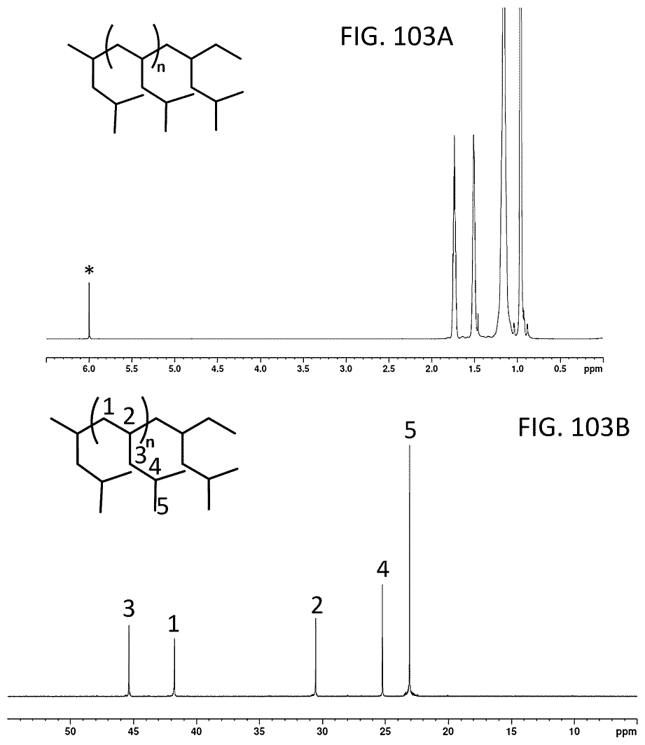

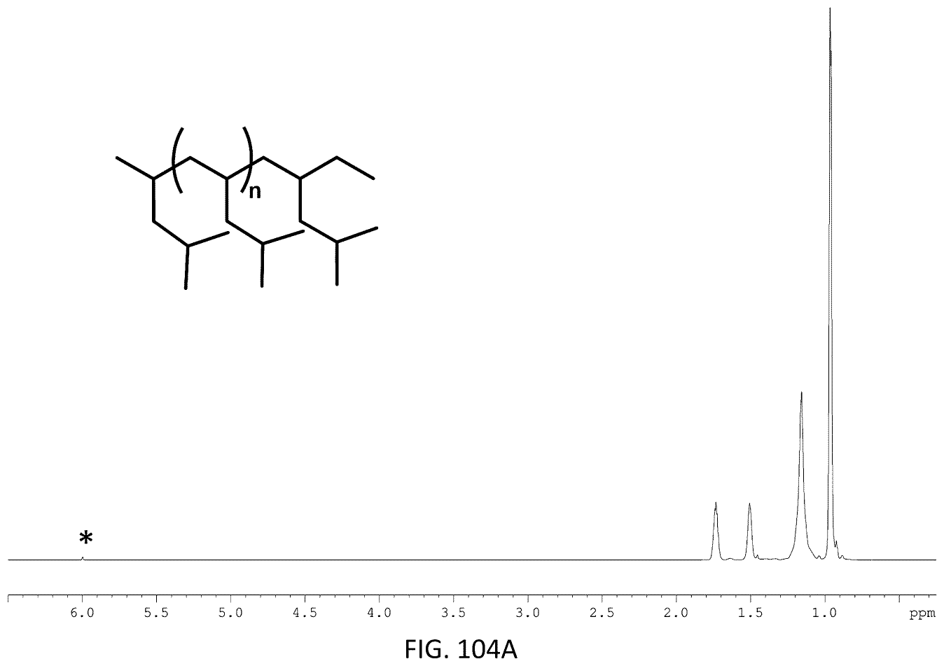

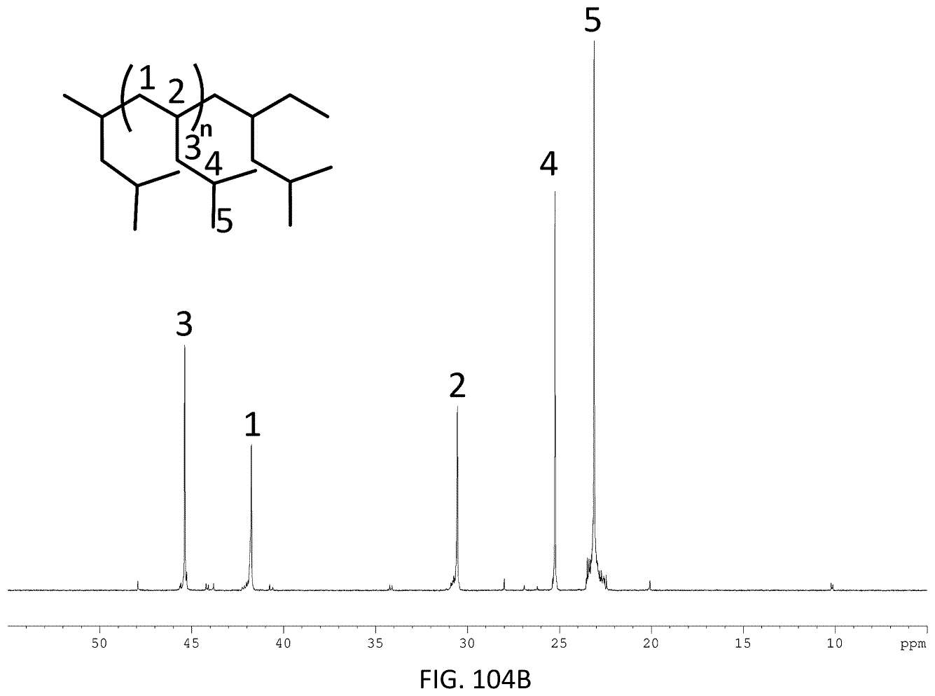

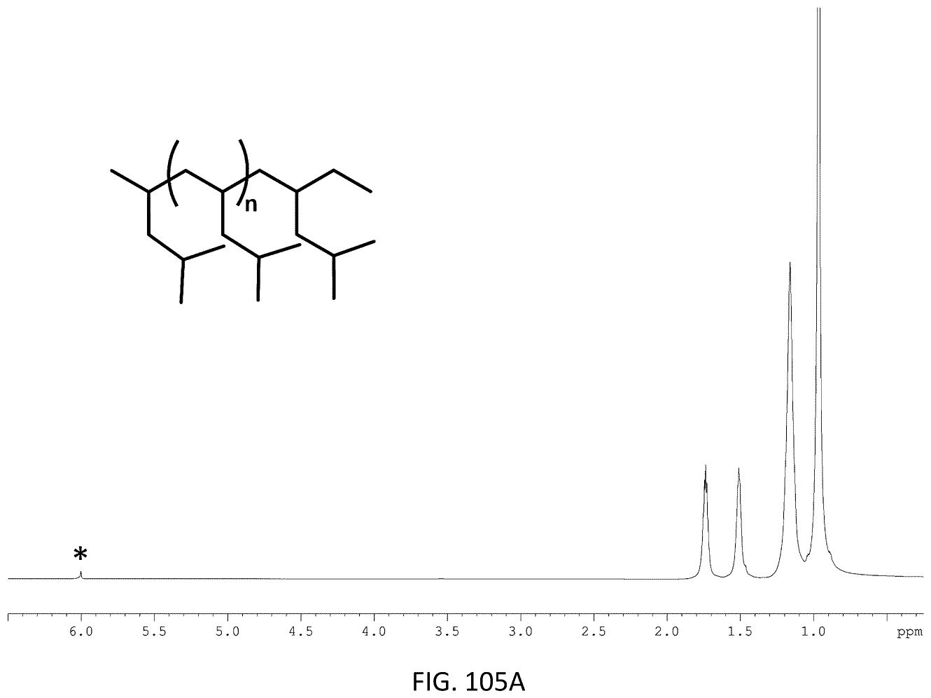

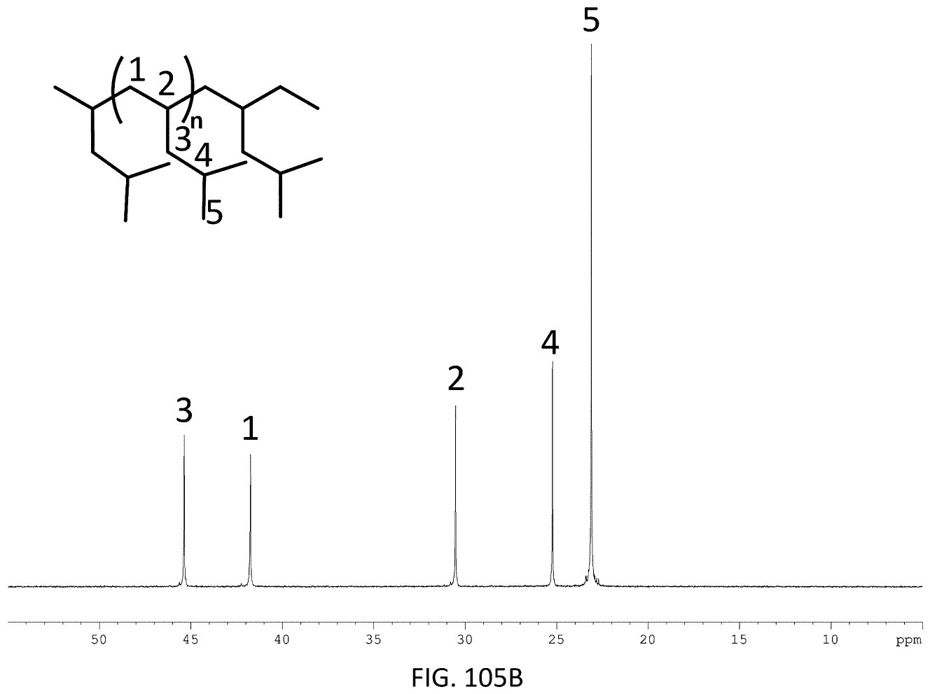

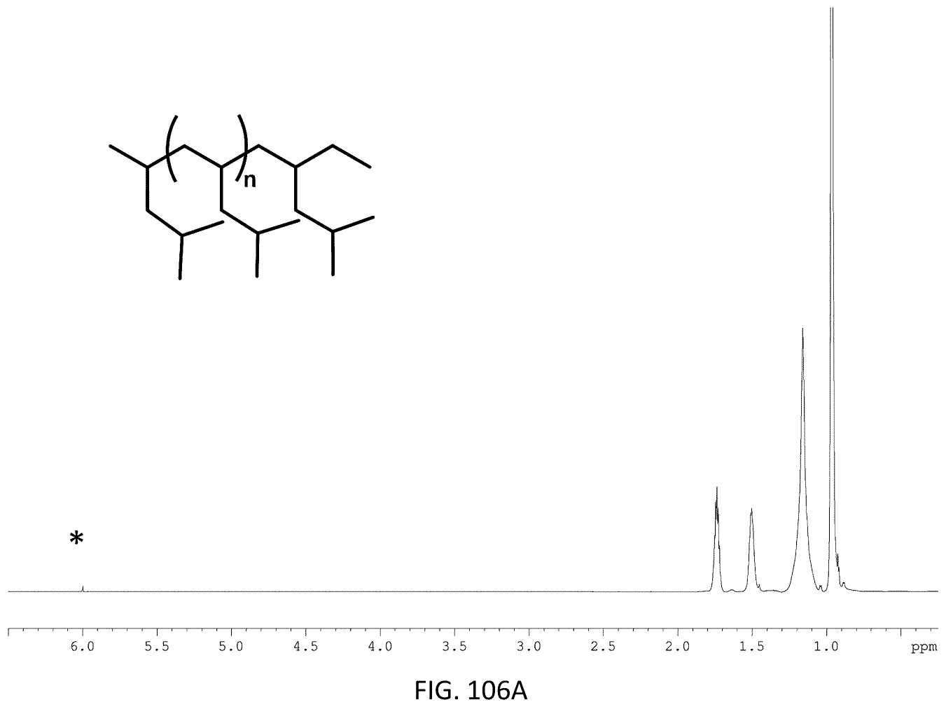

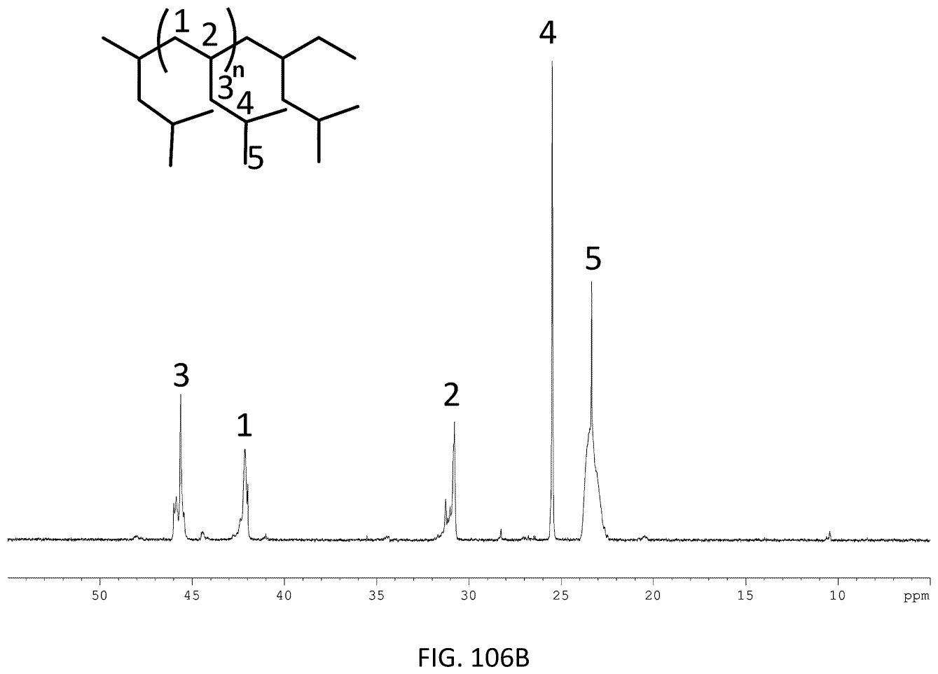

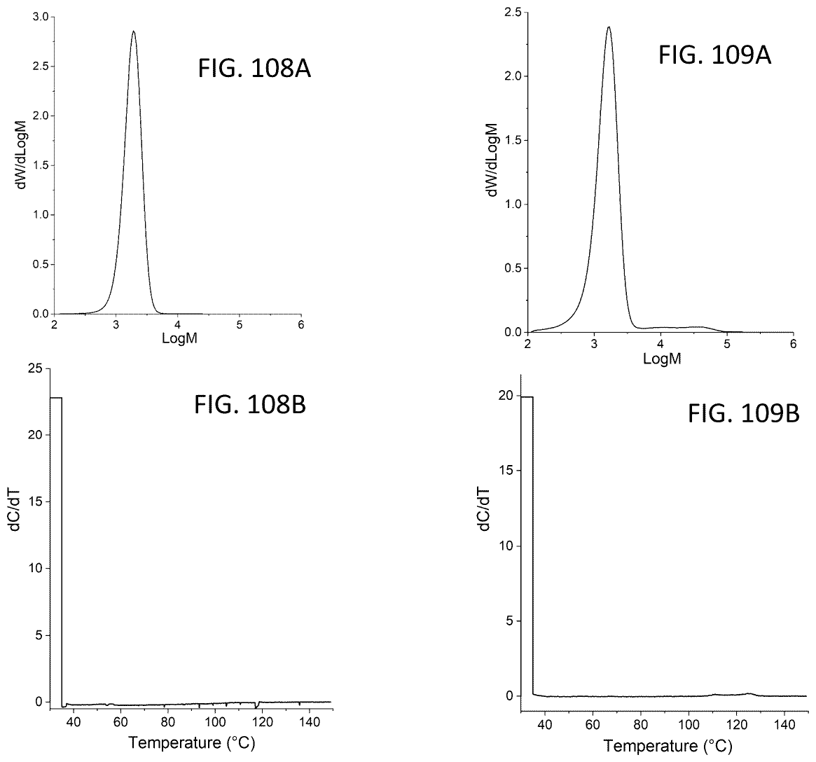

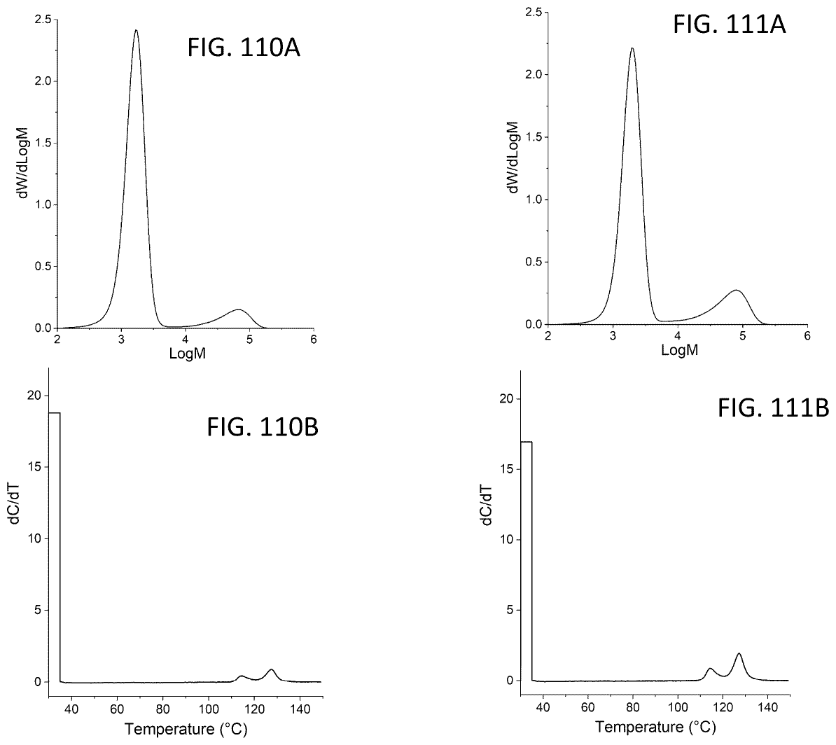

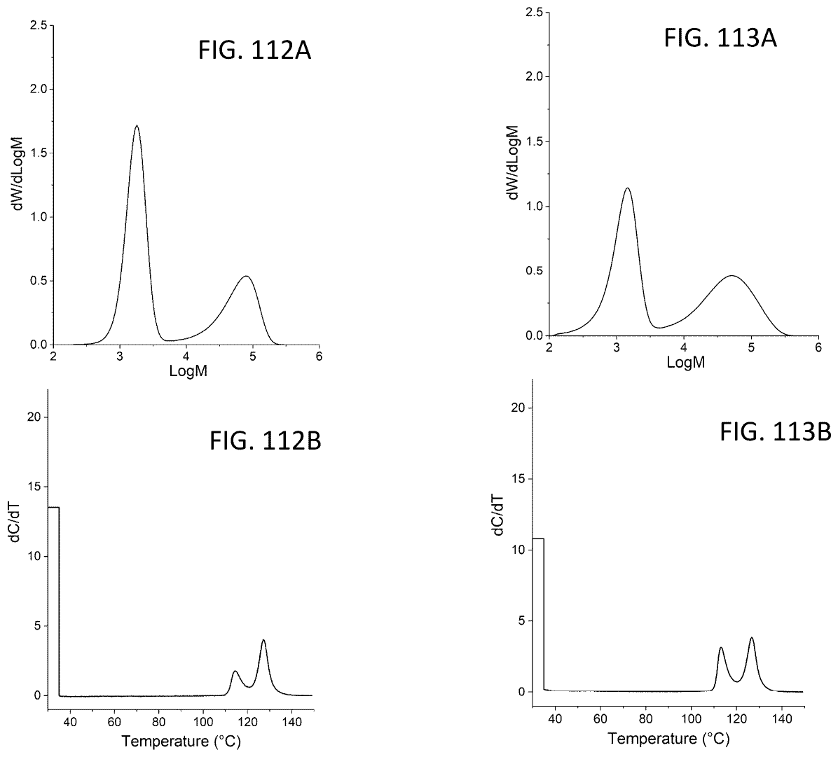

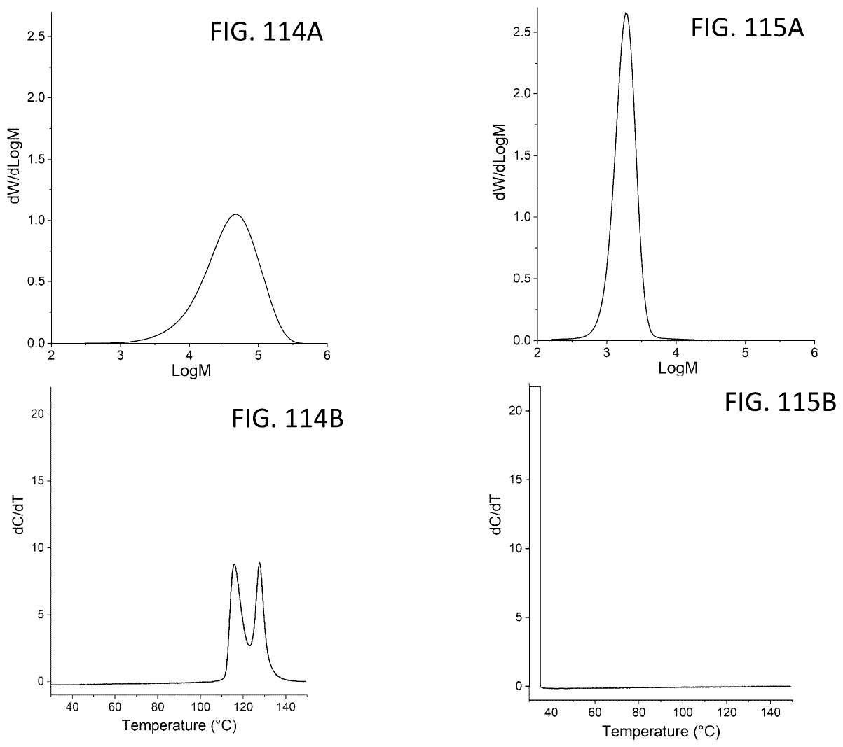

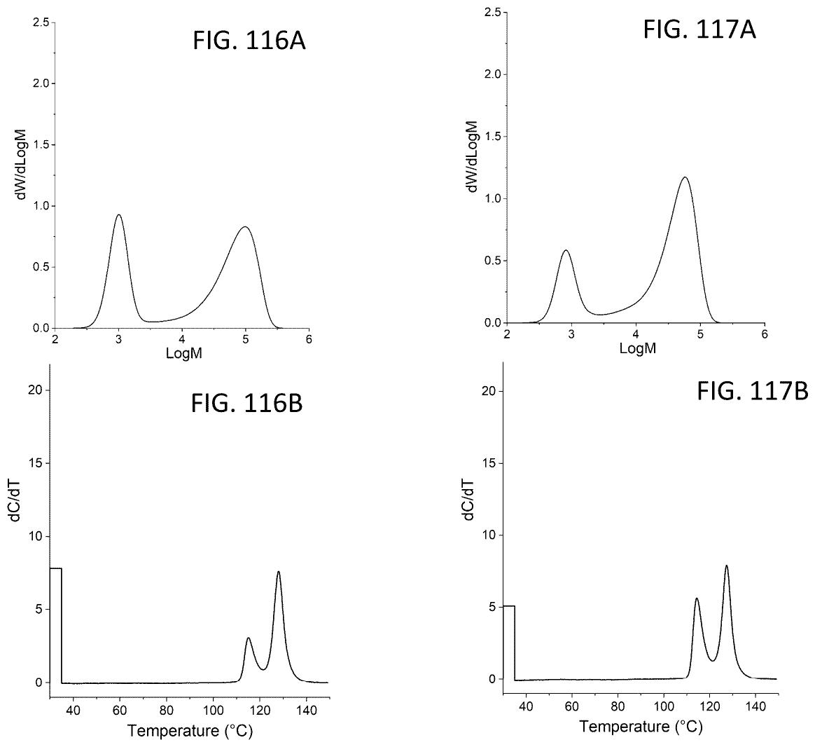

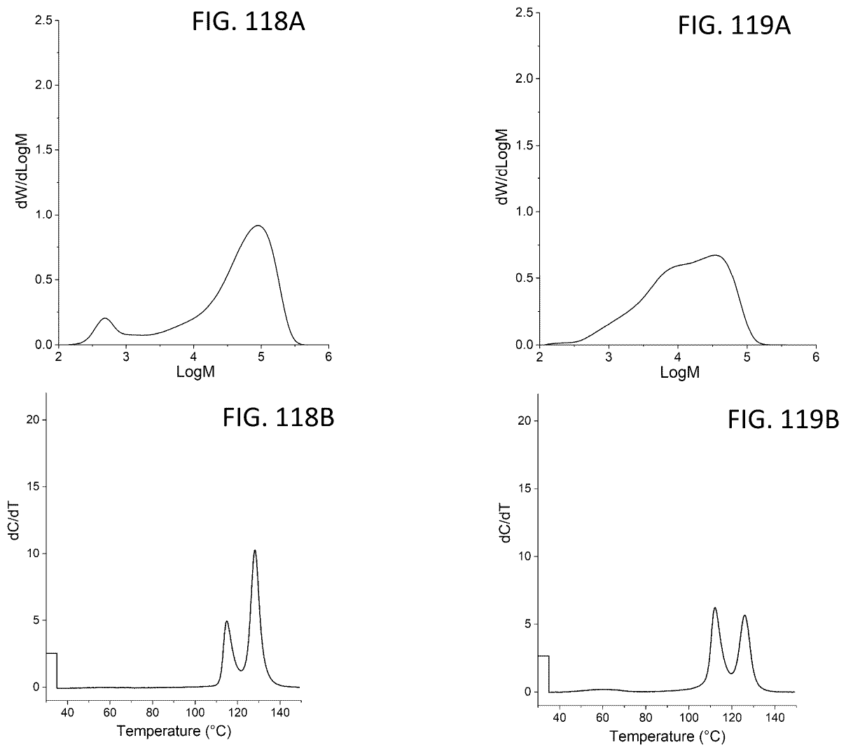

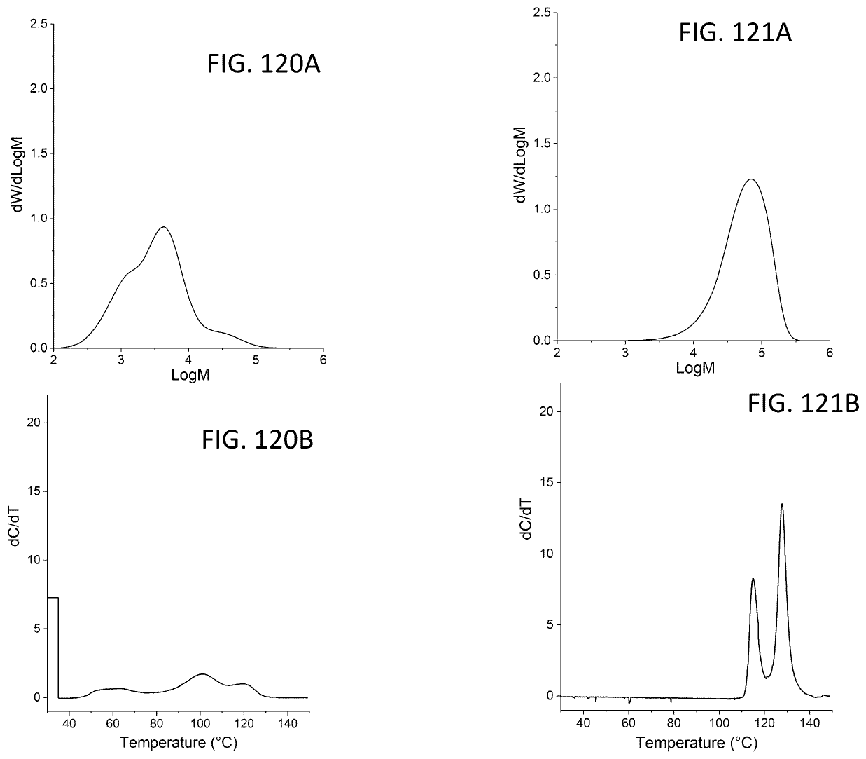

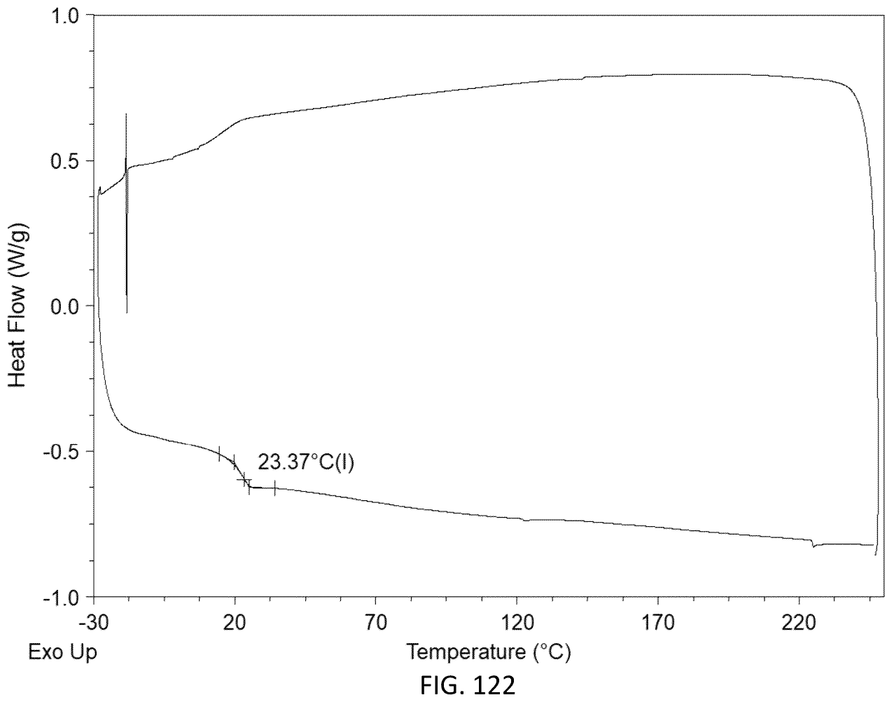

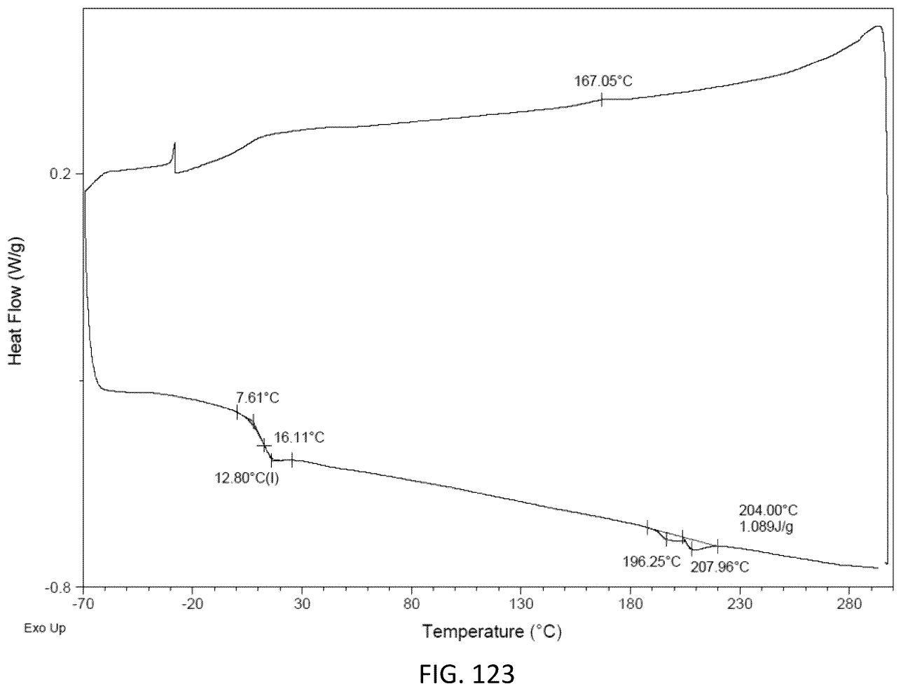

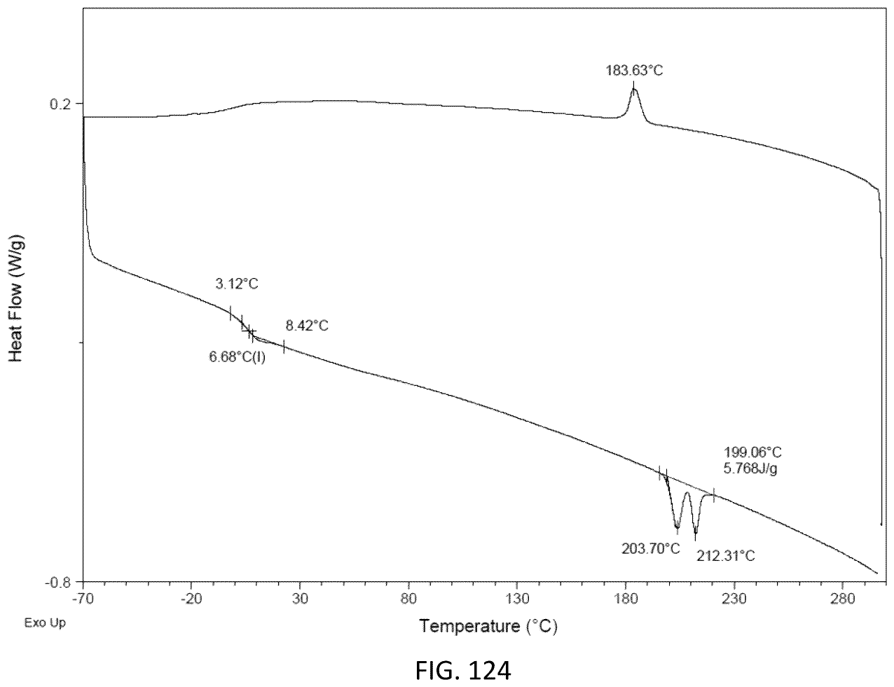

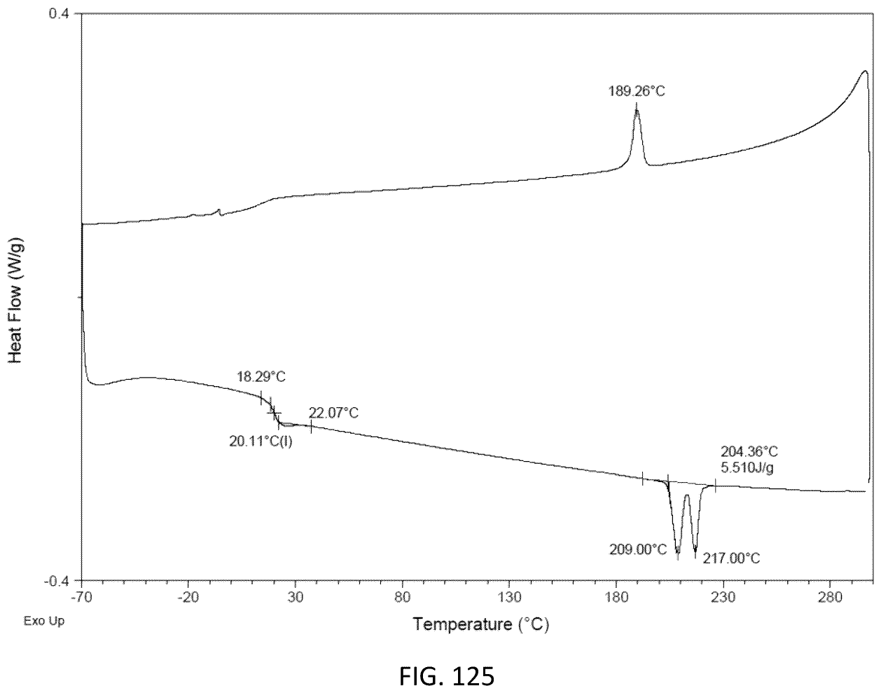

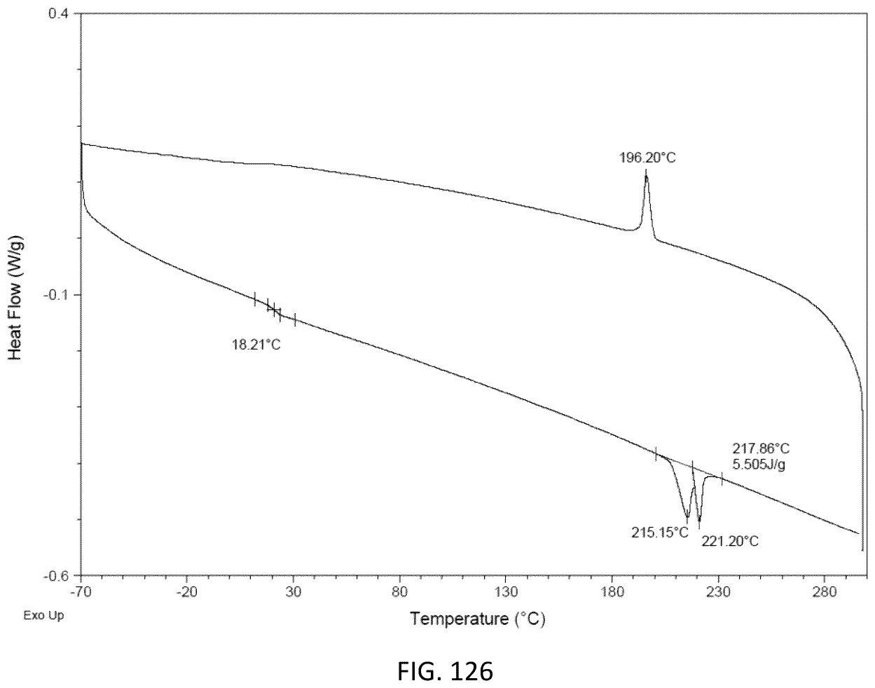

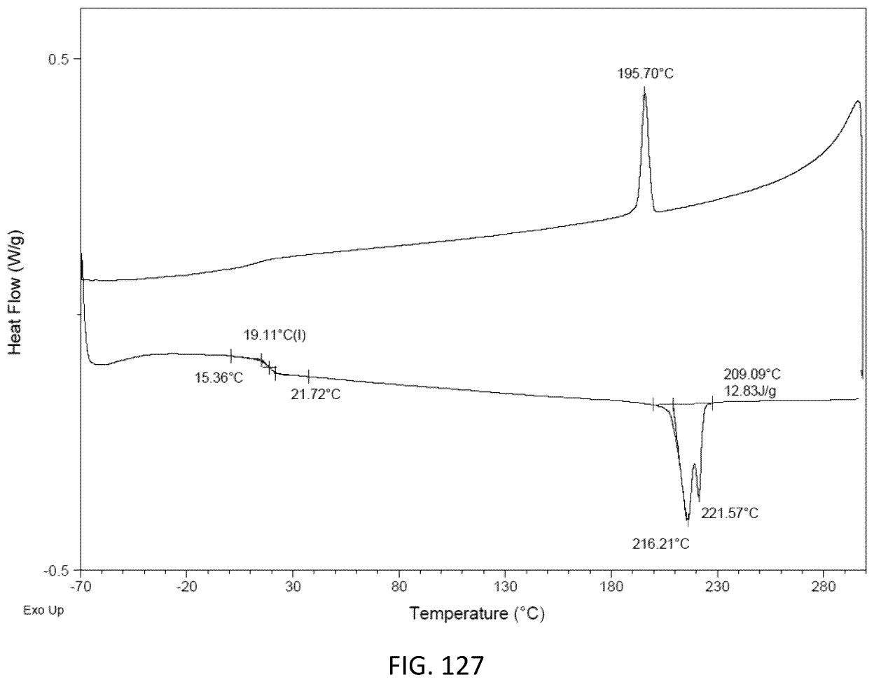

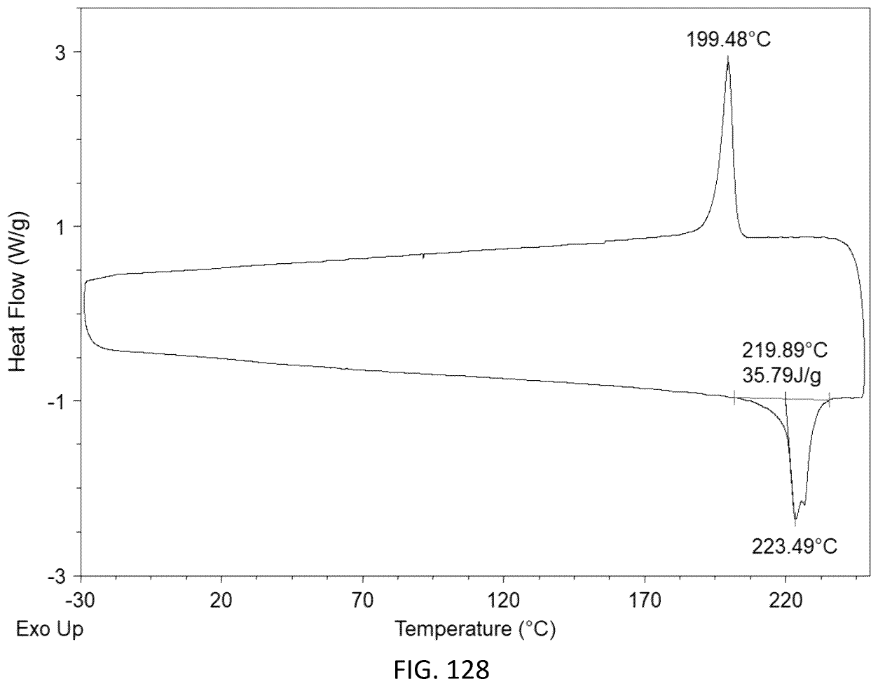

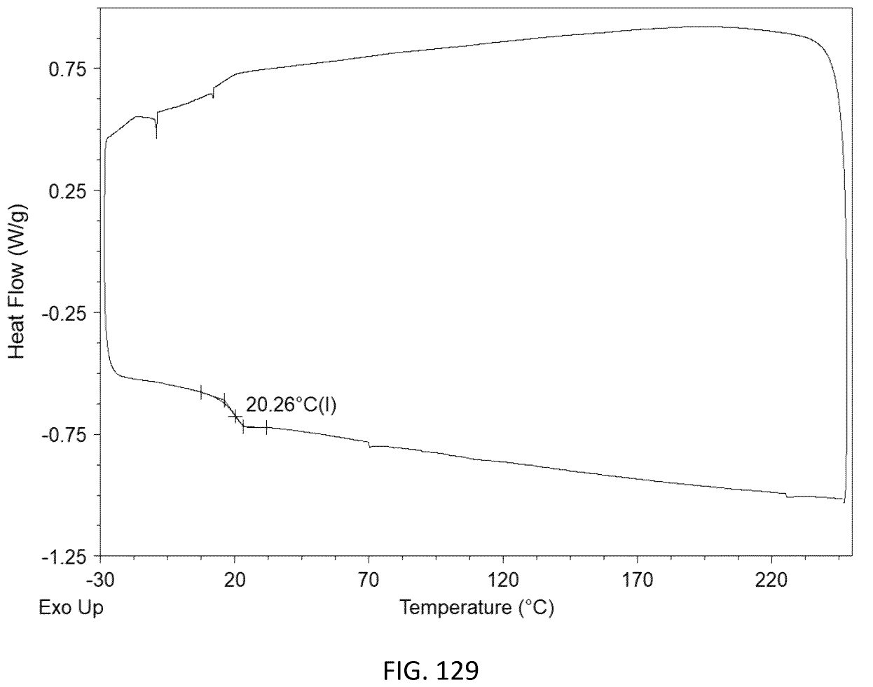

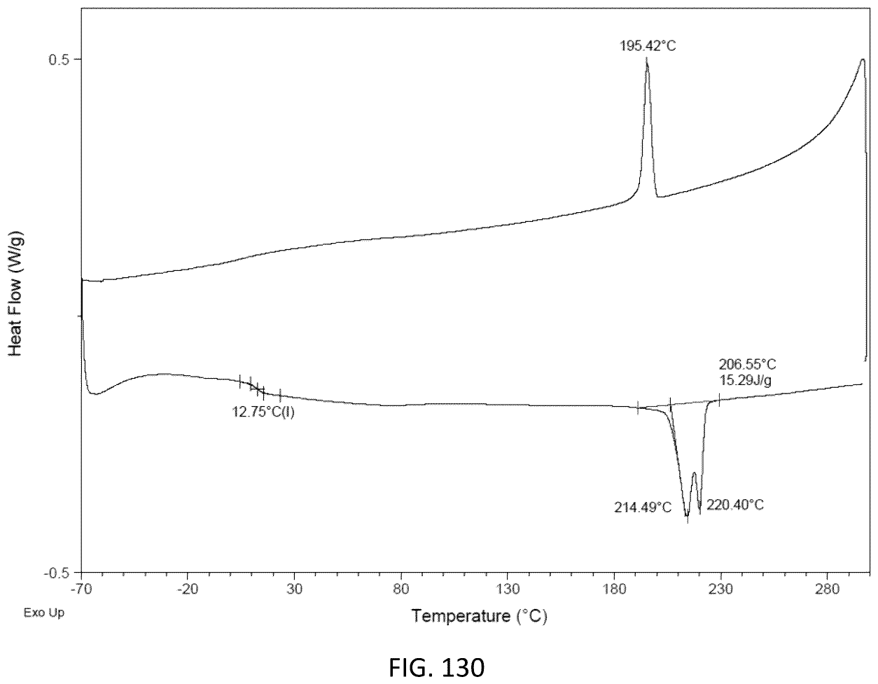

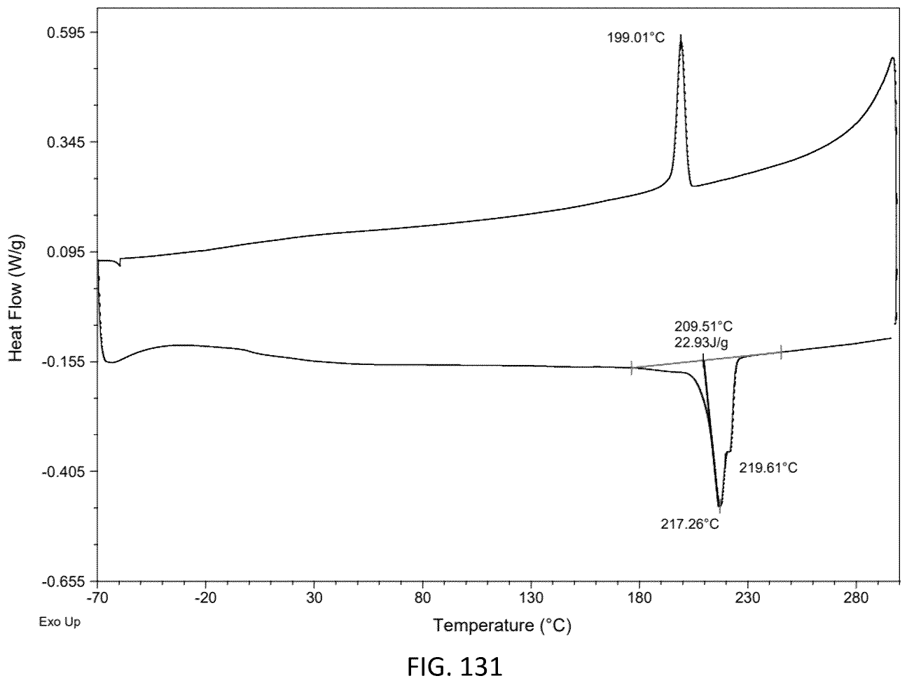

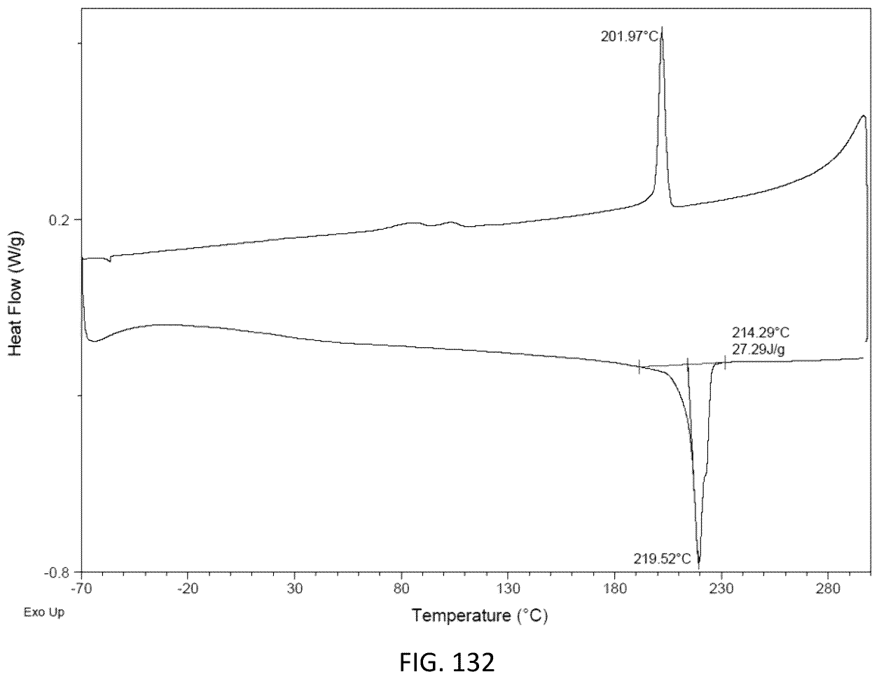

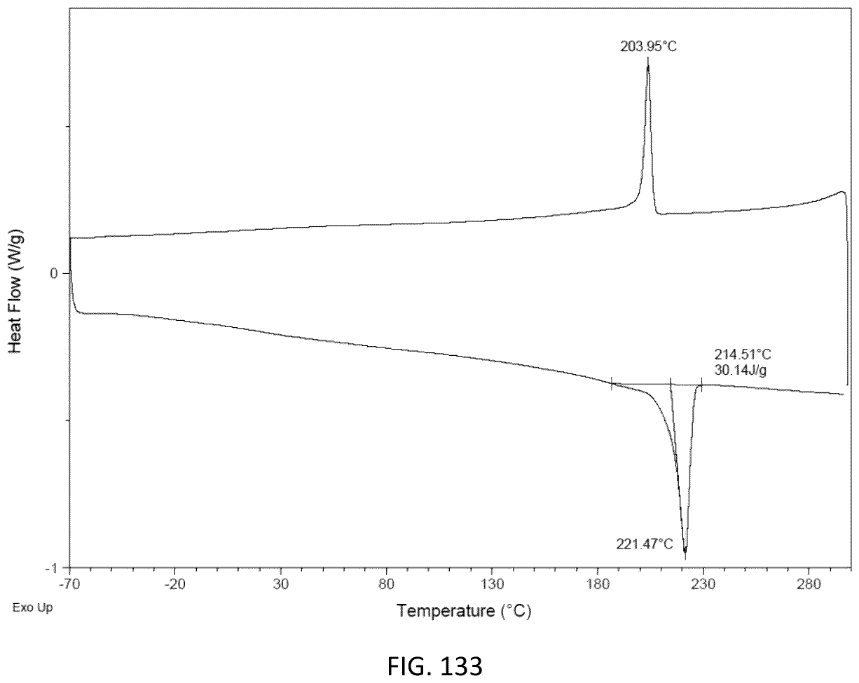

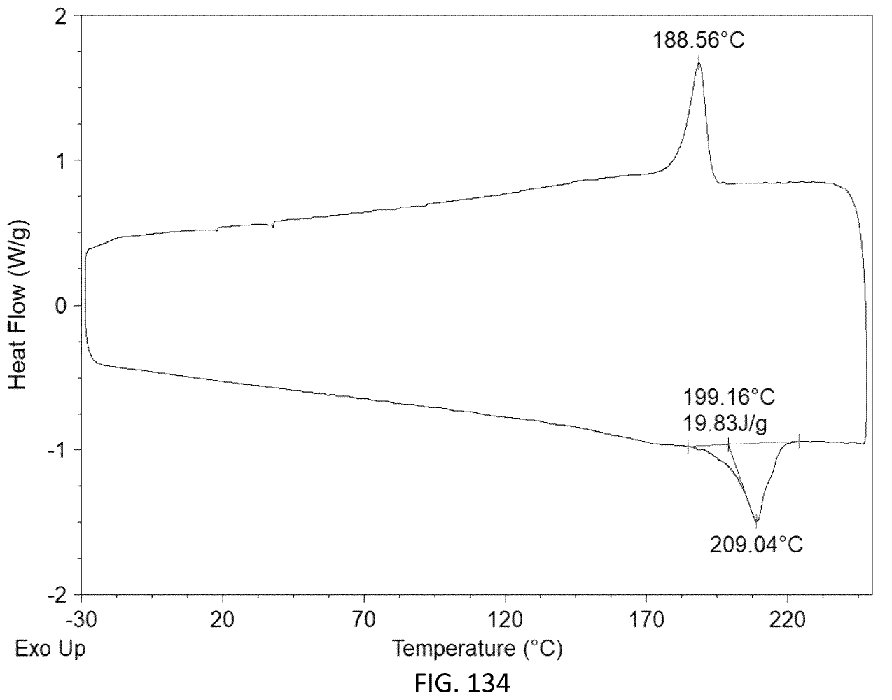

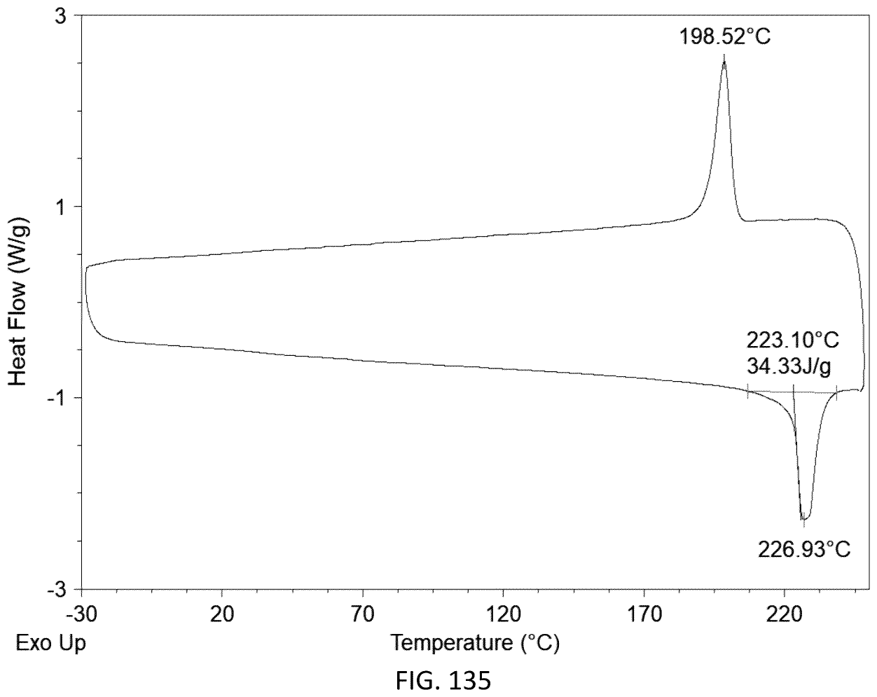

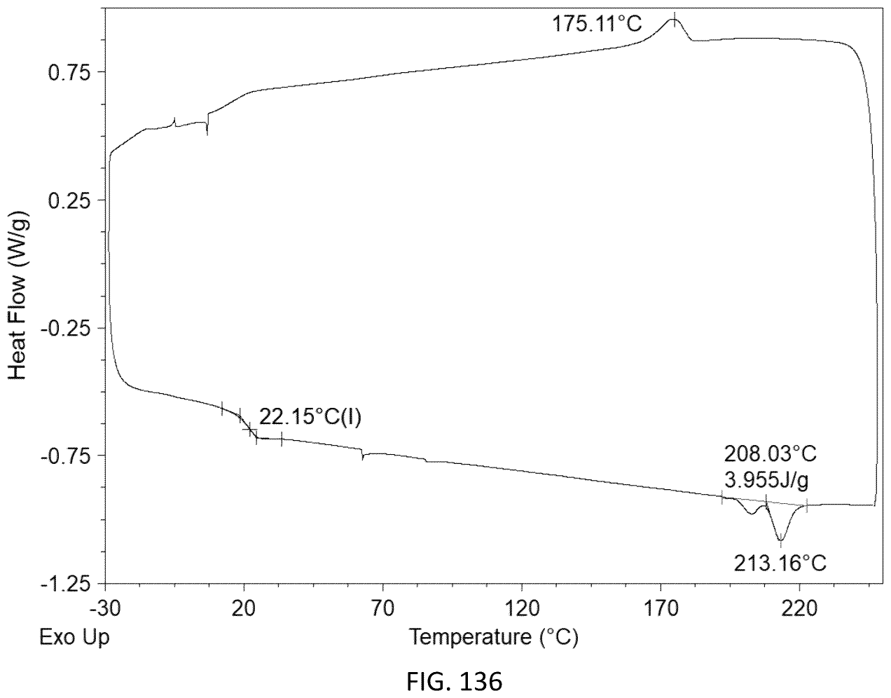

FIG. 90 presents HT-SEC and CEF data for run 5, together with that of the insoluble and soluble fractions obtained from Soxhlet fractionation. Both sets of SEC traces clearly reveal the presence of only two components in the originally isolated PMP material, one of which is a lower molar mass amorphous fraction that elutes very early at low temperature, and the second is a higher molar mass crystalline fraction that elutes at higher temperatures according to the CEF and HT-SEC analyses. Here, it is interesting to note the occurrence of two eluting crystalline fractions, which we have shown to also occur for the iPMP sample from run 10, as well as a commercial iPMP sample. We attribute these two fractions as arising from kinetic deposition during the CEF method of two different dominant crystalline polymorphs of iPMP, of which five with differing solubilities have been previously identified by x-ray analyses and reported in the literature. In other words, no evidence could be found for the co-existence of a stereoblock fraction that might be serving as a blend compatibilizer between the aPMP and iPMP components. Finally, FIG. 91 confirms that these HT-SEC and CEF results and conclusions are consistent for all the PMP materials of Table 5. Succinctly, for mixtures of 1 and 2, a stereoblend of aPMP and iPMP is formed, rather than a stereoblock PMP product, and with the iPMP fraction increasing as the pre-initiator ratio increasingly favors 2.

To summarize the present collection of results, we set out to investigate the strategy of producing new viscoelastic grades of PMP in controlled fashion by pitting two LCCTP process against each other according to FIG. 83. The same symmetries and steric environments about the transition-metals that enforce different stereochemical outcomes for propagation by active species obtained from 1 and 2 (i.e., atactic and isotactic, respectively) also dictate the relative rates of reversible chain exchange that occur between ‘like’ (Hf/Hf or Zr/Zr) or ‘unlike’ (Hf/Zr) propagators. In this case, it is clear that the less sterically-encumbered aspecific Hf-based active species outcompete the isospecific Zr-based active species with respect to both a higher rate of chain-growth propagation and domination for chain exchange with the fixed population of Zn-based surrogate centers. As a consequence, this leads to a lower molar mass fraction of aPMP by the former and higher stereoregularity of the iPMP fraction due to much less chain exchange occurring between enantiomeric forms of the latter. However, the most surprising and major finding of this work is the previously unreported ability of aPMP to serve as a property modifier for iPMP through formation of blends. Although it remains to be confirmed through additional extended investigations, we propose that aPMP is compatible with the amorphous regions of iPMP, which then places constraints on crystalline domain size (see FIG. 84). Finally, as a test of these hypothesis, a purposefully made blend (II) of separately-prepared aPMP and iPMP materials that conform to the fractions identified for run 3 (1:2=70:30) was obtained through solvent mixing and removal of volatiles. Gratifyingly, as FIG. 86 reveals, a stress-strain characterization of II via DMA revealed very similar viscoelastic properties to that of between runs 2 and 3. Further investigations are now in progress to explore the bulk structure and rheology of these new stereoblends of PMP and of their potential for new technological applications.

### Experimental Details

General Considerations. All manipulations of air and moisture sensitive compounds were carried out under N₂ atmospheres with standard Schlenk line or glovebox techniques. Toluene (ReagentPlus, 99%) was dried and deoxygenated by passage over activated alumina and GetterMax® 135 catalyst (purchased from Research Catalysts, Inc.) and collected prior to use. Chlorobenzene (Acros Organic, 99%) was dried over calcium hydride by refluxing at 130° C. for three days and distilled under N₂ prior to use. 1, 1, 2, 2-Tetrachloroethane(C₂C14)-d2 was purchased from Cambridge Isotopes and used as received. Chloroform-dl was purchased from Cambridge Isotopes and used as received. 4-methyl-1-pentene (>97%) and 1-hexene were purchased from TCI Chemicals, dried over Na/K alloy and isolated by vacuum-transfer prior to use. Diethylzinc (>52 wt. % Zn) was purchased from Sigma-Aldrich and used as received. All other solvents and reagents were used as received unless otherwise.

Nuclear Magnetic Resonance (NMR). ¹H and ¹³C{¹H}NMR spectroscopy were performed using a Bruker AVIII-HD 800 spectrometer fitted with a cryo-QCI probe spectrometer. Spectra were referenced to residual solvent peaks (¹H: 7.26 ppm for chloroform-dl and 6.0 ppm for 1,1,2,2-tetrachloroethane-d2; ¹³C: 77.23 ppm for chloroform-dl and 73.78 ppm for 1,1,2,2-tetrachloroethane-d2).

Size Exclusion Chromatography (SEC). Polymer molecular weight distributions (MWD) were measured with a Polymer Char high-temperature gel permeation chromatographer (GPC) available at the University of Alberta. All analyses were run at 145° C. under a 1 ml/min flow rate of 1,2,4-trichlorobenzene (TCB), stabilized with 300 ppm of 2,6-di-tert-butyl-4-methylphenol. The GPC was equipped with three detectors in series (infra-red, light scattering, and differential viscometer) and calibrated with narrow polystyrene standards.

Crystallization Elution Fractionation (CEF). CEF was performed using a CEF instrument from Polymer Char. The samples were prepared in TCB stabilized with 300 ppm of 2,6-di-tert-butyl-4-methylphenol, at a concentration of 0.8 mg/mL. The polymer sample was dissolved in TCB at 160° C. The volume of the injected sample was 200 μL. The polymer solution was stabilized at 145° C. for 5 min before being injected in the CEF column. The cooling cycle started by decreasing the column temperature from 145 to 35° C. under a constant cooling rate of 1° C./min and. At the end of the cooling cycle, the column temperature was held at 35° C. for 3 min under a constant elution flow rate of 0.5 mL/min. The elution cycle started with a heating rate of 2° C./min and temperature changing from 35 to 150° C. The elution pump flow rate was 0.5 ml/min. The concentration of polymer in the eluent was monitored as a function of the elution temperature by a dual wavelength infrared detector placed at the exit of the CEF column. The dimensions of the CEF column were 15 cm length and 9.5 mm diameter. The CEF column was filled with inert stainless-steel shots.

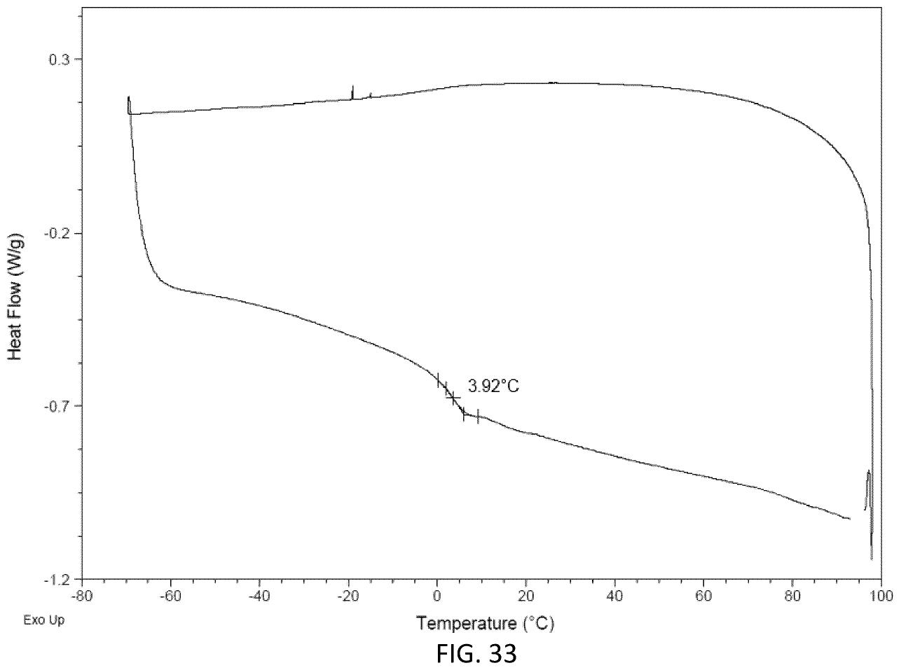

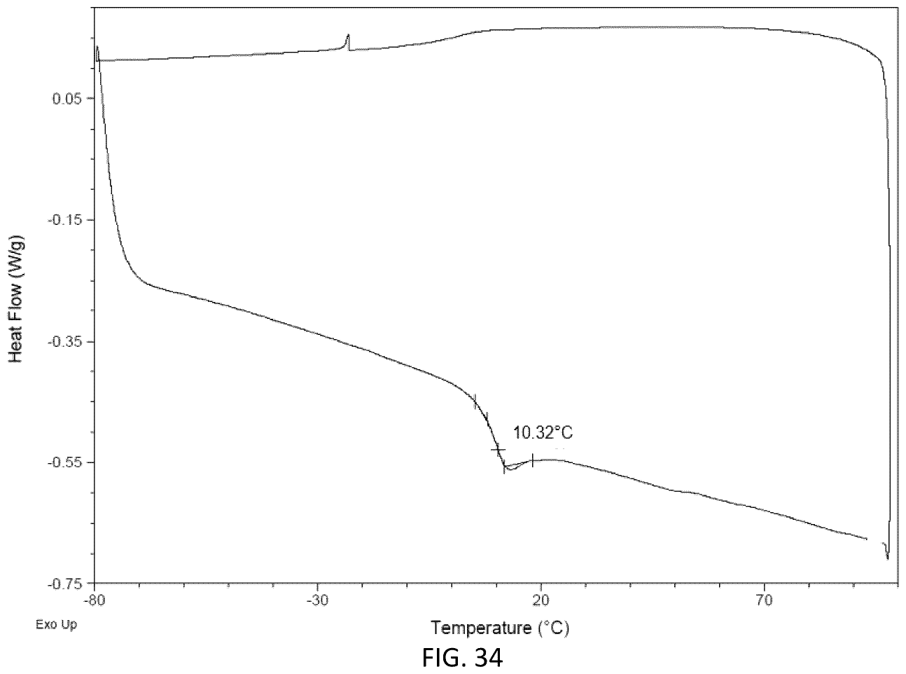

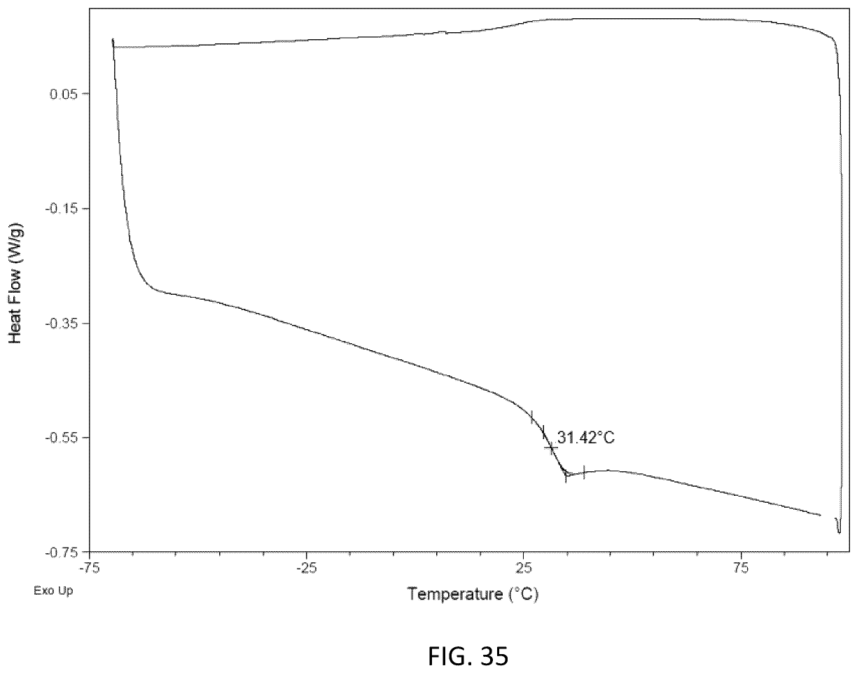

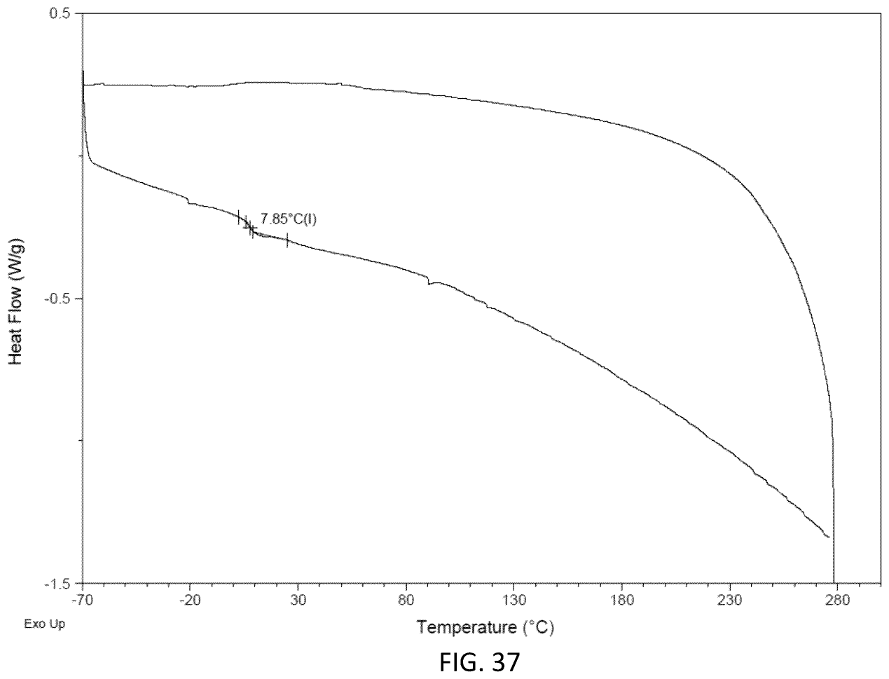

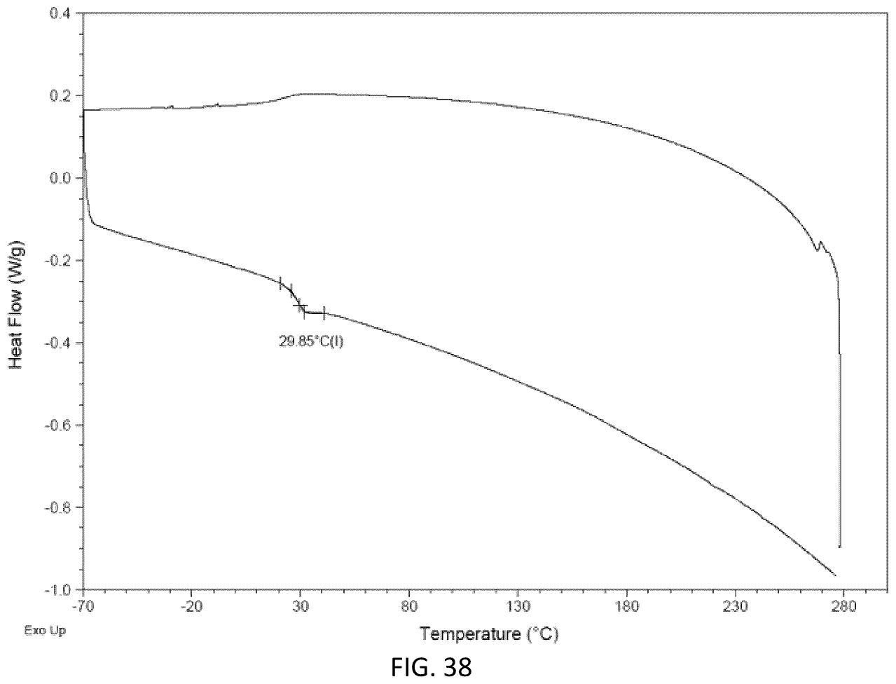

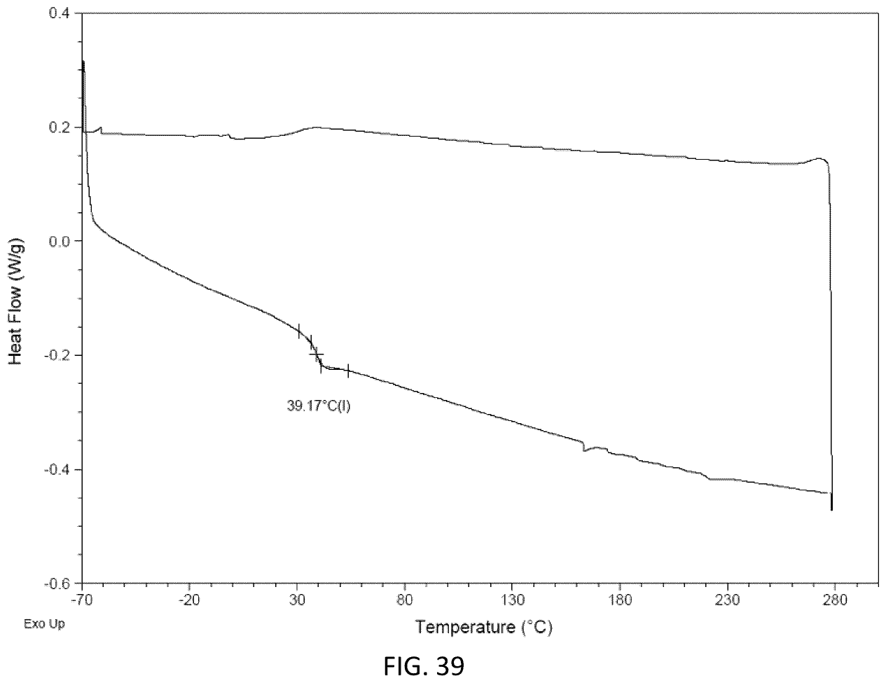

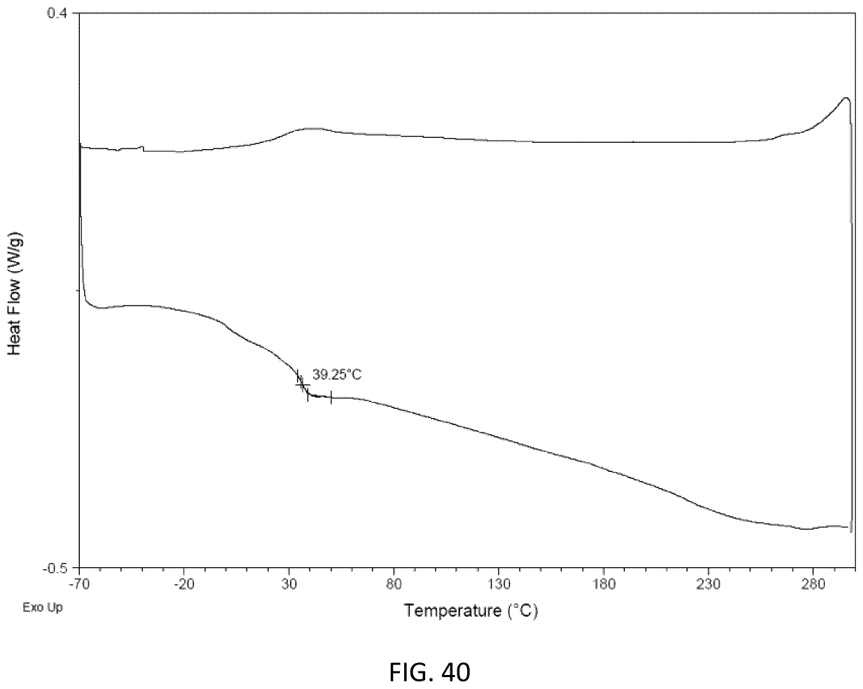

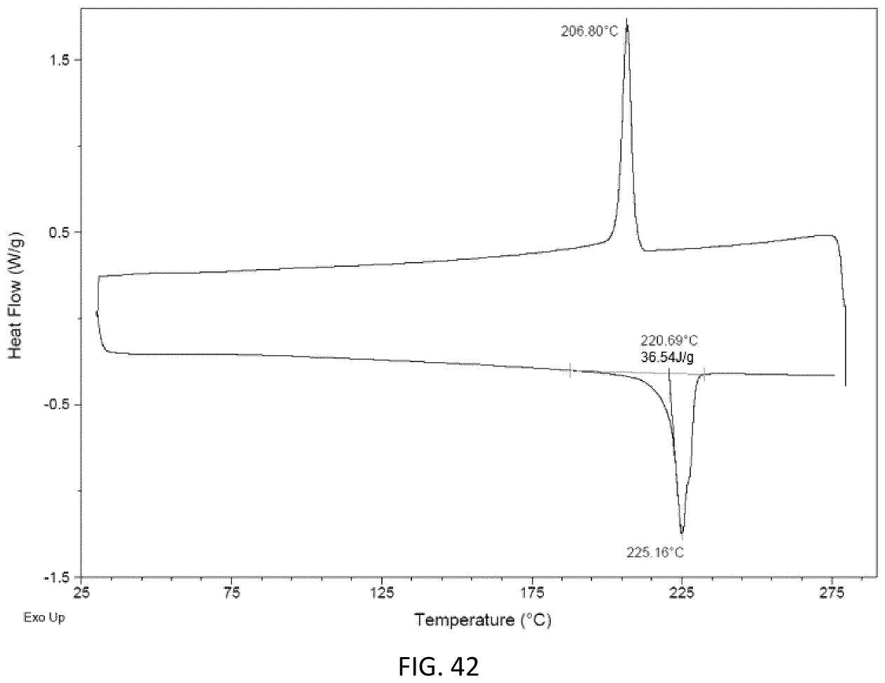

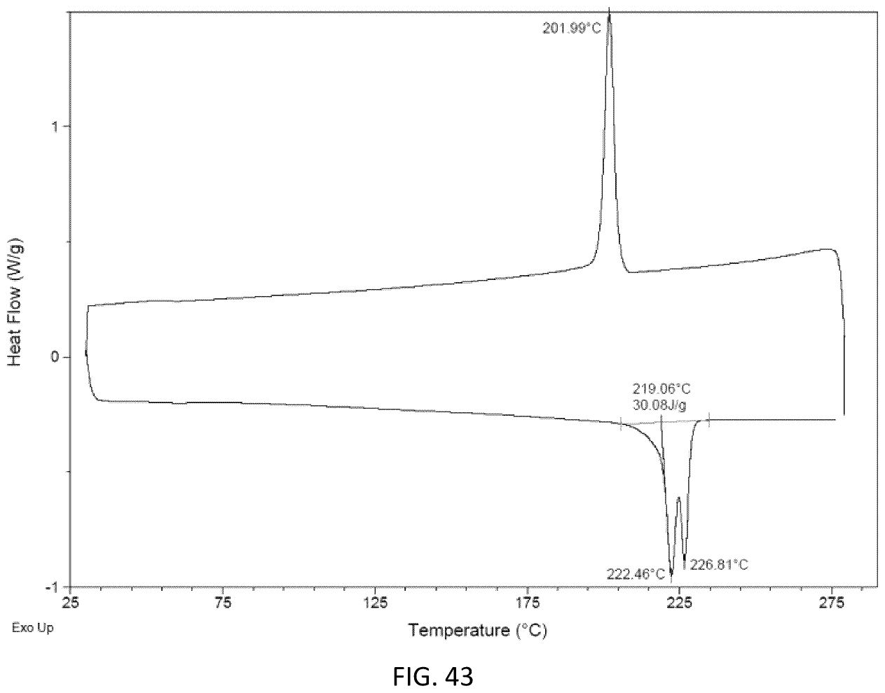

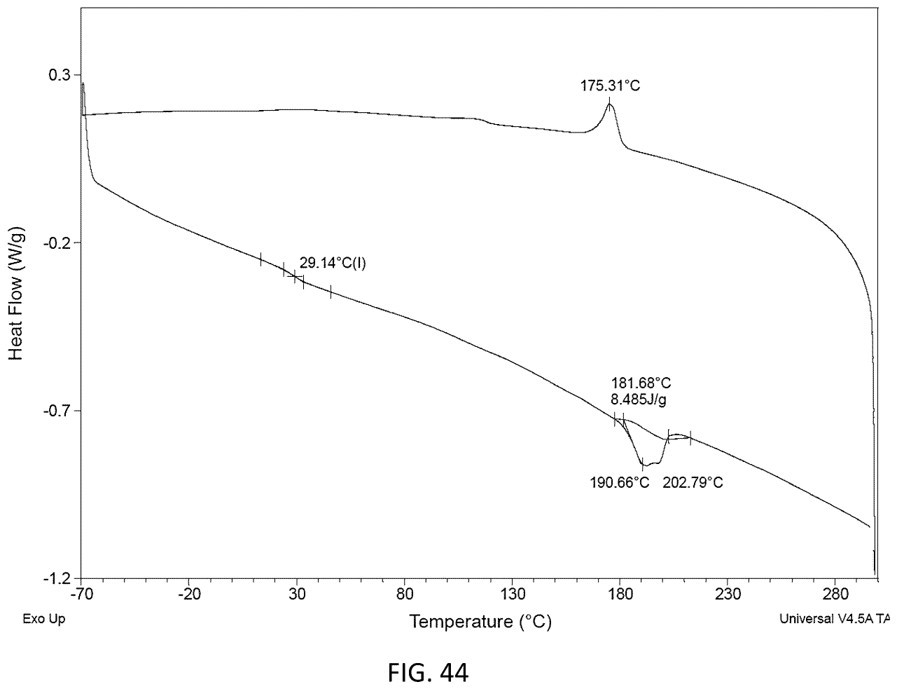

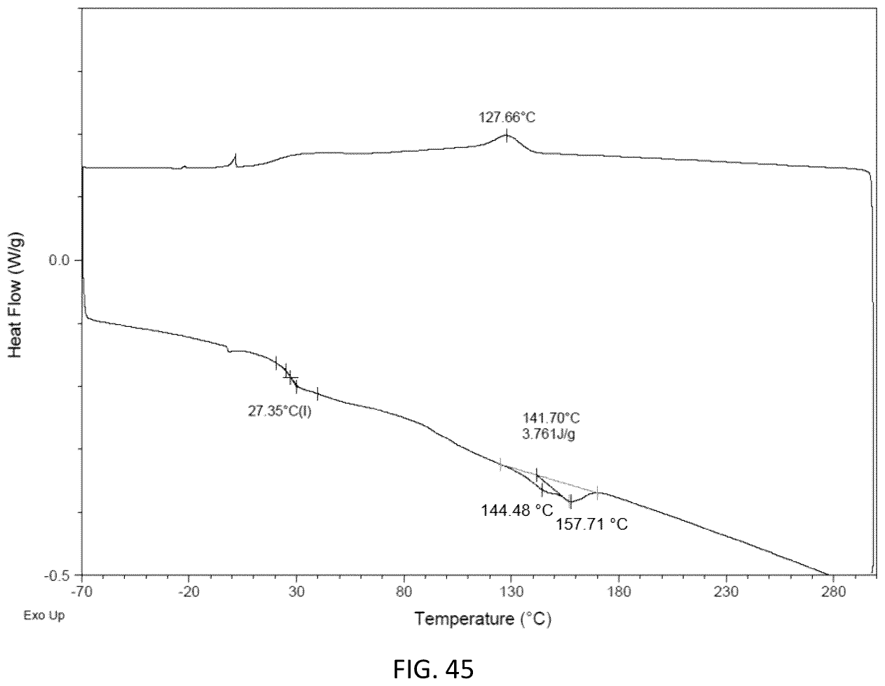

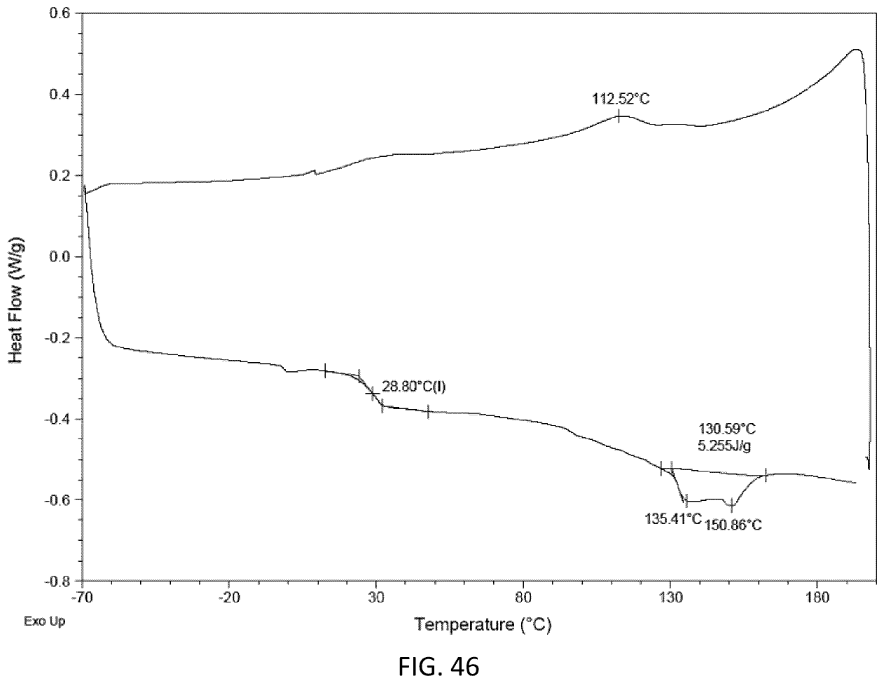

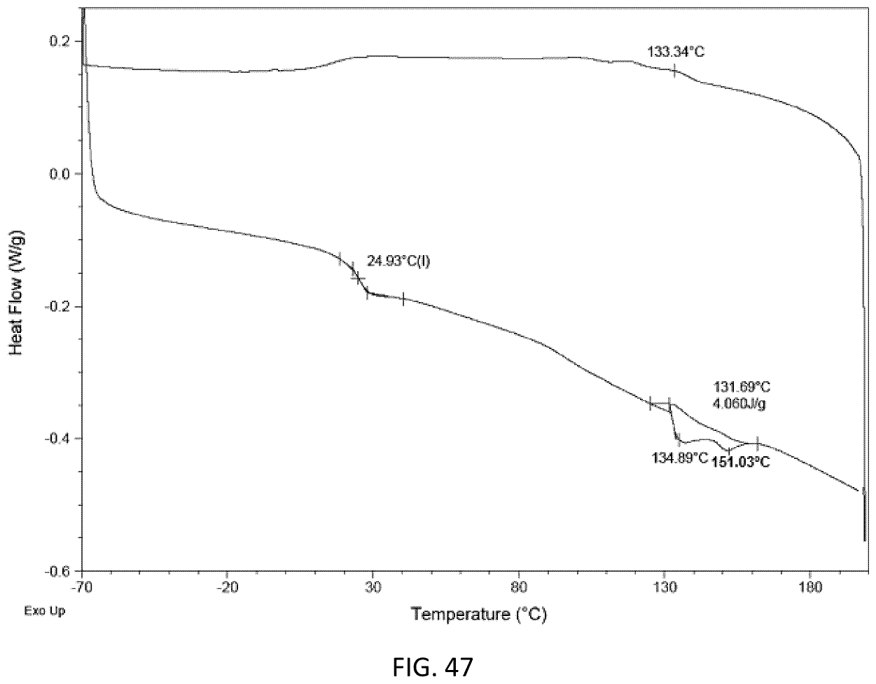

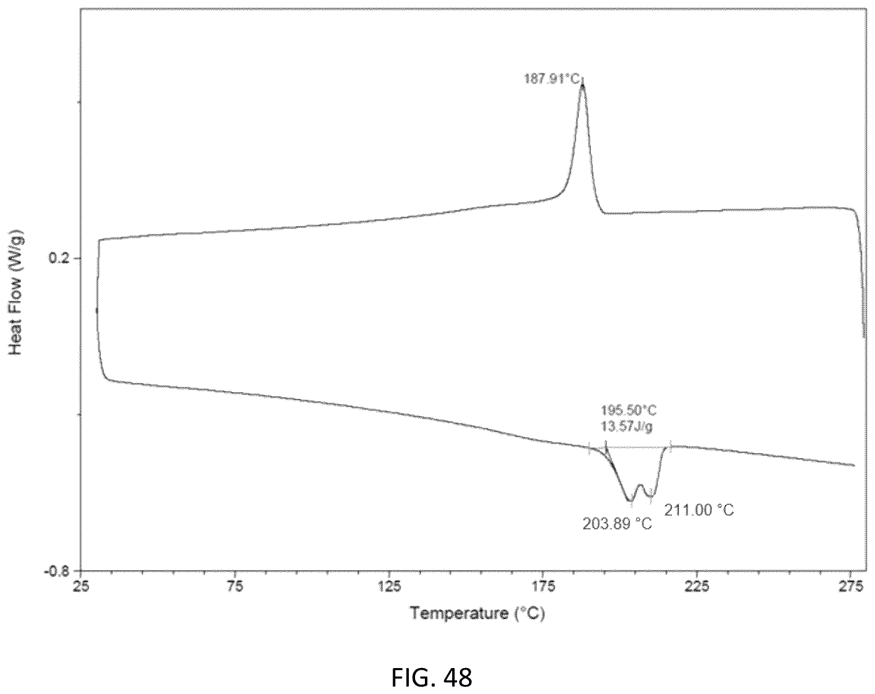

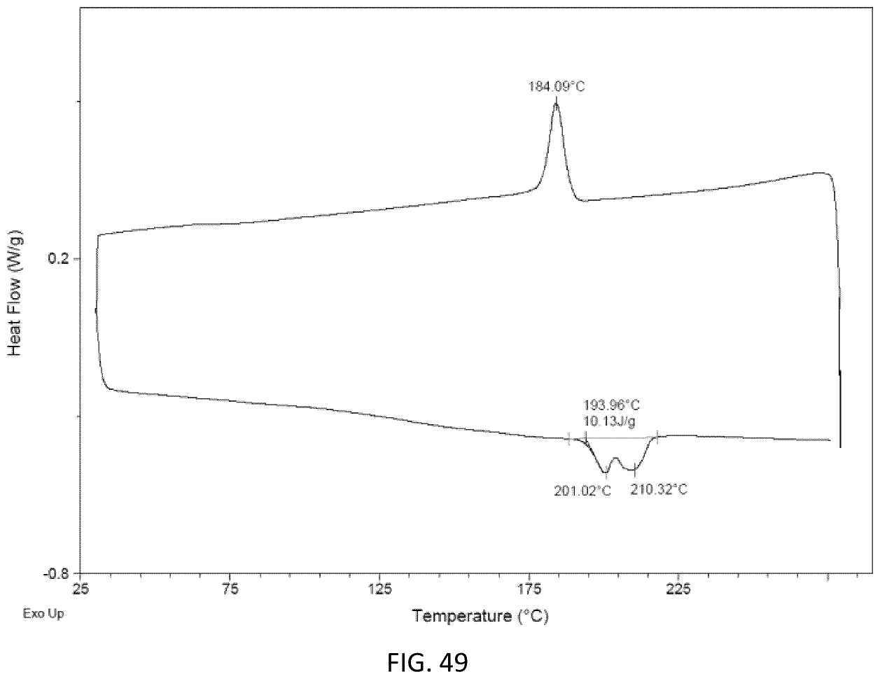

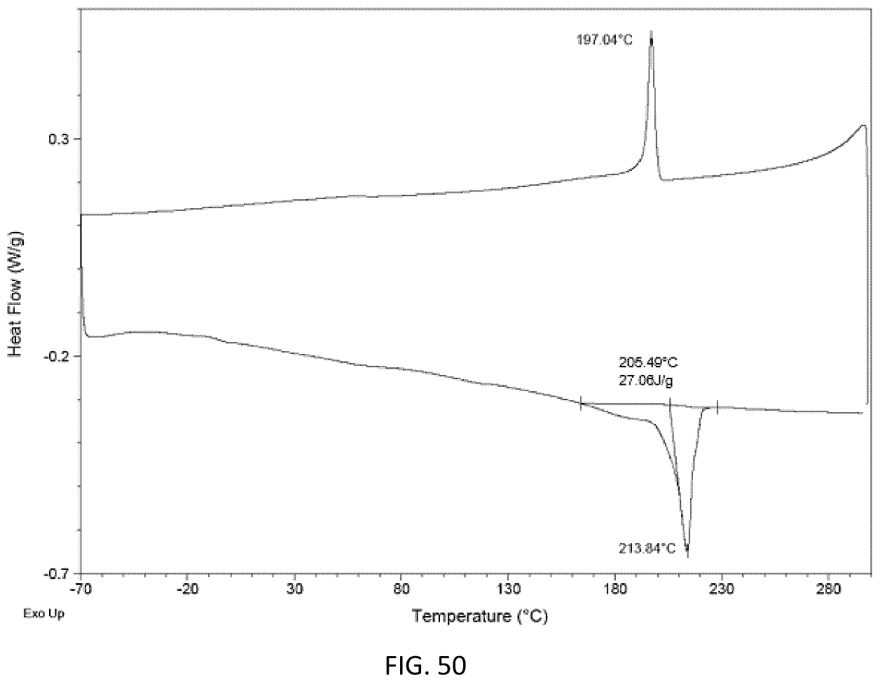

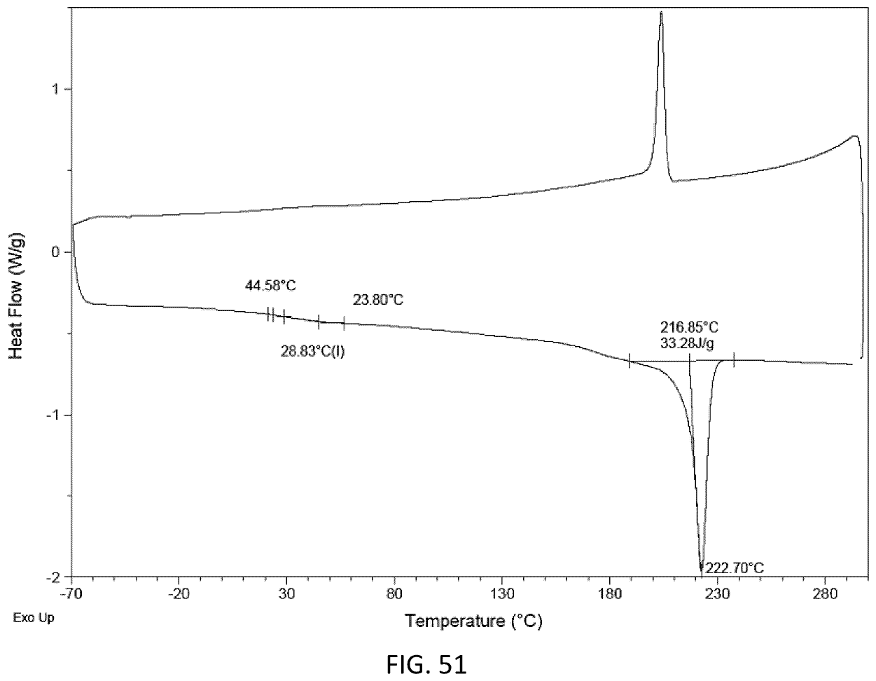

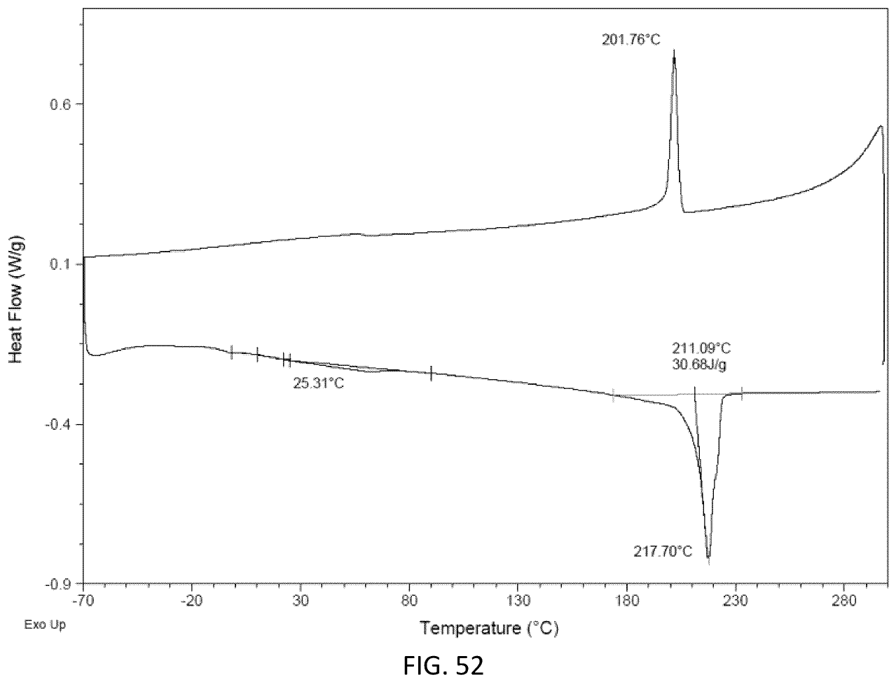

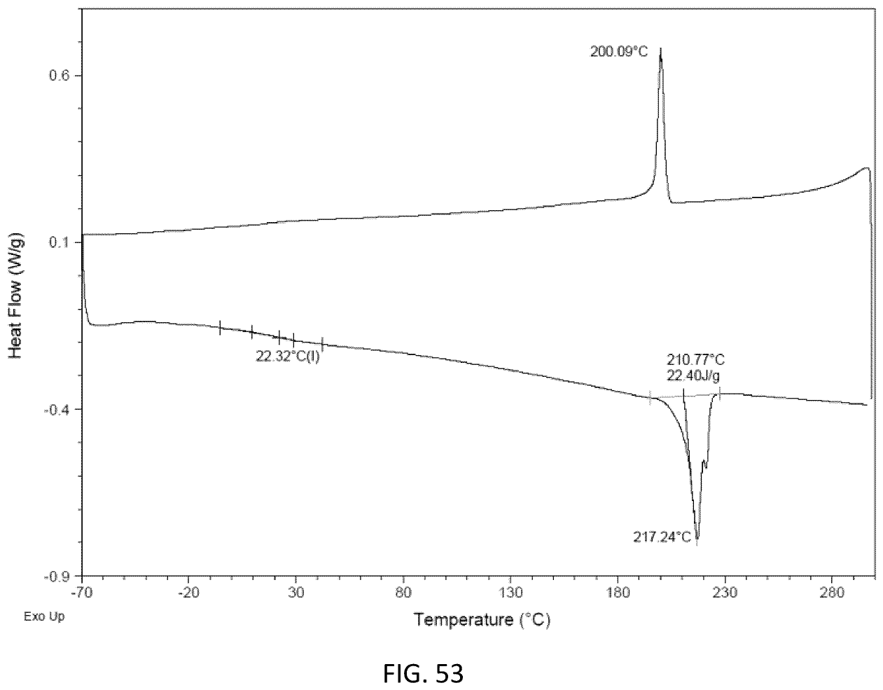

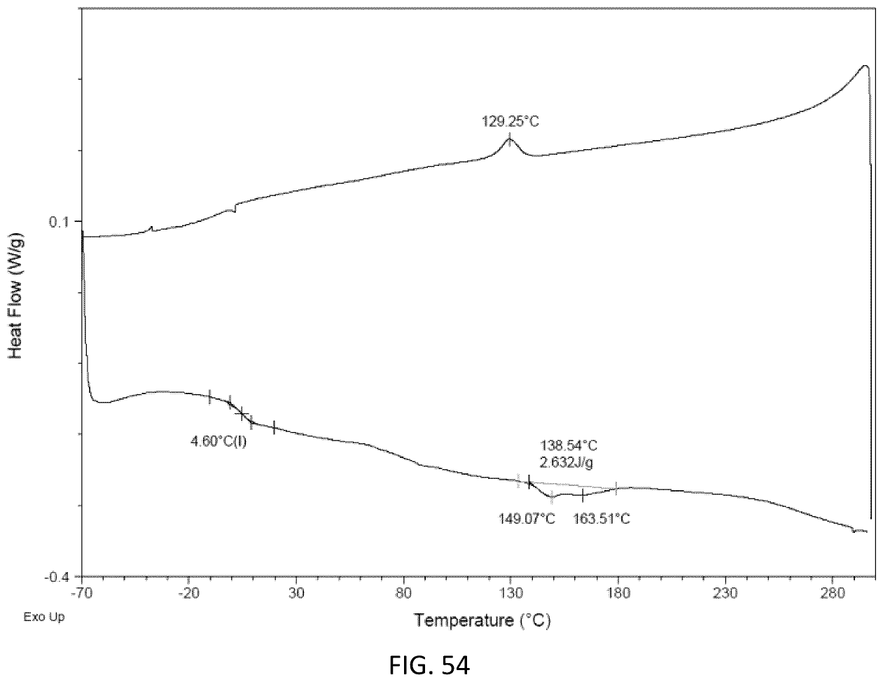

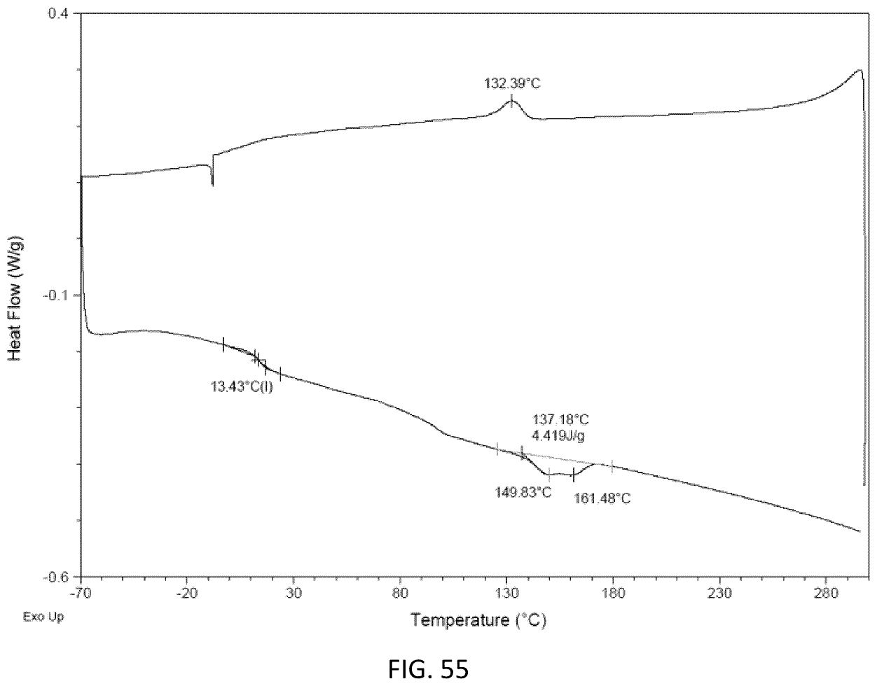

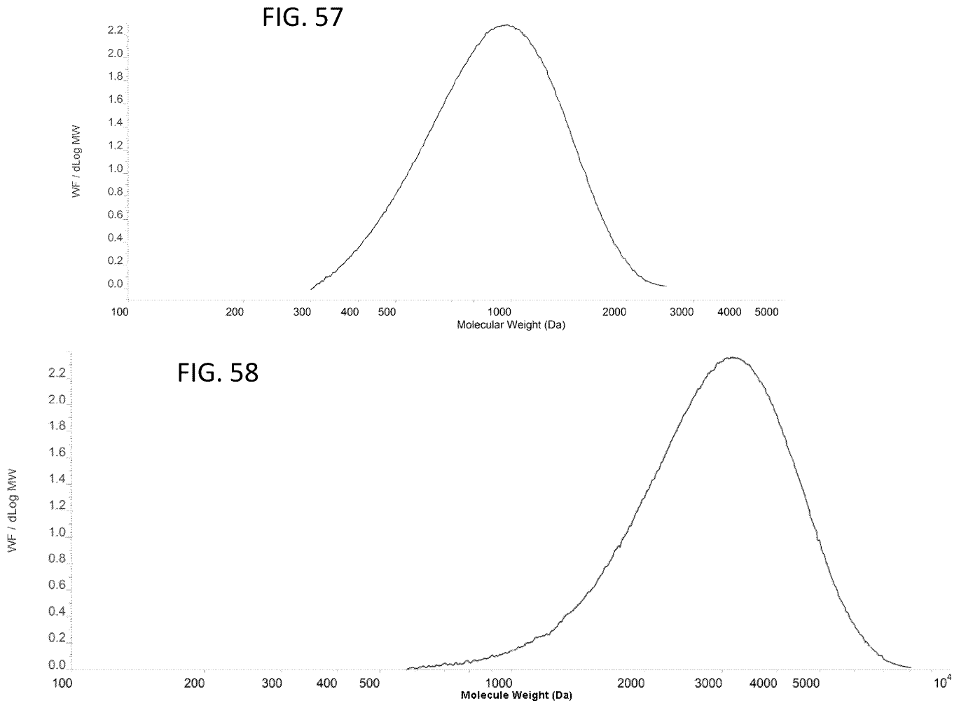

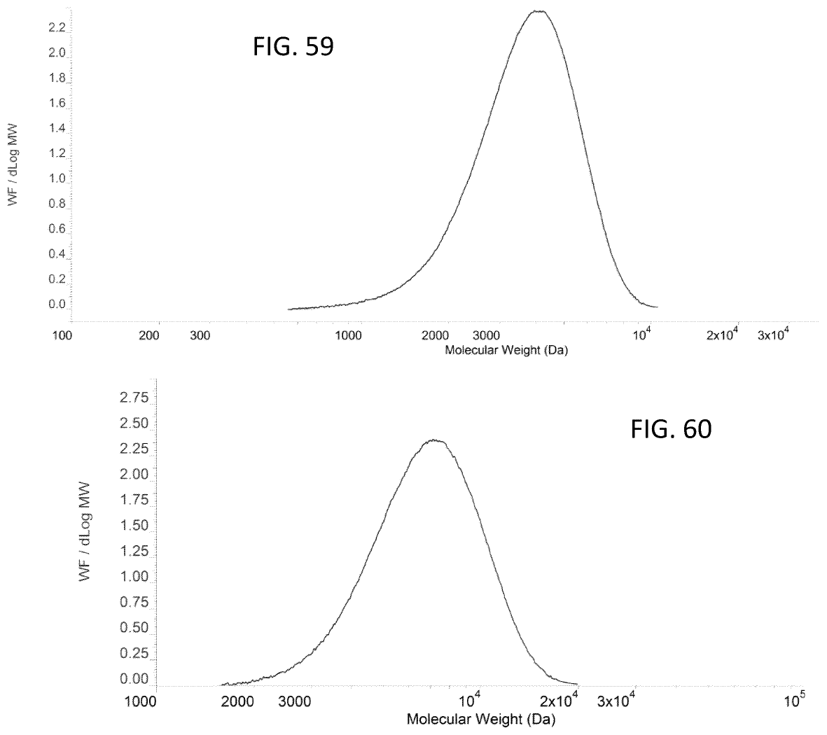

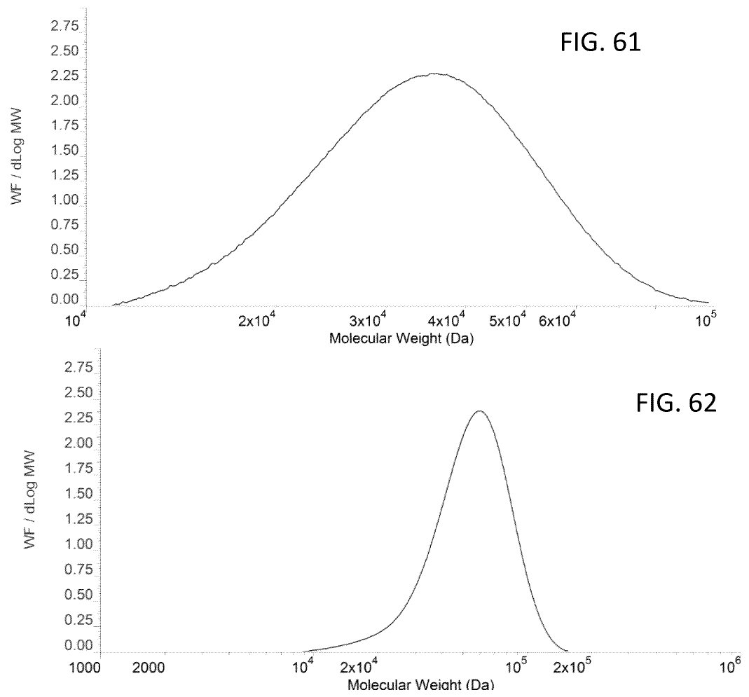

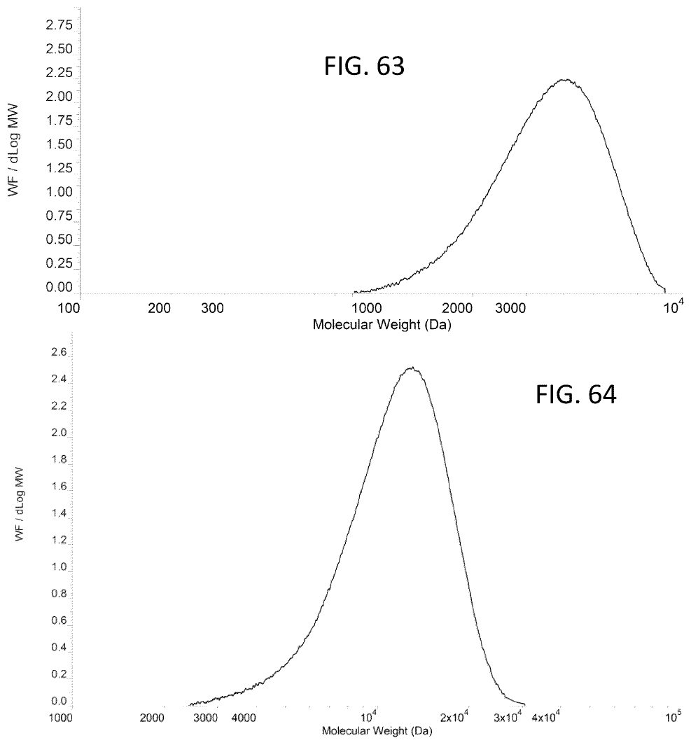

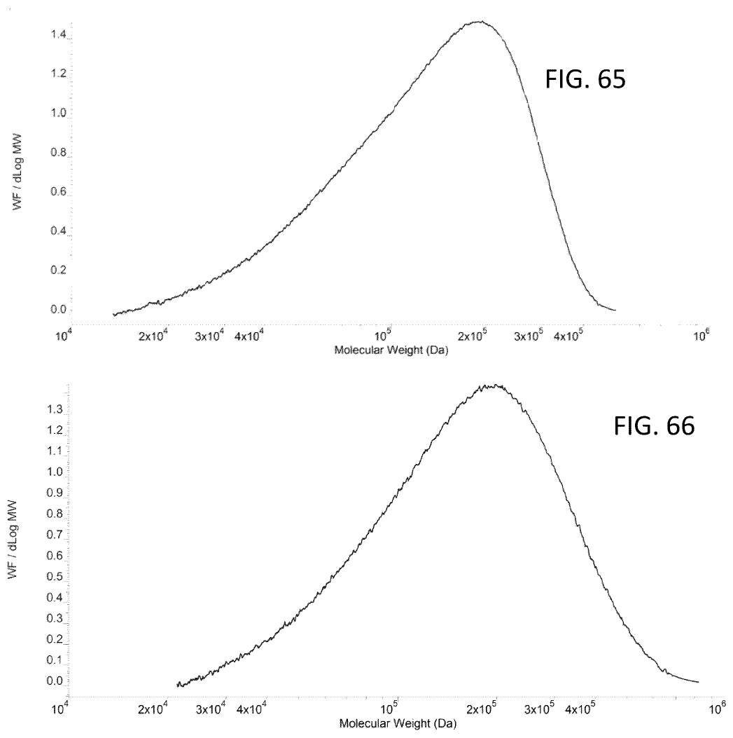

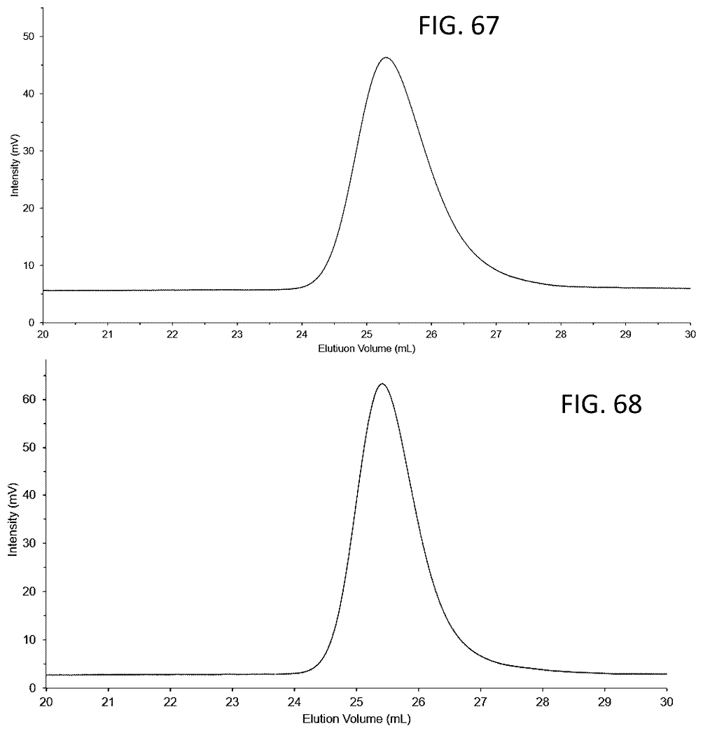

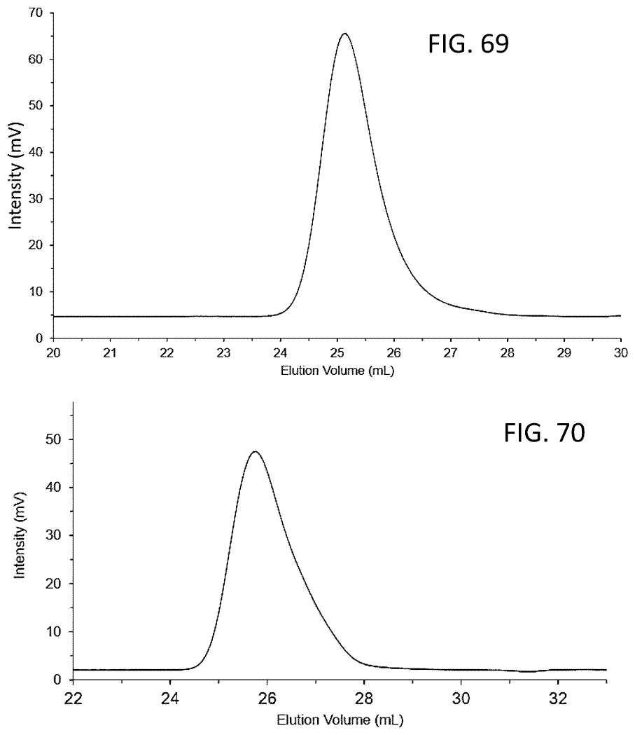

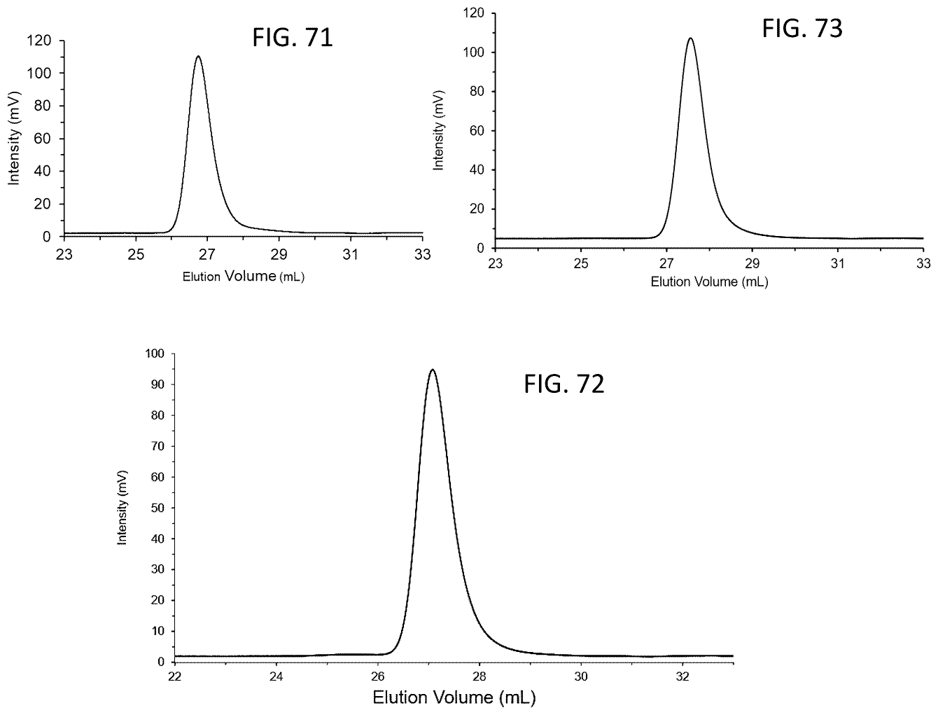

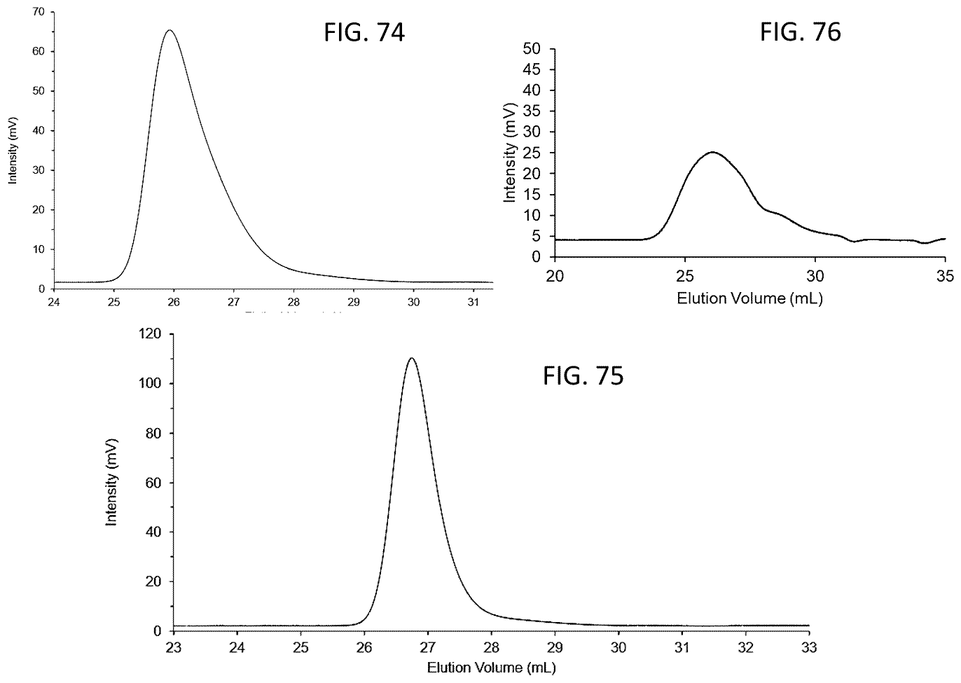

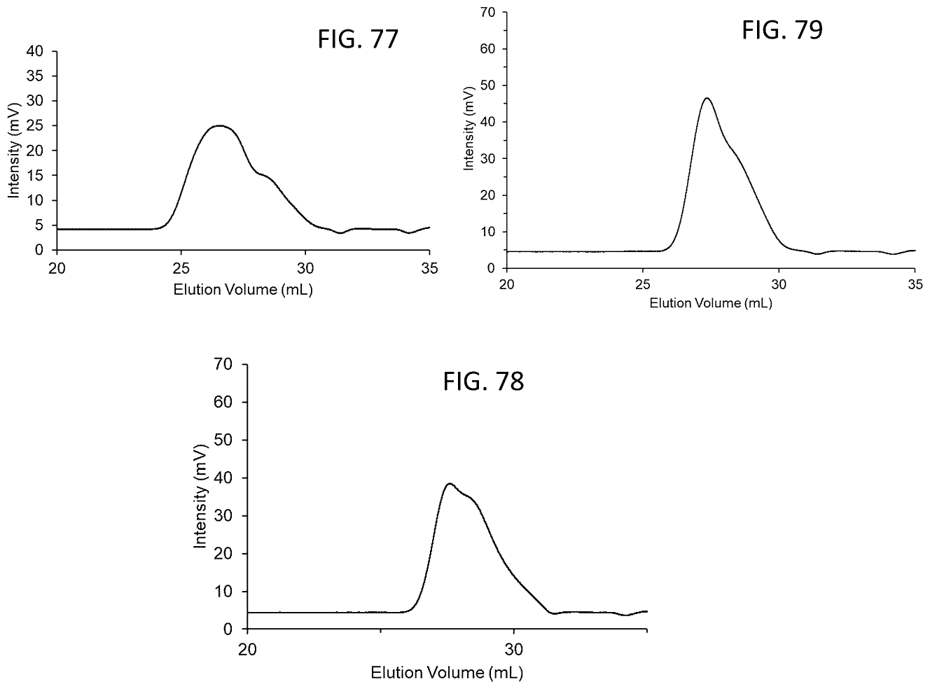

Differential scanning calorimetry (DSC). DSC was performed using a TA instruments DSC Q1000 or Q100 (noted with a *) system. Samples were run in sealed hermetical aluminum pans with an empty pan as reference. A heat/cool/heat temperature program was used at a ramp rate of 10 or 20° C./min with varied temperature ranges. The initial mass of the sample was between 4 and 10 mg. Representative results of first cooling cycle (top) and second heating cycle (bottom) are shown in FIGS. 33-55.

Dynamic Mechanical Analysis (DMA). DMA was performed on a TA Instruments DMA Q800 quipped with a film tension clamp. Samples were stretched under a controlled force ramp from 0.1 N to 18 N at rate of 0.1 N/min. Measurements were made at room temperature. Samples were prepared by melting into silicon molds of a rectangle shapes of 1.5 mm thick, 5 mm width, and 15 mm length. Each sample was measured for exact dimensions prior to running and entered into the software.

### Synthetic Procedures

### General Procedure for the Living Coordinative (Chain Transfer) Polymerization of 4-methyl-1-pentene (Runs 0-11)

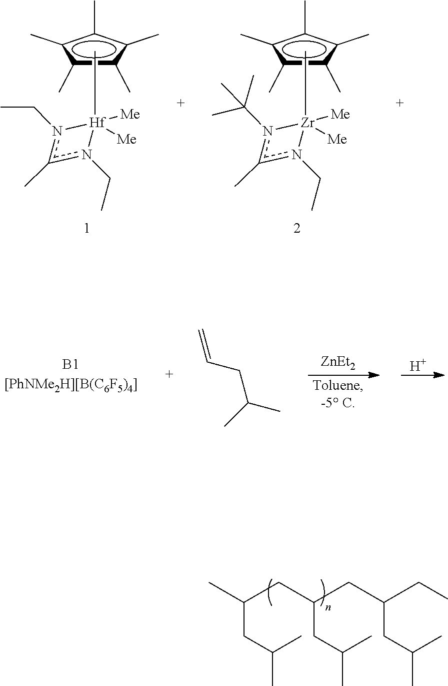

To a 50 mL round bottom flask was added 15 mL of toluene and cooled to −5° C. To the flask was added 4-methyl-1-pentene (2.0 g, 23.8 mmol). To the flask was added ZnEt₂ (see Table 6). A solution of 1 and 2 (see Table 6) in 1.0 mL of chlorobenzene (−5° C.) was added to B1 (35.3 mg, 0.044 mmol) and mixed by pipette until dissolved, then quickly added to the flask. The reaction was stirred for 16-24 hours at −5° C. The reaction was quenched and precipitated in 200 mL acidic methanol (10% HCl in MeOH) overnight and vacuum filtered using methanol. The polymer was dried in vacuo.

TABLE 6
Polymerization conditions for Runs 0-11.

| Run | 1 (mg, mmol) | 2 (mg, mmol) | ZnEt₂ (mg, mmol) |
|---|---|---|---|
| 0 | 18.3, 0.040 | — | 24.7, 0.2 |
| 1 | 16.5, 0.036 | 1.6, 0.004 | 24.7, 0.2 |
| 2 | 14.6, 0.032 | 3.2, 0.008 | 24.7, 0.2 |
| 3 | 12.8, 0.028 | 4.8, 0.012 | 24.7, 0.2 |
| 4 | 11.0, 0.024 | 6.4, 0.016 | 24.7, 0.2 |
| 5 | 9.1, 0.020 | 7.9, 0.020 | 24.7, 0.2 |
| 6 | 7.3, 0.016 | 9.6, 0.024 | 24.7, 0.2 |
| 7 | 5.4, 0.012 | 11.1, 0.028 | 24.7, 0.2 |
| 8 | 3.7, 0.008 | 12.7, 0.032 | 24.7, 0.2 |
| 9 | 1.8, 0.004 | 14.3, 0.036 | 24.7, 0.2 |
| 10 | — | 15.9, 0.040 | 24.7, 0.2 |
| 11 | — | 15.9, 0.040 | — |

### Procedure for the Extraction of Poly(4-Methyl-1-Pentene) Blend Run 5

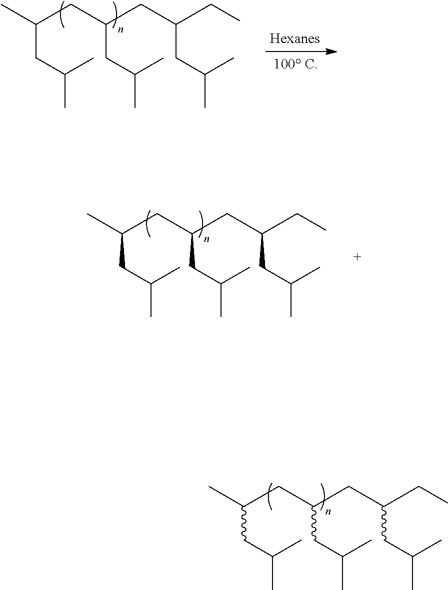

To a preweighed Whatman 43 mm×123 mm single thickness cellulose thimble was added Run 5 (428 mg). To a 250 mL round bottom flask was added about 100 mL of hexanes. On top of the flask was added a Soxhlet and the Run 5-containing thimble was placed inside. On top of the Soxhlet was added a reflux condenser open to air. The contents of the flask were refluxed overnight at 100° C. The contents in the flask named ‘soluble fraction’ were dried in vacuo. The contents remaining in the thimble named ‘insoluble fraction’ were dried for hours on a warm hotplate. The mass of the soluble fraction was determined to be 249 mg (58%). The mass of the insoluble fraction was determined to be 170 mg (40%).

TABLE 7
Mass ratios of Ia and Ib as determined by SEC
integrations for Runs 0-10.

| Run | Ia (aPMP) | Ib (iPMP) |
|---|---|---|
| 0 | 1 | — |
| 1 | 21.8 | 1 |
| 2 | 10 | 1 |
| 3 | 4.50 | 1 |
| 4 | 1.8 | 1 |
| 5 | 1.2 | 1 |
| 6 | 1 | 1.7 |
| 7 | 1 | 3.2 |
| 8 | 1 | 9.0 |
| 9 | nd | nd |
| 10 | — | 1 |

The invention claimed is:

1. A method for preparing a polyolefin composition, comprising:
reacting an olefin monomer with a first metallocene pre-initiator, a second metallocene pre-initiator, a co-initiator, and a chain transfer agent in a liquid medium, thereby polymerizing the olefin monomer to produce the polyolefin composition,
wherein the polyolefin composition comprises a blend of atactic polyolefin and isotactic polyolefin.

2. (canceled)

3. The method of claim 1, wherein the olefin monomer is 4-methyl-1-pentene.

4. The method of claim 1, wherein the polyolefin composition comprises a blend of atactic poly(4-methyl-1-pentene) (aPMP) and isotactic poly(4-methyl-1-pentene) (iPMP).

5. (canceled)

6. The method of claim 1, comprising:
mixing the olefin monomer and the chain transfer agent in a first solvent to form a first mixture;
mixing the first metallocene pre-initiator, the second metallocene pre-initiator, and the co-initiator in a second solvent to form a second mixture; and
contacting the first mixture and the second mixture, and
polymerizing the olefin monomer by living coordinative chain transfer polymerization.

7. The method of claim 1, wherein the ratio of iPMP:aPMP increases as the ratio of the second pre-initiator to the first pre-initiator increases.

8. The method of claim 1, wherein crystallinity of the polyolefin composition increases as the ratio of the second pre-initiator to the first pre-initiator increases.

9. The method of claim 1, wherein the first metallocene pre-initiator comprises (η⁵-C₅Me₅)Hf(Me)₂[N(Et)C(Me)N(Et)] and the second metallocene pre-initiator comprises (η⁵-C₅Me₅)ZrMe₂[N(Et)C(Me)N(Bu)].

10. The method of claim 1, wherein the co-initiator comprises [PhNHMe₂][B(C₆F₅)₄].

11. The method of claim 1, wherein the chain transfer agent comprises ZnR₂, wherein R is selected from the group consisting of methyl, ethyl, n-butyl, isoamyl, t-butyl, neopentyl, n-propyl, and iso-propyl.

12. The method of claim 11, wherein the chain transfer agent comprises ZnEt₂.

13. The method of claim 1, wherein the molar ratio of the co-initiator to the total amount of the first and second pre-initiators is from about 1:1 to about 2:1.

14. The method of claim 1, wherein the molar ratio of the chain transfer agent to the total amount of the first and second pre-initiators is from about 1:1 to about 400:1.

15. A polyolefin composition produced by the method of claim 1.

16. A polyolefin composition comprising a blend of atactic poly(4-methyl-1-pentene) (aPMP) and isotactic poly(4-methyl-1-pentene) (iPMP).

17. The polyolefin composition of claim 16, wherein a mass ratio of aPMP to iPMP is about 1:99 to about 99:1.

18. The polyolefin composition of claim 16, wherein the aPMP in the composition has a number-average molar mass index of about 0.2 to about 10.0 KDa and the iPMP in the composition has a number-average molar mass index of about 1.0 to about 200 KDa.

19. The polyolefin composition of claim 16, wherein the aPMP in the composition has a molar mass distribution dispersity of about 1.0 to about 2.5 and the iPMP in the composition has a molar mass distribution dispersity of about 1.0 to about 4.0.

20. (canceled)

21. (canceled)

22. (canceled)

23. (canceled)

24. (canceled)

25. A method of preparing atactic poly(4-methyl-1-pentene) (aPMP), comprising reacting 4-methyl-1-pentene monomer with: a pre-initiator selected from the group consisting of (η⁵-C₅Me₅)Hf(Me)₂[N(Et)C(Me)N(Et)], (η⁵-C₅Me₅)ZrMe₂[N(Et)C(Me)N(^{t}Bu)], and a combination thereof; and a co-initiator in a liquid medium, thereby producing the atactic poly(4-methyl-1-pentene) (aPMP).

26. (canceled)

27. (canceled)

28. The method of claim 25, comprising reacting 4-methyl-1-pentene monomer with a chain transfer agent in the liquid medium.

29. (canceled)

30. (canceled)

31. An aPMP prepared by the method according to claim 25.

32. (canceled)

33. (canceled)

34. (canceled)

35. (canceled)
